(19) United States
(12) Patent Application Publication
(10) Pub. No.: US 2025/0198146 A1
(43) Pub. Date: Jun. 19, 2025

(54) GEODESIC DOME HABITAT, INCLUDING FRAME AND TILE SYSTEMS FOR USE THEREIN

(71) Applicant: Aurelia Institute, Inc., Cambridge, MA (US)

(72) Inventors: Ariel EKBLAW, Cambridge, MA (US); Sanjana SHARMA, Seattle, WA (US); Che-Wei WANG, New York, NY (US); Max POMMIER, Boston, MA (US); Evan HILGEMANN, Brighton, MA (US); Annika ROLLOCK, Cambridge, MA (US)

(73) Assignee: Aurelia Institute, Inc., Cambridge, MA (US)

(21) Appl. No.: 18/981,034

(22) Filed: Dec. 13, 2024

Related U.S. Application Data
(60) Provisional application No. 63/560,169, filed on Mar. 1, 2024.
(60) Provisional application No. 63/560,159, filed on Mar. 1, 2024.
(60) Provisional application No. 63/560,117, filed on Mar. 1, 2024.
(60) Provisional application No. 63/560,109, filed on Mar. 1, 2024.
(60) Provisional application No. 63/610,718, filed on Dec. 15, 2023.

(51) Int. Cl. E04B 1/32; A01G 9/14

(52) U.S. Cl. CPC E04B 1/3211; A01G 9/14; E04B 2001/3223; E04B 2001/3252

(57) ABSTRACT

Described herein are systems and methods for creating and operating a geodesic dome habitat. The geodesic dome habitat includes a frame system for providing structural support and at least one tile that attaches to a face of the frame system. The frame system includes a plurality of struts arranged along the edges, a plurality of tension cables arranged planar to the faces, and at least one connector arranged along a vertex. The tile may be a functional tile for performing a specific functional task, such as a functional tile that includes irrigation systems for irrigating plant receptacles in a vault enclosure, and/or a functional tile that includes thermal plates and outlets for fermentation. The geodesic dome habitat may be compatible with any number of functional tiles, electrical systems, furnishings, etc.

### CROSS-REFERENCE TO RELATED APPLICATIONS

This application claims the benefit of U.S. Provisional Application No. 63/610,718, filed Dec. 15, 2023, U.S. Provisional Application No. 63/560,109, filed Mar. 1, 2024, U.S. Provisional Application No. 63/560,159, filed Mar. 1, 2024, U.S. Provisional Application No. 63/560,117, filed Mar. 1, 2024, and U.S. Provisional Application No. 63/560,169, filed Mar. 1, 2024, each of which is hereby incorporated by reference in its entirety.

### FIELD OF THE DISCLOSURE

This disclosure relates generally to a human-scale space habitat comprising a geodesic dome and functional tiles, and methods for creating and operating thereof.

### BACKGROUND OF THE DISCLOSURE

A geodesic dome is a structure characterized by a network of interconnected polygons (typically triangles) resembling a spherical or hemispherical shape. In the context of human-scale habitats, geodesic domes may be used for a wide variety of applications due to providing large, open interiors with minimal structural supports. The geodesic domes can enclose large areas with minimal materials, making them suitable for creating controlled environments, such as greenhouses and portable shelters. Functional components can be attached to the framework of the geodesic domes to provide life support and other environmental features. These characteristics make geodesic domes an excellent candidate for providing controlled environments suitable for human habitation in a space environment. In some instances, it may be necessary or beneficial to develop a geodesic dome concept that resembles the functionality, materiality, and design of a space-based geodesic dome. The geodesic dome may be created on an Earth-based setting. Creating such a space habitat concept at a human scale may be desirable, as it would allow for Earth-based testing of the space-based geodesic dome before committing the time, money, and resources to a space-based version of the geodesic dome.

Engineering human-scale space habitats can be challenging. Extra-terrestrial environments can, however, impose challenges to providing the sustenance. For example, the environments may not provide natural resources essential for the survival of individuals in space. Forms of sustenance, such as food, and resources such as medicine and sanitizing equipment, may not be readily secured from the extra-terrestrial environments. In addition, the environments can comprise gravitational fields with strengths different from those of Earth. The differing gravitational field strengths can mitigate the functions of some engineering solutions that may otherwise be useful for the preparation, e.g., cultivating of resources in space. Creating or improving methods and systems for providing support, e.g., sustenance, to inhabitants of a human-scale space habitat may be desirable.

In the context of human habitation in a space environment, it may be desirable to provide systems for growing edible plants to sustain human life. In some instances, it may be important to have the ability to grow and sustain plant mass in Earth-gravity and microgravity environments. Green systems may provide enclosed environments for growing and sustaining plant mass. Further, the green systems may be configured with the proper lighting, irrigation, and gas exchange with less reliance on Earth-based conditions, such as gravity and lighting from the sun, making green systems an excellent candidate for providing controlled environments suitable for sustaining human habitation in a space environment. Additionally, green systems that are modular may be easily installed and/or replaced. In some instances, it may be desirable to develop a green system that resembles the functionality, materiality, and design of a microgravity-adaptable green system. The green system may be recreated on an Earth based, Earth-gravity setting. Creating such a green system at a human-sustaining scale may be desirable, as it would allow for Earth-gravity testing of the microgravity green system before committing the time, money, and resources to a microgravity version.

### SUMMARY OF THE DISCLOSURE

In some aspects, described herein are systems and methods for creating and operating a human-scale space habitat. The human-scale space habitat may comprise a frame system that provides structural support for the overall habitat. The frame system described herein may serve as a way to engage the broader scientific, space enthusiast, and architectural communities with the aspirations, realities, and current research on how humans can live meaningful lives in space.

In some embodiments, the frame system comprises a truncated icosahedron geodesic dome oriented with a pentagonal face located at a crown of the geodesic dome. Recognizing the effects of gravity on Earth, in some aspects, the shape of the frame of the dome may not form a complete sphere. In some aspects, the shape of the frame of the dome may be approximately ⅔ of a complete sphere. The base of the frame system includes feet that are designed to support the frame system above a flat surface. The frame system is constructed from pieces that are intended to be quickly assembled and disassembled. The frame system comprises connector nodes as the vertices of the frame system, and struts that connect the connector nodes to form edges. Cables between the connector nodes provide tension reinforcement and rigidity. The resulting hexagonal faces and pentagonal faces can be further subdivided into mountable frames where functional tiles may be attached. Functional tiles may include tiles with functional components. In some aspects, the functional components may be accessible to users inside of the dome. In some aspects, non-functional tiles or cladding may be installed in locations where there are no functional tiles.

According to some embodiments, an example geodesic dome habitat includes: a frame system for providing structural support for the geodesic dome habitat, the frame system comprising: a plurality of struts arranged along edges of the geodesic dome habitat, a plurality of tension cables arranged planar to a face of the geodesic dome habitat, and at least one connector arranged along a vertex of the geodesic dome habitat; and at least one tile configured to attach to the face of the geodesic dome habitat.

In some embodiments, the at least one connector includes: a plurality of rods, wherein each rod of the plurality of rods is configured to connect to at least one strut from the plurality of struts and comprises a first through-hole, and a connection plate configured to connect to at least one tension cable from the plurality of tension cables. In some embodiments, the at least one connector is arranged to form a vertex of the geodesic dome. In some embodiments, the at least one connector is configured to be interchangeable with another connector.

In some embodiments, the plurality of rods is configured to connect to the at least one strut from the plurality of struts such that the geodesic dome is deformable. In some embodiments, the plurality of rods extends from a central connection point of the at least one connector. In some embodiments, a plurality of rods extend from a central connection point of the connector, wherein each rod of the plurality of rods is configured to connect to at least one strut from the plurality of struts and comprises at least one through-hole. In some embodiments, the plurality of rods comprises at least three rods.

In some embodiments, a tension cable of the plurality of tension cables is configured to be adjustably connected to the connection plate such that a tension force of the at least one tension cable is adjustable. In some embodiments, a tension cable of the plurality of tension cables is configured to extend between the connection plate of the at least one connector and a connection plate of another connector.

In some embodiments, the plurality of struts comprises at least one hollow strut configured to receive at least one rod from the plurality of rods and comprises a second through-hole. In some embodiments, the frame system further comprises at least one pin configured to connect the at least one hollow strut to the at least one rod through the first through-hole and the second through-hole. In some embodiments, the plurality of struts is arranged such that the frame system forms at least one pentagonal face and at least one hexagonal face of the geodesic dome habitat. In some embodiments, the plurality of struts is configured to be interchangeable with one another. In some embodiments, the plurality of struts comprises at least one rigid strut.

In some embodiments, the geodesic dome habitat is a truncated icosahedron dome. In some embodiments, the frame system is oriented such that a pentagonal face of the frame system is located at a crown of the geodesic dome habitat.

In some embodiments, the geodesic dome habitat further includes a floor system comprising: a floor positioned at a base of the geodesic dome habitat, wherein a surface of the floor is sloped such that a center of the floor is lower than an edge of the floor adjacent to the frame system; a catwalk extending from the edge of the floor toward the center of the floor, wherein the catwalk is arranged above the surface of the floor; and an underfloor enclosure, wherein the underfloor enclosure is configured to include one or more systems compatible with the at least one tile of the geodesic dome habitat. In some embodiments, the underfloor enclosure is configured to connect to one or more functional tiles. In some embodiments, the underfloor enclosure is configured to include one or more of: a nutrient container configured to house one or more nutrient mixtures for a green system; a pump container configured to pump one or more nutrient mixtures for a green system; or a switch box configured to house an electrical system for a green system. In some embodiments, the underfloor enclosure is configured to include one or more of: one or more housings configured to house one or more thermal plates and one or more ferments; a tile plate comprising one or more receptacles, wherein the one or more receptacles are configured to mate with the one or more housings; or one or more outlets configured to expel air from the one or more housings.

In some embodiments, the geodesic dome habitat further includes at least one foot comprising: a flat panel configured to lay flush against the surface of the floor, and a hollow strut configured to receive a portion of the at least one connector and connected to the flat panel at an angle relative to a surface of the flat panel, wherein the at least one foot is configured to support the frame system above the surface of the floor system. In some embodiments, the angle of the hollow strut is 30-90 degrees. In some embodiments, the at least one foot is adjacent to the edge of the floor.

In some embodiments, an example connector for a geodesic dome frame system includes: a plurality of rods, wherein each rod of the plurality of rods is configured to connect to at least one strut from the plurality of struts and comprises a through-hole; and a connection plate configured to connect to at least one tension cable from the plurality of tension cables, wherein the connection plate is configured to face outward relative to the center of the geodesic dome frame system once assembled.

In some embodiments, the at least one tile comprises a functional tile for performing a specific functional task. In some embodiments, the functional tile is configured to attach to the frame system such that a functional component of the functional tile faces inward relative to a center of the geodesic dome habitat. In some embodiments, the functional tile comprises: one or more plant receptacles for plant containment; a tile plate configured to receive the one or more plant receptacles; a vault enclosure configured to attach to the tile plate; and one or more irrigation systems configured to irrigate the one or more plant receptacles. In some embodiments, the functional tile comprises: one or more housings configured to house one or more thermal plates and one or more ferments; a mountable frame comprising one or more receptacles, wherein the one or more receptacles are configured to mate with the one or more housings; and one or more outlets configured to expel air from the one or more housings.

In some embodiments, the geodesic dome habitat further includes at least one mountable frame configured to connect to the at least one connector such that the at least one mountable frame is planar to a hexagonal face of the geodesic dome. In some embodiments, the at least one mountable frame is configured to support the at least one tile and is arranged along the hexagonal face of the geodesic dome habitat.

In some embodiments, the at least one mountable frame is configured to support one or both of a panel and a baseplate, and wherein the at least one mountable frame is arranged along the hexagonal face of the geodesic dome. In some embodiments, the at least one mountable frame comprises a triangular bracket.

In some aspects, disclosed herein is a geodesic dome habitat comprising: a frame system for providing structural support for the geodesic dome habitat; and a fermentor system, comprising: one or more housings configured to house one or more thermal plates and one or more ferments; a tile plate comprising one or more receptacles, wherein the one or more receptacles are configured to mate with the one or more housings; and one or more outlets configured to expel air from the one or more housings.

In some embodiments, the air expelled by the one or more outlets can be controlled by one or more electric fans. In some embodiments, the one or more electric fans can be configured to expel the air at a volumetric flow rate of at least a first predetermined volumetric flow rate. In any of the embodiments herein, the one or more electric fans can be configured to expel the air at an average flow velocity of at least a first predetermined average flow velocity. In any of the embodiments herein, an electric fan of the one or more electric fans can comprise 3 to 8 fan blades.

In any of the embodiments herein, the one or more outlets can comprise one or more filters. In some embodiments, at least one of the one or more filters can be a carbon filter. In any of the embodiments herein, the one or more electric fans are located in an underfloor enclosure of a geodesic dome. In any of the embodiments herein, of the one or more outlets, a plurality of outlets is controlled by a single fan and a single filter. In some embodiments, the plurality of outlets can comprise three outlets. In any of the embodiments herein, a multi-to-one inlet-to-outlet manifold air can be configured to expel, at least in part, the air from the one or more housings. In some embodiments, the multi-to-one inlet-to-outlet manifold can be a three-to-one inlet-to-outlet manifold. In any of the embodiments herein, the one or more outlets can be configured to be controlled by a same number of fans as the one or more outlets and a same number of filters as the one or more outlets. In any of the embodiments herein, the one or more outlets can be connected to one or more tubings. In some embodiments, the one or more tubings comprise polyvinyl chloride. In any of the embodiments herein, the one or more tubings can comprise an inner diameter of 0.250″, 0.50″ or 0.375″. In any of the embodiments herein, the one or more tubings can be configured to expel the air at the volumetric flow rate of at least a second predetermined volumetric flow rate. In any of the embodiments herein, the one or more tubings can be configured to expel the air at the average flow velocity of at least a second predetermined average flow velocity. In some embodiments, each of the one or more outlets can be configured to be controlled independently from one or more other outlets. In any of the embodiments herein, the control can comprise control of the volumetric flow rate or the average flow velocity. In any of the embodiments herein, the one or more outlets can be configured to expel oxygen from the one or more housings.

In any of the embodiments herein, the one or more thermal plates can be temperature controlled, at least in part, by one or more reservoirs and one or more chiller-heaters. In some embodiments, of the one or more thermal plates, a plurality of thermal plates is controlled by a single reservoir of the one or more reservoirs and a single chiller-heater of the one or more chiller-heaters. In any of the embodiments herein, the one or more thermal plates can be configured to be controlled by a same number of reservoirs as the one or more thermal plates and a same number of chiller-heaters as the one or more thermal plates. In any of the embodiments herein, the one or more reservoirs or the one or more chiller-heaters can be located on a tray. In any of the embodiments herein, the one or more reservoirs or chiller-heaters can be located in the underfloor enclosure of the geodesic dome. In any of the embodiments herein, the one or more thermal plates can be temperature controlled by one or more thermoelectric devices. In some embodiments, the one or more thermal plates can be configured to be controlled by a same number of the one or more thermoelectric devices as the one or more thermal plates. In any of the embodiments herein, the one or more thermal plates can be configured to be controlled independently from one or more other thermal plates. In any of the embodiments herein, the one or more thermal plates can be configured to target a setpoint temperature of approximately 18-33 degrees Celsius. In any of the embodiments herein, the one or more thermal plates can comprise aluminum. In any of the embodiments herein, the one or more thermal plates can be configured to pass a coolant through the one or more thermal plates. In some embodiments, the coolant can comprise water. In some embodiments, the coolant can comprise a biocide. In any of the embodiments herein, the one or more thermal plates can comprise two thermal plate portions and a gasket.

In any of the embodiments herein, the one or more thermal plates can comprise one or more internal channels to pass the coolant through the one or more thermal plates. In some embodiments, the one or more internal channels can comprise one or more inlets and one or more outlets. In any of the embodiments herein, the methods disclosed can further comprise an electrical panel controlling, at least in part, the one or more reservoirs, the one or more chiller-heaters, the one or more thermoelectric devices, the one or more electric fans, or a combination thereof. In some embodiments, the electrical panel can prevent one or more pumps configured to provide flow to the coolant from being turned on after the one or more chiller-heaters turn on. In any of the embodiments herein, the electrical panel can prevent one or more electrical components of the fermentor system from drawing 10 A or more current. In any of the embodiments herein, the electrical panel can be located in the underfloor enclosure of the geodesic dome. In any of the embodiments herein, the one or more electrical components of the fermentor system can receive an input alternating current of 60 Hz, 120 V, and single phase.

In any of the embodiments herein, the one or more housings can be transparent. In any of the embodiments herein, the one or more housings can be spherical. In any of the embodiments herein, the one or more housings can comprise glass, acrylic, or both. In any of the embodiments herein, each of the one or more housings can be configured to mate with only one of the one or more receptacles. In any of the embodiments herein, the one or more housings can be 1, 2, 3, 4, 5, 6, or 7 housings. In any of the embodiments herein, each housing of the one or more housings can comprise a different shape from one or more other housings. In any of the embodiments herein, the disclosed methods can further comprise: one or more inactive housings that do not house one or more thermal plates. In some embodiments, the one or more inactive housings can be affixed to the one or more housings. In some embodiments, the one or more inactive housings can be affixed to the one or more housings via one or more ball joints and one or more ball joint sockets. In any of the embodiments herein, the one or more inactive housings can each comprise a rod structure. In some embodiments, each rod structure of each of the one or more inactive housings can be of a different length from one or more other rod structures. In any of the embodiments herein, the rod structure can comprise a ball joint of the one or more ball joints. In any of the embodiments herein, the tile plate can be triangular in shape. In any of the embodiments herein, the fermentor system can be configured to attach to a bracket of a geodesic dome, a frame of a geodesic dome, or both. In any of the embodiments herein, a ferment of the one or more ferments can comprise a yeast ferment.

In any of the embodiments herein, a ferment of the one or more ferments can comprise a yeast ferment. In some embodiments, the ferment can comprise a sourdough ferment. In any of the embodiments herein, the ferment can be housed in a pouch. In some embodiments, the pouch can be filled to approximately two-thirds of the volume of the pouch, with the ferment.

In any of the embodiments herein, the pouch can be filled in accordance with a determination that the pouch is not bulging or ballooning. In any of the embodiments herein, the pouch can comprise a magnet. In some embodiments, the magnet can be sealed with a room-temperature-vulcanizing silicone. In any of the embodiments herein, the magnet can mate with a recess on a surface of a thermal plate of the one or more thermal plates. In some embodiments, the mating of the magnet with the recess can be configured to increase contact between the pouch and the surface of the thermal plate.

In some aspects, disclosed herein is a method for operating a fermentor system, comprising: controlling or more setpoint temperatures of one or more thermal plates located in one or more housings; mating the one or more housings with one or more receptacles located on a tile plate; expelling air from the one or more housings via one or more outlets connected to the one or more housings; and propagating one or more ferments located on the one or more thermal plates. In some embodiments, the method can further comprise flowing a coolant through the one or more thermal plates. In some embodiments, the coolant can comprise water. In any of the embodiments herein, the one or more ferments can be capable of being checked for signs of healthy or positive growth. In any of the embodiments herein, an electrical panel can control one or more pumps configured to provide flow to the coolant and the one or more chiller-heaters. In some embodiments, the electrical panel can prevent the one or more pumps from being turned on after the one or more chiller-heaters turn on.

In some aspects, disclosed herein is a method for assembling a fermentor system comprising: mounting a tile plate to a geodesic dome; fastening one or more housings to the tile plate via one or more receptacles located on the tile plate; fastening one or more thermal plates inside the one or more housings via a tubing or a crossbar fastened to the one or more housings; mounting one or more chiller-heaters controlling, at least in part, the temperature of the one or more thermal plates and one or more reservoirs controlling, at least in part, the temperature of the one or more thermal plates, in an underfloor enclosure of a geodesic dome; mounting one or more electric fans configured to expel air from the one or more housings, in the underfloor enclosure of the geodesic dome; mounting an electrical panel controlling, at least in part, the one or more reservoirs, the one or more chiller-heaters, the one or more electric fans, or a combination thereof; and providing one or more pouches comprising one or more ferment, on the one or more thermal plates, wherein a pouch of the one or more pouches comprises a magnet. In some embodiments, the fastening the one or more thermal plates can further comprise: constantly pumping a coolant through the one or more thermal plates, wherein the coolant can comprise water; and slowly rotating the one or more thermal plates, in accordance with a determination that an air bubble is observed in the coolant. In any of the embodiments herein, the providing the one or more pouches can comprise mating the magnet with a recess on a surface of a thermal plate of the one or more thermal plates. In any of the embodiments herein, an electrical panel can control one or more pumps configured to provide flow to the coolant and the one or more chiller-heaters. In some embodiments, the electrical panel can prevent the one or more pumps from being turned on after the one or more chiller-heaters turn on. In any of the embodiments herein, the electrical panel can prevent one or more electrical components of the fermentor system from drawing 10 A or more current.

Disclosed herein are systems and methods for creating and operating a green system configured to assist inhabitants of a human-scale space habitat. Extra-terrestrial environments can comprise gravitational fields that may limit the use of gravity-based mechanical features, such as gravity-based pumps. In addition, extra-terrestrial environments may be limited in nutritional resources and/or medicine. Sources of nutrition and/or medicine that can be cultivated for extended durations may prove useful. Described herein is a green system for cultivating sources of nutrition and/or medicine. The green system can be modular, e.g., removable, relative to a human-scale space habitat. The human-scale space habitat can be a geodesic dome, such as a truncated icosahedron geodesic dome. The green system can comprise components for helping plant mass growth, such as support structures (e.g., tile plate and plant receptables), a vault enclosure with a lighting system and a gas exchange system, an irrigation system, an underfloor enclosure, or a combination thereof. The components of the green system may be configured to provide one or more functions for plant growth with less (e.g., little to no) reliance on Earth-based conditions, such as gravity and sunlight.

In some aspects, disclosed herein is a geodesic dome habitat, comprising: a frame system for providing structural support for the geodesic dome habitat; and a green system, comprising: one or more plant receptacles for plant containment; a tile plate configured to receive the one or more plant receptacles; a vault enclosure configured to attach to the tile plate; and one or more irrigation systems configured to irrigate the one or more plant receptacles. In some aspects, described herein are systems and methods for creating and operating a green system to be used in a human-scale space habitat comprising a geodesic dome.

In some embodiments, the green system may be configured to attach to a bracket of a geodesic dome, a frame of a geodesic dome habitat, or both. In any of the embodiments herein, the tile plate may comprise one or more openings for the one or more plant receptacles and attachment hardware. In any of the embodiments herein, at least two of the one or more plant receptacles may be different sizes, and the tile plate may be configured to receive the different-sized plant receptables. In any of the embodiments herein, the one or more plant receptacles may be configured to be replaced and removed from the tile plate. In any of the embodiments herein, the one or more plant receptacles may be configured to accept plant mass comprising one or more of: leaves, stems, and roots. In some embodiments, the plant mass may an edible plant mass grown and maintained for at least two weeks. In any of the embodiments herein, the one or more plant receptacles may comprise openings of one or more sizes to accept plant pots of one or more sizes. In some embodiments, the plant pots may be configured to accept plant collars. In any of the embodiments herein, at least one of the one or more plant receptacles may comprise one or more of: a receptacle lid with rotating latches, one or more bottoms configured to latch onto one or more funnels and a first side of the tile plate to create a watertight seal, and one or more funnels configured to attach to the one or more bottoms of the one or more plant receptables and a second side of the tile plate, wherein the first side of the tile plate is different from the second side. In some embodiments, the receptable lid may be configured to: receive a plant mass through an opening; and lock onto one or more bottoms of the one or more plant receptables. In any of the embodiments herein, the one or more funnels may comprise one or more holes for irrigation drainage, wherein the one or more funnels may be made of a single material that protects plant mass from light exposure.

In any of the embodiments herein, the vault enclosure may be removable and configured to lock in place onto the tile plate. In any of the embodiments herein, the vault enclosure may be configured to form a vacuum when locked into place. In any of the embodiments herein, the vault enclosure may comprise one or more hinged panels configured to attach to other hinged panels to create an enclosed space. In some embodiments, the one or more hinged panels may be triangular in shape. In any of the embodiments herein, the one or more hinged panels may comprise transparent acrylic panels with 3D printed corners and a flexible trim. In any of the embodiments herein, the vault enclosure may comprise: one or more springs configured to allow removal of the vault enclosure from the tile plate. In some embodiments, the springs may be gas springs. In any of the embodiments herein, the geodesic dome habitat may further comprise: one or more lights and one or more wires, wherein the one or more lights may be configured to attach to the vault enclosure and provide lighting for plant growth. In some embodiments, the one or more lights may be controlled by a timer and may be directed toward plant mass. In any of the embodiments herein, the one or more lights may operate at a brightness that is conducive to plant growth, pleasant to the human eye, or a combination thereof. In any of the embodiments herein, the vault enclosure may further comprise: one or more sensors configured to detect temperature, carbon dioxide, humidity, or a combination thereof. In some embodiments, at least one of the one or more sensors may comprise: a carbon dioxide sensor configured to measure carbon dioxide levels, the measured carbon dioxide levels used to adjust fan speed to maintain carbon dioxide levels for plant growth; or a humidity sensor configured to measure humidity levels of the green system, the humidity levels used to adjust fan speed to obtain target humidity levels for plant growth. In any of the embodiments herein, the vault enclosure may comprise one or more inlets and one or more outlets configured to maintain or adjust humidity using one or more fans, reduce condensation buildup, circulate air inside the vault enclosure, promote plant growth, create a more difficult environment for pests, or a combination thereof. In any of the embodiments herein, the vault enclosure may comprise one or more inlets and one or more outlets configured to maintain or adjust humidity, reduce condensation buildup, circulate air inside the vault enclosure, promote plant growth, create a more difficult environment for pests, or a combination thereof, wherein the one or more inlets may comprise one or more fans, and the one or more outlets may comprise one or more gaps between vault enclosure panels.

In any of the embodiments herein, the one or more irrigation systems may be configured to irrigate proximate to roots of plant mass at an irrigation pressure higher than a high-pressure threshold, wherein the irrigation pressure may be based on a pressure of a gravity environment, a pressure of a micro gravity environment, or both. In any of the embodiments herein, the one or more irrigation systems may be configured to feed one or more nutrient mixtures to the one or more plant receptacles. In some embodiments, the one or more nutrient mixtures may comprise: water, nitrogen, potassium, salts, or a combination thereof. In some embodiments, the one or more nutrient mixtures may be monitored by a pH meter and an electrical conductivity meter. In any of the embodiments herein, the one or more nutrient mixtures may comprise: one or more growth mixtures that are diluted separately to reduce nutrient lockout, wherein proportions of the one or more growth mixtures may be based on a stage of plant growth. In some embodiments, the one or more growth mixtures may comprise: nitrogen, calcium, micronutrients, trace minerals, potassium, phosphorus, magnesium, sulfur, or a combination thereof. In some embodiments, the one or more growth mixtures may comprise three parts of a first growth mixture per gallon of water, two parts of a second growth mixture per gallon of water, and one part of a third growth mixture per gallon of water. In any of the embodiments herein, the one or more irrigation systems may feed the one or more plant receptacles at time intervals in accordance with a timer. In any of the embodiments herein, the one or more irrigation systems may comprise: one or more aeroponic misters. In some embodiments, the one or more aeroponic misters may supply the one or more nutrient mixtures to a root zone of the plant in the form of droplets. In some embodiments, the geodesic dome habitat may further comprise: a solenoid configured to control release of the one or more nutrient mixtures through the aeroponic misters. In any of the embodiments herein, the one or more irrigation systems may further comprise: a pump system, comprising: a pump, a pressure switch, an accumulator tank, a safety valve, a filter, and one or more irrigation lines. In some embodiments, the pressure switch may control whether the pump is on or off depending on whether pressure in the one or more irrigation lines is above a lower pressure threshold and below an upper pressure threshold. In some embodiments, the accumulator tank may be pre-pressurized to reduce pump load. In some embodiments, the safety valve may actuate when pressure in the one or more irrigation lines exceeds a safe threshold. In some embodiments, the one or more irrigation lines may be configured to connect to the filter and to one or more aeroponic misters. In some embodiments, the one or more irrigation lines may be configured to draw up one or more nutrient mixtures through the filter and pump it through one or more aeroponic misters.

In any of the embodiments herein, the tile plate may be connected to an underfloor enclosure of a geodesic dome. In some embodiments, the underfloor enclosure may comprise: a nutrient container configured to house one or more nutrient mixtures. In some embodiments, the nutrient container may be configured to feed the one or more nutrient mixtures to a pump container via one or more lines with one or more filters. In some embodiments, the nutrient container may be configured to receive excess nutrient mixture supplied by the one or more irrigation systems from a root zone of the one or more plant receptacles. In any of the embodiments herein, the underfloor enclosure may comprise: a pump container configured to pump one or more nutrient mixtures to the one or more irrigation systems via one or more lines connected to one or more of: a solenoid valve and a pressure gauge. In some embodiments, the pump container may comprise: a pump, an accumulation tank, one or more safety valves, and one or more pressure switches. In any of the embodiments herein, a switch box may be configured to house an electrical system that controls conditions within the vault enclosure. In some embodiments, the electrical system may be connected to one or more sensors. In some embodiments, the switch box may comprise one or more of: one or more cycle timers configured to adjust a solenoid valve for irrigation; one or more cycle timers configured to adjust a brightness of lights within the enclosure; one or more potentiometers configured to adjust a speed of fans within the enclosure; and one or more transformers configured to connect to a pump and one or more pressure switches. In some embodiments, the one or more potentiometers may be configured to be manually operated.

In any of the embodiments herein, the tile plate may be configured to be connected to a frame of the geodesic dome, brackets, or both. In any of the embodiments herein, the tile plate may be configured to be removed from a frame of the geodesic dome, brackets, or both. In any of the embodiments herein, the tile plate may be configured to be connected to both an outer face and an inner face of the geodesic dome. In any of the embodiments herein, the tile plate may be configured to connect to a frame, bracket, or both when rotated and bolted into place. In any of the embodiments herein, the vault enclosure and the tile plate may form a pyramid shaped enclosure. In any of the embodiments herein, the green system may be configured to operate in one or both of gravity and micro gravity environments. In any of the embodiments herein, the green system may be configured to operate in any orientation in space to account for one or both of gravity and micro gravity environments.

A method for operating a green system is disclosed. The method comprises: placing one or more plant masses into one or more plant receptacles; placing the one or more plant receptacles into a tile plate of the green system; attaching a vault enclosure to the tile plate; irrigating the one or more plant masses with one or more nutrient mixtures; and monitoring plant growth conditions within the vault enclosure. In some embodiments, placing the one or more plant masses comprises: one or more root bundles planted in one or more plant pots. In some embodiments, the plant receptacles are configured to receive one or both of soil-based plant mass or soil-less plant mass. In some embodiments, the plant mass is placed with a plant collar. In some embodiments, the receptacle lids of the plant receptacles are placed first. In some embodiments, the system operation termination is controlled by a switch box.

A method for assembling and operating a green system is disclosed. The method comprises: attaching one or more tile plates to one or more frames, brackets, or both; planting one or more plant masses into one or more plant receptacles; placing the one or more plant receptacles for plant containment into the one or more tile plates; latching the one or more plant receptacles into place; removably attaching a vault enclosure to the one or more tile plates; attaching one or more irrigation systems to the one or more plant receptables; adding one or more nutrient mixtures to a nutrient container in an underfloor enclosure; connecting the one or more irrigation systems to a pump container and the nutrient container; connecting one or more wiring systems and one or more sensors from the vault enclosure to the underfloor enclosure; and maintaining the plant mass and the vault enclosure. In some embodiments, the vault enclosure is configured to be locked into place. In some embodiments, the irrigation system comprises one or more exchangeable aeroponic misters. In some embodiments, the one or more irrigation systems are configured to supply nutrient mixtures to the plant receptacles, remove excess liquid from the plant receptacles, or a combination thereof. In some embodiments, the one or more irrigation systems are configured to remove the excess liquid back to the nutrient container.

In some aspects, disclosed herein is a geodesic dome habitat comprising: a frame system for providing structural support for the geodesic dome habitat, the frame system; a fermentor system for providing an environment for cultivating ferments housed in one or more housings; and a green system for providing an environment for growing and sustaining plant mass.

### BRIEF DESCRIPTION OF THE FIGURES

The present application can be understood by reference to the following description taken in conjunction with the accompanying figures.

FIG. 1A illustrates a side-view rendering of an example assembled frame system without any tiles installed, according to some examples.

FIG. 1B illustrates a top view rendering of an example assembled frame system without any tiles installed, according to some examples.

FIG. 1C illustrates an interior-view rendering of an example assembled frame system with tiles installed, according to some examples.

FIG. 2 illustrates a rendering of a hexagonal face and a pentagonal face of an example portion of a frame system, according to some examples.

FIG. 3A illustrates a close-up rendering of a top side of an example connector node of a frame system, according to some examples.

FIG. 3B illustrates a close-up rendering of a bottom side of an example connector node of a frame system, according to some examples.

FIG. 4A illustrates a close-up rendering of an example strut of a frame system, according to some examples.

FIG. 4B illustrates a close-up rendering of example connections between connector nodes and struts of a frame system, according to some examples.

FIG. 5A illustrates a rendering of an example base section of a frame system, according to some examples.

FIG. 5B illustrates a close-up rendering of an example foot of a frame system, according to some examples.

FIG. 6 illustrates a flow chart of an example process for assembling a geodesic dome frame system, according to some examples.

FIG. 7A illustrates a rendering of a hexagonal face and a pentagonal face of an example portion of a frame system with triangular brackets installed, according to some examples.

FIG. 7B illustrates an image of example tiles attached to triangular brackets on a hexagonal face of the frame system, according to some examples.

FIG. 8A illustrates a schematic of an example architecture of a fermentor system supporting a single temperature setpoint, according to some examples.

FIG. 8B illustrates a schematic of an example architecture of a fermentor system supporting multiple temperature setpoints, according to some examples.

FIG. 9 illustrates a high-level connectivity diagram of an example fermentor system supporting multiple temperature setpoints, according to some examples.

FIG. 10A illustrates a rendering of an exploded view of an example housing and its cognate thermal plate and ferment, according to some examples.

FIG. 10B illustrates a rendering of an example housing, according to some examples.

FIG. 11A illustrates an example tile plate configured to receive one or more housings, according to some examples.

FIG. 11B illustrates an example tile plate with housings, according to some examples.

FIG. 11C illustrates a rendering of an exploded view of an example tile plate with housings, according to some examples.

FIG. 12A illustrates an image of an example housing not secured to a cognate receptacle, according to some examples.

FIG. 12B illustrates an image of an example housing attached to a cognate receptacle, according to some examples.

FIG. 12C illustrates an image of an example housing secured to a cognate receptacle, according to some examples.

FIG. 13 illustrates a rendering of an example tile plate with housings, including one or more inactive housings, according to some examples.

FIG. 14A illustrates an image of an example inactive housing secured to a housing, according to some examples.

FIG. 14B illustrates an image of an example plurality of inactive housings secured to a housing, according to some examples.

FIG. 15A illustrates a rendering of an inside view of an example portion of a thermal plate, according to some examples.

FIG. 15B illustrates an image of an inside view of an example portion of a thermal plate, according to some examples.

FIG. 16A illustrates an image of a top of a thermal plate secured inside a housing, according to some examples.

FIG. 16B illustrates an image of an alternative view of a thermal plate secured inside a housing, according to some examples.

FIG. 17 illustrates an image of an example tile plate and tubing supporting housings secured to the tile plate, according to some examples.

FIG. 18 illustrates an image of example electrical systems controlling a pump and a chiller-heater for adjusting the temperature of one or more thermal plates, according to some examples.

FIG. 19 illustrates an image of an example fan configured to draw air from one or more of the housings, according to some examples.

FIG. 20A illustrates images of an example electrical panel configured to support pumps and chiller-heaters for adjusting the temperatures of the thermal plates, according to some examples.

FIG. 20B illustrates an image of an example electrical panel and the chiller-heaters, according to some examples.

FIG. 21A illustrates an image of an inside of an example pouch for holding ferment, comprising sealed magnets, according to some examples.

FIG. 21B illustrates an image of a bottom of an example pouch for holding ferment, according to some examples.

FIG. 22 illustrates an image of an example ferment sealed in the pouch secured to the thermal plate, inside the housing, according to some examples.

FIG. 23 illustrates an example method for assembling a fermentor system, according to some examples.

FIG. 24 illustrates an example method for assembling a fermentor system, according to some examples.

FIG. 25 illustrates an example computing device or system, according to some examples.

FIG. 26 illustrates an example computer system or computer network, according to some examples.

FIG. 27A illustrates a side-view of an example green system including plant mass that is growing, according to some examples.

FIG. 27B illustrates a close view of an example green system including plant mass that is growing, according to some examples.

FIG. 28A illustrates a top view rendering of an example vault enclosure, tile plate, and plant receptacles, according to some examples.

FIG. 28B illustrates a side-view rendering of an example vault enclosure, tile plate, and plant receptacles, according to some examples.

FIG. 29A illustrates a top view rendering of an example tile plate with plant receptacles attached where a vault enclosure has been removed, according to some examples.

FIG. 29B illustrates a bottom-view rendering of an example tile plate with plant receptacles attached where a vault enclosure has been removed, according to some examples.

FIG. 30A illustrates an example tile plate mounted to a frame of a geodesic dome where the plant receptacles have been removed, according to some examples.

FIG. 30B illustrates an example tile plate mounted to a geodesic dome where the plant receptacles have been inserted, according to some examples.

FIG. 31 illustrates an example assembly of components of plant receptacles attached to a tile plate, according to some examples.

FIG. 32 illustrates a rendering of a plant receptacle capable of receiving plant mass, according to some examples.

FIG. 33A illustrates a top view of an example plant receptacle mounted to a tile plate including netted plant pots, according to some examples.

FIG. 33B illustrates a bottom-view an example plant receptacle mounted to a tile plate including netted plant pots, according to some examples.

FIG. 34A illustrates a rendering of an example receptacle lid, according to some examples.

FIG. 34B illustrates a rendering of an example receptacle bottom, according to some examples.

FIG. 34C illustrates a rendering of an example funnel, according to some examples.

FIG. 35A illustrates example receptacle lids of different materials attached to a tile plate, according to some examples.

FIG. 35B illustrates example receptacle lids of different materials, according to some examples.

FIG. 36 illustrates a diagram of an example assembly of plant mass and plant pots within the plant receptacles, according to some examples.

FIG. 37 illustrates a rendering of an example green system attached to a frame of a geodesic dome where a vault enclosure is detached from a tile plate, according to some examples.

FIG. 38 illustrates a diagram of an example wiring, lighting, and fan system within a vault enclosure, according to some examples.

FIG. 39 illustrates a diagram of an example irrigation system where nutrient mixtures are pumped from an underfloor enclosure, according to some examples.

FIG. 40 illustrates a diagram of an example irrigation of plant mass within plant receptacles using aeroponic misters, according to some examples.

FIG. 41 illustrates a rendering of an example green system where a tile plate is attached to a frame of a geodesic dome, a vault enclosure is attached, and which is connected to an underfloor enclosure, according to some examples.

FIG. 42 illustrates a diagram of an example underfloor enclosure attached to the rest of the green system, according to some examples.

FIG. 43 illustrates an example pump container within the underfloor enclosure, according to some examples.

FIG. 44 illustrates a diagram of an example electrical system, according to come examples.

FIG. 45A illustrates an example pump control setup using a solenoid and a timer, according to some examples.

FIG. 45B illustrates an example lighting control setup using a timer, according to some examples.

FIG. 46 illustrates an example method of assembling and operating a green system, according to some examples.

FIG. 47 illustrates an example method of assembling and operating a green system, according to some examples.

### DETAILED DESCRIPTION OF THE DISCLOSURE

Described herein are systems and methods for creating and operating a human-scale space habitat concept comprising a geodesic dome. A frame system for a geodesic dome includes a plurality of struts arranged along edges of the geodesic dome, a plurality of tension cables, and at least one connector node (also referred to herein as “connector”). The connector includes a plurality of rods and a connection plate. The frame system can be assembled by connecting the plurality of struts to each other by one or more connectors, wherein a connector is connected to a strut via a pin running through through-holes on the struts and connectors. The frame system can be assembled by connecting the plurality of tension cables to the plurality of connectors such that the plurality of tension cables is planar to a face of the frame system. In some instances, before the tension cables are tightened, the geodesic dome can be deformable. The frame system can be assembled by increasing the tension force of at least one cable of the plurality of cables such that the geodesic dome is no longer deformable. The frame system may be compatible with one or more tiles, electrical systems, furnishings, etc., to produce the human-scale habitat.

The following description is presented to enable a person of ordinary skill in the art to make and use various embodiments. Descriptions of specific devices, techniques, and applications are provided only as examples. These examples are being provided solely to add context and aid in the understanding of the described examples. It will thus be apparent to a person of ordinary skill in the art that the described examples may be practiced without some or all of the specific details. Other applications are possible, such that the following examples should not be taken as limiting. Various modifications in the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various techniques and process flow steps will be described in detail with reference to examples as illustrated in the accompanying drawings. In the following description, numerous specific details are set forth in order to provide a thorough understanding of one or more aspects and/or features described or referenced herein. It will be apparent, however, to a person of ordinary skill in the art, that one or more aspects and/or features described or referenced herein may be practiced without some or all of these specific details. In other instances, well-known process steps and/or structures have not been described in detail in order to not obscure some of the aspects and/or features described or referenced herein.

In the following description of examples, reference is made to the accompanying drawings which form a part hereof, and in which it is shown by way of illustration specific examples that can be practiced. It is to be understood that other examples can be used, and structural changes can be made without departing from the scope of the disclosed examples.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combination of one or more of the associated listed items. It will be further understood that the terms “includes,” “including,” “comprises,” and/or “comprising,” when used in this specification, specify the presence of stated features, integers, steps, processes, elements, and/or components, but do not preclude the presence or addition of one or more other features, integers, steps, processes, elements, components, and/or groups thereof. “About” and “approximately” shall generally mean an acceptable degree of error for the quantity given the nature or precision of the quantity. Exemplary degrees of error are within 20 percent (%), typically, within 10%, and more typically, within 5% of a given value or range of values.

### Frame System for a Geodesic Dome

### Overview

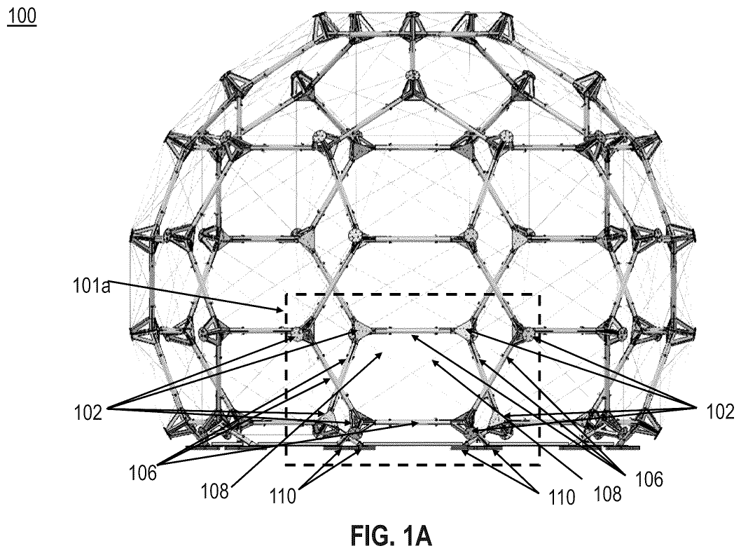

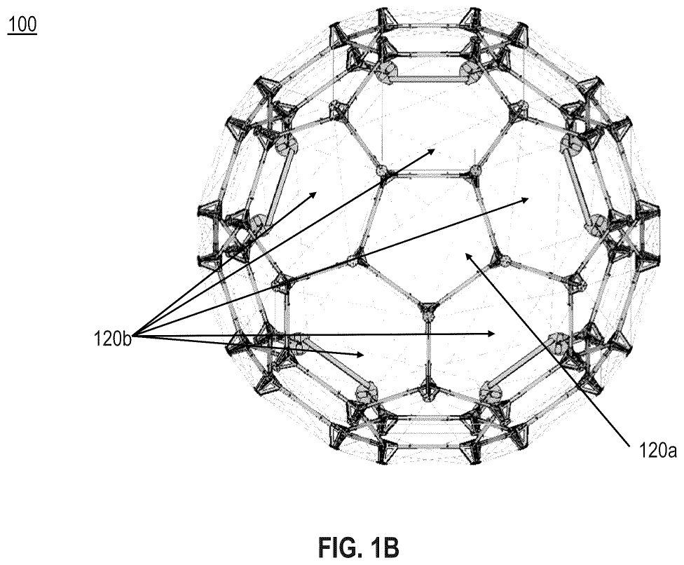

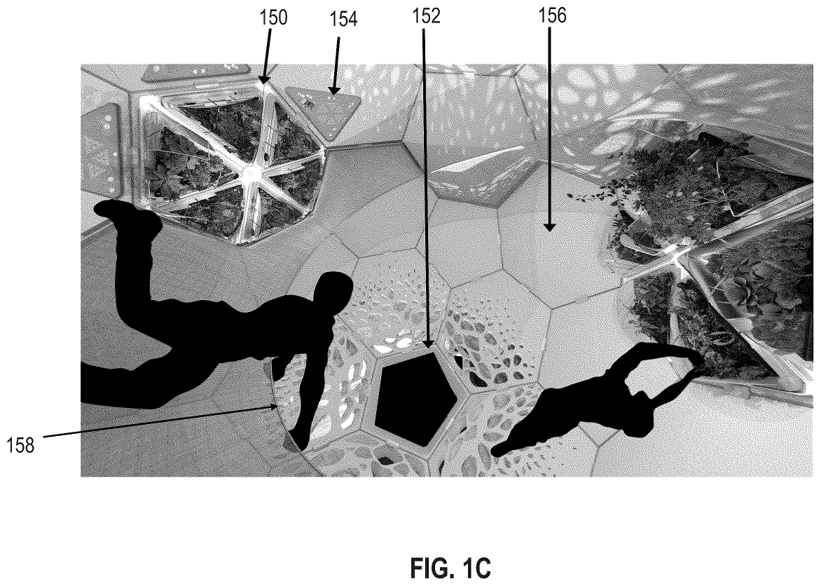

FIG. 1A illustrates a side-view rendering of an assembled frame system 100 without any tiles installed, according to some examples. Recognizing the effects of gravity on Earth, in some aspects, the frame system 100 may not form a complete geodesic dome shape once assembled. In some aspects, the frame system 100 may form a truncated icosahedron geodesic dome. In some aspects, the truncated shape of frame system 100 may be approximately ⅔ of a complete geodesic dome shape. The overall specifications of the exemplary frame system 100 can be, but are not limited to: height: 19 feet; diameter at base: 19 feet; widest diameter: 24 feet; weight: ˜3,500 pounds; internal volume: 4,672 cubic feet; floor area: ˜250 square feet; number of full hexagon faces: 14; number of full pentagon faces: 6.

As shown in FIG. 1A, the frame system 100 is constructed from various components. The components of the frame system 100 may be configured to be easily assembled and disassembled. Example portion 101a of the frame system 100 illustrates a high-level structural overview of how exemplary components may be arranged relative to each other to form the frame system 100. In some aspects, connectors 102 may comprise the vertices of the frame system 100, and struts 106 may connect the connectors 102 to form edges of the frame system 100. Tension cables 108 extending between the connectors 102 may provide tension reinforcement and rigidity to the frame system 100. The base of the frame system 100 may include feet 110 that are designed to support the frame system 100 above a surface, such as a flat floor.

The resulting shape of the frame system 100 may comprise a plurality of full hexagonal faces and pentagonal faces, which form the overall structure of the dome, and partially truncated faces, which terminate at the feet 110 and/or near the base of the frame system 100. A hexagonal face may include six struts 106 and six connectors 102. A pentagonal face may include five struts 106 and five connectors 102. It is to be understood that the shapes of the faces are not limited to hexagons and pentagons and could be other shapes. At least some of the struts 106 and/or connectors 102 may be shared between faces.

The arrangement of hexagonal and pentagonal faces may be illustrated in FIG. 1B, which illustrates a top view rendering of the assembled frame system 100 without any tiles installed, according to some examples. In some aspects, the frame system 100 may be oriented such that a pentagonal face 120a is located at a crown (e.g., a top surface) of the geodesic dome shape, as shown in FIG. 1B. In some aspects, one or more (e.g., each) of the five edges of the pentagonal face 120a may be shared with an edge of a hexagonal face 120b, such that at least one edge of the pentagonal face 120a is bordered by at least one edge of one or more (e.g., five) hexagonal faces 120b.

The resulting hexagonal faces 120b and pentagonal faces 120a can include one or more portions (e.g., portions of the struts 106 and/or connectors 102 that form the edges and/or vertices, respectively, of the faces 120a and 120b) where tiles, either functional or non-functional, may be attached. Functional tiles may include tiles with functional components (e.g., control panels) accessible to users inside of the dome. Non-functional tiles may have the same shape and/or weight as functional tiles but may not contain functional components accessible to users inside of the dome. In some aspects, a hexagonal face 120b and/or pentagonal face 120a can include one or more mountable frames for attaching one or more tiles. In some aspects, non-functional tiles and/or cladding (e.g., coating on a tile) can be installed in locations where there are no functional tiles.

FIG. 1C illustrates an interior-view rendering of an assembled frame system 100 with functional and/or non-functional tiles installed, according to some examples. The tiles may be attached to the frame system 100 such that portions of the tiles are accessible to human users while inside the geodesic dome habitat. The tiles can include, but are not limited to: green vault tiles 150 for growing plants, fermentation tiles for fermenting foods (not pictured), window tiles 152 for allowing human users to see outside of the geodesic dome, control panel tiles 154 for controlling various functionalities and/or settings associated with the geodesic dome, and blank tiles 156 for providing insulation and/or structural support to the geodesic dome. In some embodiments, black tiles 156 may be non-functional tiles that have the same shape and/or weight as functional tiles but may not contain functional components accessible to users inside of the frame system 100. In addition to tiles, the interior of the frame system 100 may include other furnishings 158, such as walkways, seating, walls, dividers, etc. In some aspects, the furnishings 158 may allow human users to access and/or restrict access to various parts of the geodesic dome habitat. Although FIG. 1C illustrates the frame system 100 and tiles as being in a microgravity (e.g., space-based) environment, it is to be understood that the frame system 100 and tiles may instead be in an Earth-based environment. This may allow for Earth-based use and/or testing of the frame system 100 and tiles before committing the time, money, and resources to a space-based geodesic dome habitat.

### Example Faces

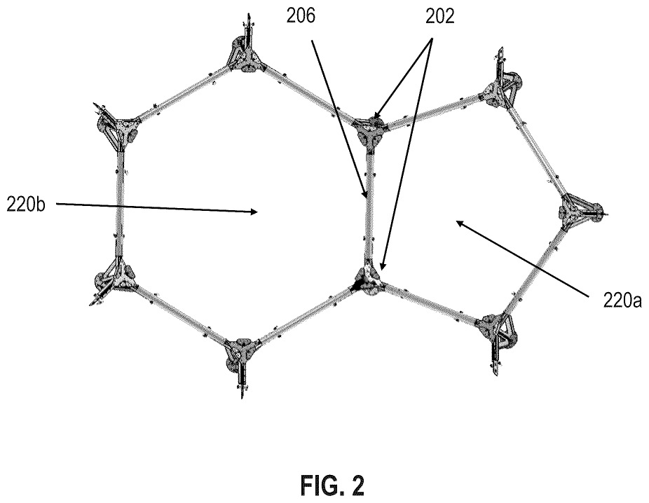

FIG. 2 illustrates a rendering of a hexagonal face 220b and a pentagonal face 220a of a frame system (such as frame system 100 of FIG. 1A), according to some examples. An assembly of struts 206 and connectors 202 form the edges and vertices, respectively, of the pentagonal face 220a and the hexagonal face 220b. The faces 220a and 220b can be oriented such that at least one edge of the hexagonal face 220b is shared with at least one edge of the pentagonal face 220a (e.g., they share a strut 206 and two connectors 202). In order to form a three-dimensional geodesic dome, the hexagonal face 220b and the pentagonal face 220a can be oriented such that they are not planar to each other. For example, the angle formed by the intersection of hexagonal face 220b and pentagonal face 220a may be greater than or less than 180 degrees. In some examples, one or more (e.g., any) faces of the frame system can be oriented such that a face is not planar to other faces.

### Example Connectors

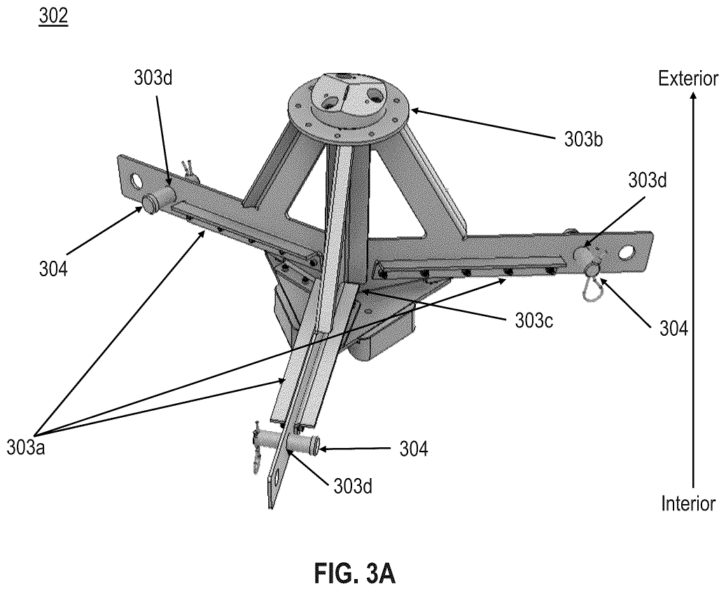

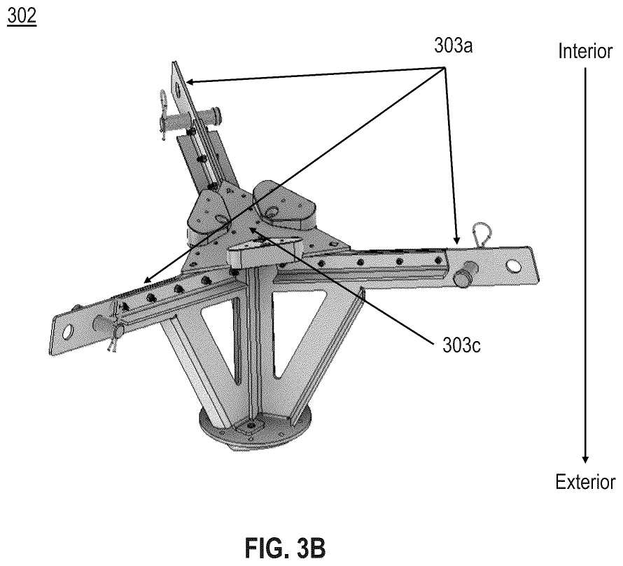

FIGS. 3A and 3B illustrate close-up renderings of a connector 302 of a frame system (such as frame system 100 of FIG. 1A), according to some examples. The connector 302 may be arranged to form a vertex of the geodesic dome. The connector 302 may be the same as connectors 102/202. The connector 302 may be interchangeable (e.g., can be used, can replace and/or be replaced by other connectors 302). The connector 302 includes a plurality of rods 303a configured to connect to a plurality of struts (e.g., struts 106 of FIG. 1A) and a connection plate 303b configured to connect to a plurality of tension cables (e.g., tension cables 108 of FIG. 1A). In some aspects, the plurality of rods 303a and the connection plate 303b may extend from a central connection point 303c of the connector 302. In order to connect to the struts to form the three-dimensional geodesic dome, the plurality of rods 303a may comprise at least three rods, in some aspects. One or more (e.g., each) rod of the plurality of rods 303a may comprise a mechanism for connecting to a strut. In the depicted example of FIGS. 3A and 3B, the plurality of rods 303a includes three rods 303a. A rod 303a may comprise a through-hole 303d. A pin 304 may be used to connect the through-hole 303d on a rod 303a to a corresponding through-hole 303d on a strut (e.g., strut 106 of FIG. 1A). In some aspects, the plurality of rods 303a is configured to loosely connect to at least one strut such that the geodesic dome is deformable. The ability to deform the geodesic dome after the connectors and struts are connected may help simplify the assembly of the frame system, since the placement of individual components of the frame system can be adjusted without disassembling and/or reassembling the entire structure. In some aspects, the geodesic dome may be deformable before the tension cables are tightened. In some aspects, to allow the geodesic dome to deform, at least one hexagonal face of the frame system may not be a regular hexagon (e.g., the hexagon may not be equilateral and/or equiangular), and at least one pentagonal face of the frame system may not be a regular pentagon (e.g., the pentagon may not be equilateral and/or equiangular).

FIG. 3A illustrates a top side of a connector 302. The top side may be an exterior-facing side that includes a connection plate 303b (e.g., a side configured to face outward relative to the center of the geodesic dome, once assembled). The connection plate 303b can extend from the central connection point 303c of the connector 302 such that it extends toward the exterior of the geodesic dome. When assembled together with other components to form the frame system, the connection plate 303b may be located further away from the center of the geodesic dome than the central connection point 303c. The exterior-facing configuration of the connection plate 303b allows the tension cables (e.g., tension cables 108 of FIG. 1A) to be attached to the exterior of the frame structure during assembly of the frame system. FIG. 3B illustrates a bottom side of a connector 302. The bottom side may be an interior-facing side (e.g., a side configured to face inward relative to the center of the geodesic dome, once assembled). The plurality of rods 303a can extend from the central connection point 303c of the connector 302 such that at least one rod extends toward the interior of the geodesic dome. This allows the struts (e.g., struts 106 of FIG. 1A) to be attached to connectors (e.g., connector 102, 202, and/or 302), such that adjoining faces of the frame system are not planar (e.g., the angle formed by the intersection of adjoining faces may be greater than or less than 180 degrees), which can enable three-dimensionality of the geodesic dome.

Although FIGS. 3A and 3B illustrate the connector 302 as having three rods, it is to be understood that the connector 302 may have more or less than three rods. In some aspects, rods 303a can be added and/or removed from the connector 302. In some aspects, the connector 302 may have multiple rods extending from the central connection point 303c to provide one or more connection angles for connecting one or more struts of the frame system to the connector 302. In some aspects, the position of the rods 303a relative to the central connection point 303c can be adjusted. For example, the angle between two rods can be changed by adjusting the position of one or more of the rods relative to the central connection point 303c, thereby allowing the connector 302 to provide multiple connection angles for connecting one or more struts of the frame system to the connector 302. In some aspects, the rods 303a may not connect to each other at the same location (e.g., central connection point 303c) of the connector 302. In some examples, a first rod can connect to a second rod at one location, and a third rod can connect to one or more rods at a different location. For example, the third rod may extend from a point on the second rod instead of all three rods extending from the central connection point 303c. In some aspects, the connector 302 may not have a central connection point 303c.

Although the connector 302 is described above as having one through-hole and one pin, it is to be understood that the connector 302 can have more than one through-hole and/or more than one pin. For example, in FIG. 3A, one or more (e.g., each) rod of the plurality of rods 303a include a second through-hole next to the through-hole 303d. In some examples, one or more (e.g., each) rod of the plurality of rods 303a may comprise a non-pin-based connection mechanism for connecting to a strut of the frame system. The connection mechanism can include, but is not limited to, magnet-based mechanisms, loop-and-hook mechanisms, ball-and-socket mechanisms, etc.

### Example Struts

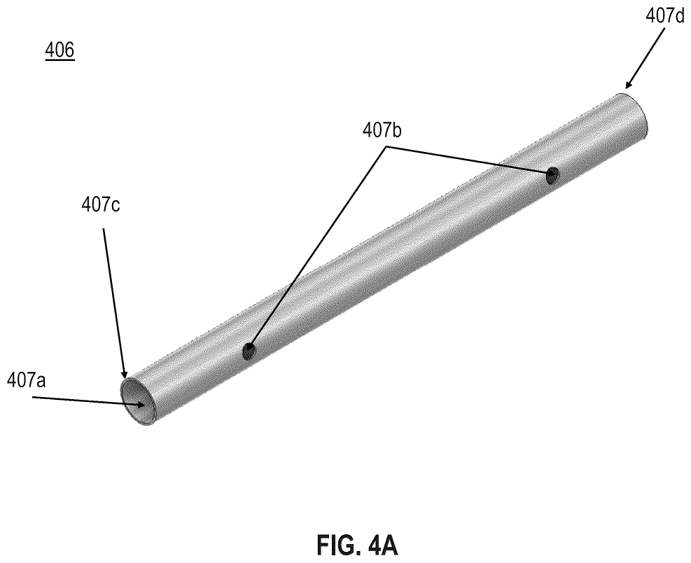

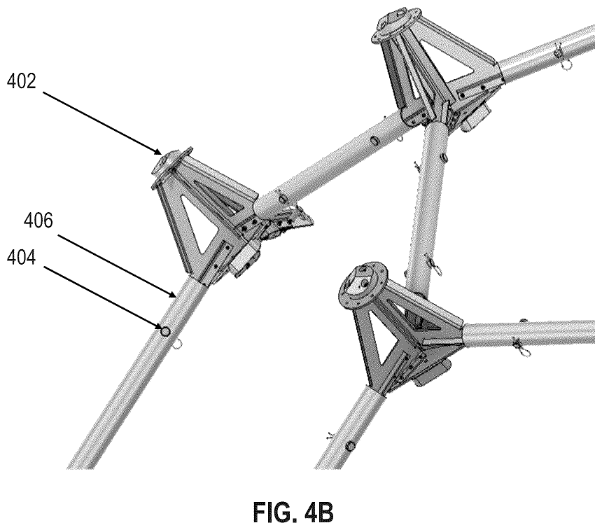

FIG. 4A illustrates a close-up rendering of a strut 406 of a frame system (such as frame system 100 of FIG. 1A), according to some examples. The strut 406 can be one of a plurality of struts (e.g., struts 106 of FIG. 1A) arranged to form edges of the geodesic dome. The strut 406 may be interchangeable with (e.g., can be used, can replace and/or be replaced by) other struts of the plurality of struts. The plurality of struts can be arranged to form at least one pentagonal face or at least one hexagonal face (e.g., pentagonal face 220a and hexagonal face 220b of FIG. 2).

As shown in FIG. 4A, the strut 406 may be cylindrical in shape, hollow, and have a rigid structure. The strut 406 can be configured to receive at least one rod (e.g., a rod from the plurality of rods 303a of the connector 302 of FIG. 3A) in the hollow opening 407a of the strut 406. The strut 406 may further comprise at least one through-hole 407b for fastening at least one rod and the strut 406 together. For example, a first rod can be slotted into the hollow opening 407a at a first end 407c of the strut 406, such that a through-hole on the first rod (e.g., through-hole 303d) and a through-hole 407b near the first end 407c of the strut 406 are aligned. A pin (e.g., pin 304 of FIG. 3A) can extend through two or more through-holes (e.g., through-holes 303d and 407b) to fasten the first rod and the first end 407c of the strut 406 together. In some aspects, a second rod can be slotted into the hollow opening 407a at a second end 407d of the strut 406 such that a through-hole on the second rod and a through-hole 407b near the second end 407d of the strut 406 are aligned, and a pin can be used to fasten the second rod and the second end 407d of the strut 406 together.

FIG. 4B illustrates a close-up rendering of an exemplary connection between connectors 402 and struts 406 of a frame system (such as frame system 100 of FIG. 1A), according to some examples. A connector 402 may be placed at an end of a strut 406 such that a rod of a connector fits inside of the hollow opening of the strut 406. Pins 404 may extend through through-holes on the connectors 402 and through-holes on the struts 406 to connect the connectors 402 and struts 406.

### Example Tension Cables

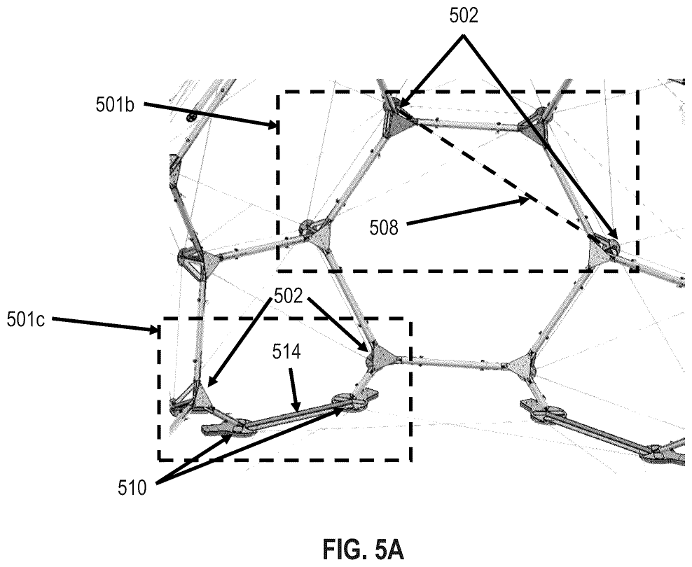

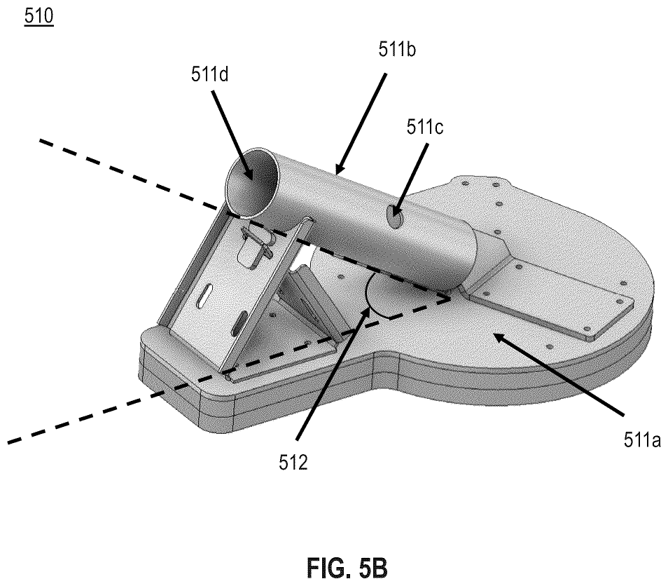

FIG. 5A illustrates a rendering of a base section of a frame system (such as frame system 100 of FIG. 1A) that includes a plurality of tension cables 508, according to some examples. The plurality of tension cables 508 are attached to a plurality of connectors 502 to provide tension reinforcement and rigidity to the frame system. A tension cable 508 can be attached to a first connector 502 and a second connector 502. For example, portion 501b of the frame system includes a tension cable 508 that is attached to two connectors 502. As shown in the figure, the tension cable 508 is attached to the connection plates (e.g., connection plate 303b of connector 302 of FIG. 3A) of the connectors 502. The connection plates extend outward relative to the center of the geodesic dome, and the tension cable 508 is positioned outward relative to the struts (e.g., struts 106 of FIG. 1A) of the frame system. This allows the plurality of tension cables (including tension cable 508) and the plurality of struts to connect to the same or nearby connectors (including connectors 502) without colliding and/or interfering with one another.

The plurality of tension cables can be planar relative to a face of the frame system (e.g., the flat surface formed by the tension cables and the flat surface of the face may be approximately parallel to each other). As shown in the portion 501b of FIG. 5A, the connectors 502 are part of the same face of the frame system (e.g., both connectors form corners of a hexagonal face). A tension cable (including tension cable 508) is configured to be adjustably connected to the connection plates such that a tension force of a tension cable is adjustable. For example, a tension cable may be attached to a connection plate (e.g., connection plate 303b of connector 302 of FIG. 3A) via a tension screw on the connection plate. The tension cable may be attached to the tension screw such that, if the tension screw is rotated in one direction, the tension cable is pulled tighter (e.g., tension force increases), and if the tension screw is rotated in the opposite direction, the tension cable is loosened (e.g., tension force decreases).

### Example Base/Floor

As mentioned previously, FIG. 5A illustrates a rendering of a base section of a frame system (such as frame system 100 of FIG. 1A), according to some examples. The base section of the frame system includes feet 510 that are designed to support the frame system above a flat surface (e.g., a floor). In the portion 501c of the frame system, two feet 510 are positioned at the base of the frame system. A foot 510 is connected to a connector 502, which is, in turn, connected to various struts and other components of the frame system. In some aspects, one or more (e.g., each) foot 510 is connected to a connector 502. Attached between the two feet 510 is an optional beam 514, which may ensure that the feet 510 maintain a fixed distance from each other. The beam 514 may improve the stability of the frame system.

FIG. 5B illustrates a close-up rendering of a foot 510 of a frame system, according to some examples. The foot 510 includes a flat panel 511a configured to lay flush against a surface (e.g., the floor), and a hollow strut 511b connected to the flat panel 511a at an angle 512 relative to the top surface of the flat panel 511a. In some aspects, the angle 512 may range between 30-90 degrees. The hollow strut 511b can be configured to receive at least one rod (e.g., a rod from the plurality of rods 303a of connector 302 of FIG. 3A) in the hollow opening 511d of the hollow strut 511b. For example, a rod can slot into the hollow opening 511d of the hollow strut 511b such that a through-hole on the rod (e.g., through-hole 303d of FIG. 3A) and a through-hole 511c on the hollow strut 511b are aligned. A pin (e.g., pin 304 of FIG. 3A) can extend through through-holes to fasten the rod and the hollow strut 511b together. The pin-based fastening mechanism connects the foot 510 of the frame system to a connector (e.g., connectors 502 of FIG. 5A), connecting the foot 510 to the rest of the frame system.

Although FIGS. 5A and 5B illustrate the connectors 502 as being directly attached to the feet 510, it is to be understood that additional components can be used to connect the connectors 502 and the feet 510. For example, in some aspects, struts (such as struts 106 of FIG. 1A) can be used as intermediary components in the connection of the connectors 502 and the feet 510. One or more (e.g., each) of the feet 510 can connect to a first end of a strut, and one or more (e.g., each) of the connectors 502 can connect to the second end of a strut.

In some examples, the feet 510 (e.g., and, by extension, the frame system) can be positioned on a top surface of a floor system. The floor system may be part of the geodesic dome system and may be assembled and/or disassembled together with the other components of the geodesic dome. Humans inside of the geodesic dome may be able to walk on any surface of the floor system. The floor system can include a floor positioned at the base of (e.g., underneath) the frame system of the geodesic dome. The floor may be sloped such that a center of the floor is lower than an edge of the floor adjacent to the foot 510. For example, the floor may have a concave and/or bowl-like shape such that it includes a ring of higher elevation beneath the feet 510 of the frame system, and a central region of lower elevation where the feet 510 are not positioned. In some examples, the lowest point of the floor system may be located beneath the highest point of the geodesic dome.

In some examples, the floor system may further include a catwalk extending from the edge of the floor toward the center of the floor. The catwalk may be elevated and/or suspended above the surface of the floor. In some examples, the catwalk may not follow the contour of the floor (e.g., the catwalk does not change in elevation throughout its length). Alternatively, the catwalk may mirror the contour of the floor.

In some examples, the floor system may further include an underfloor enclosure. The underfloor enclosure may be located at least partially beneath the floor of the floor system and may connect to the tiles (e.g., functional tiles, as described below). The underfloor enclosure may include components that are used in conjunction with the tiles, such as a nutrient container configured to house one or more nutrient mixtures; a pump container configured to pump the one or more nutrient mixtures; a switch box configured to house an electrical system; a chiller-heater, electric fan, and/or reservoir configured to control the temperature of thermal plates; and/or an electrical control panel for the chiller-heater, fan, and/or reservoir.

### Example Assembly of Frame System

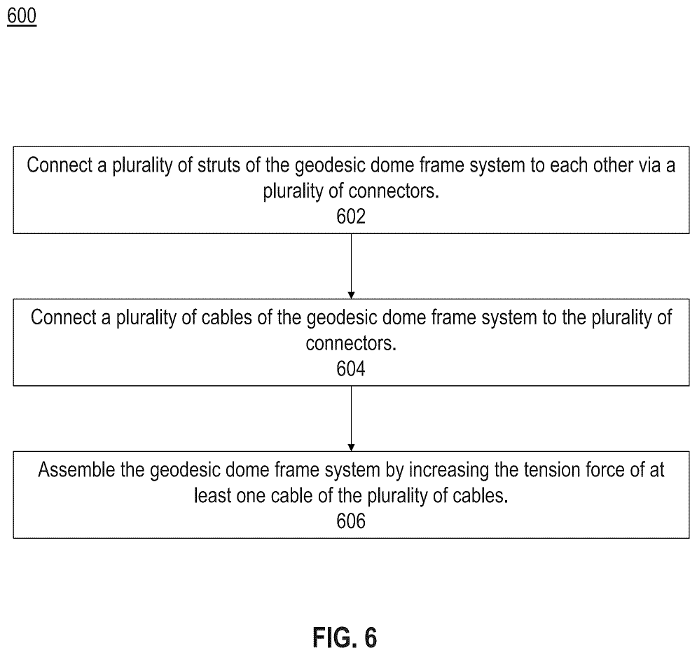

FIG. 6 illustrates a flow chart of an exemplary process 600 for assembling a geodesic dome frame system, according to some embodiments. Process 600 includes connecting a plurality of struts, a plurality of connectors, and a plurality of tension cables to form the geodesic dome frame system. The frame system can be any frame system (such as frame system 100 of FIG. 1A).

In process 600, some blocks and/or steps are, optionally, combined, the order of some blocks and/or steps is, optionally, changed, and some blocks and/or steps are, optionally, omitted. In some examples, additional steps may be performed in combination with the process 600. Accordingly, the operations as illustrated (and described in greater detail below) are exemplary by nature and, as such, should not be viewed as limiting.

At step 602, a plurality of struts of the geodesic dome frame system may be connected to each other via a plurality of connectors of the geodesic dome frame system. One or more (e.g., each) connector (of the plurality of connectors) may comprise a first through-hole configured to connect to at least one strut (from the plurality of struts). The strut may comprise a second through-hole. The connector may be connected to the at least one strut via a pin running through the first through-hole and the second through-hole. The pin-based connection mechanism may have a loose tolerance (e.g., the pin may be smaller than the through-holes, which allows the connector and/or the at least one strut to be moveable to some degree). The loose tolerance of the pin-based connection mechanism may allow the geodesic dome frame system to be deformable at step 602 (e.g., the struts and the connectors may be attached, but they may have some degree of movement relative to one another).

At step 604, a plurality of tension cables of the geodesic dome frame system may be connected to the plurality of connectors (e.g., via connection plates 303b of connectors 302 of FIG. 3A). The tension cables may be connected such that they are planar to a face of the frame system (e.g., hexagonal face 220b or pentagonal face 220a of FIG. 2). The tension cables are configured to be adjustably connected to the plurality of connectors such that a tension force of one or more (e.g., each) tension cable is adjustable. In some aspects, the tension cables can be tightened to increase the tension force. In some aspects, the tension cables can be loosened to decrease the tension force.

At step 606, the geodesic dome frame system may be assembled by increasing the tension force of at least one cable of the plurality of cables such that the geodesic dome frame system is no longer deformable. Increasing the tension force of a given tension cable can increase the tension between a plurality of connectors to which the tension cable is attached. In some aspects, increasing the tension can shorten the distance between connectors. In some aspects, increasing the tension may reduce the degree of movement available to the struts and connectors of the frame system, thereby reducing the deformability of the frame system.

### Example Attachments

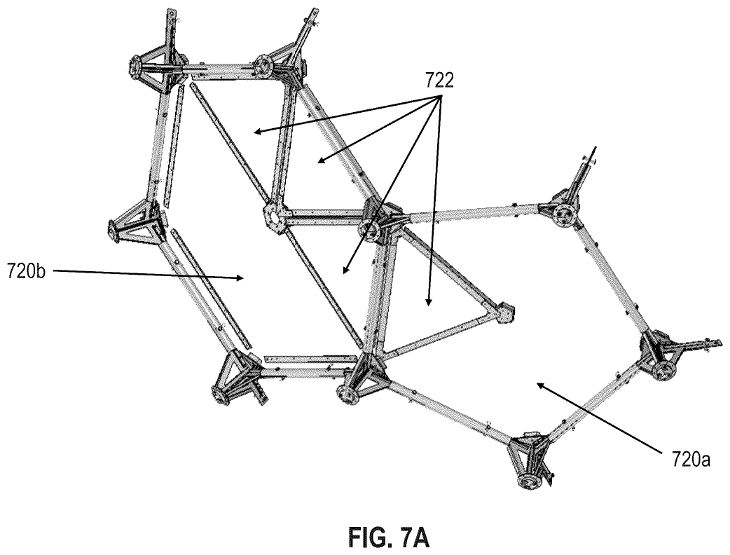

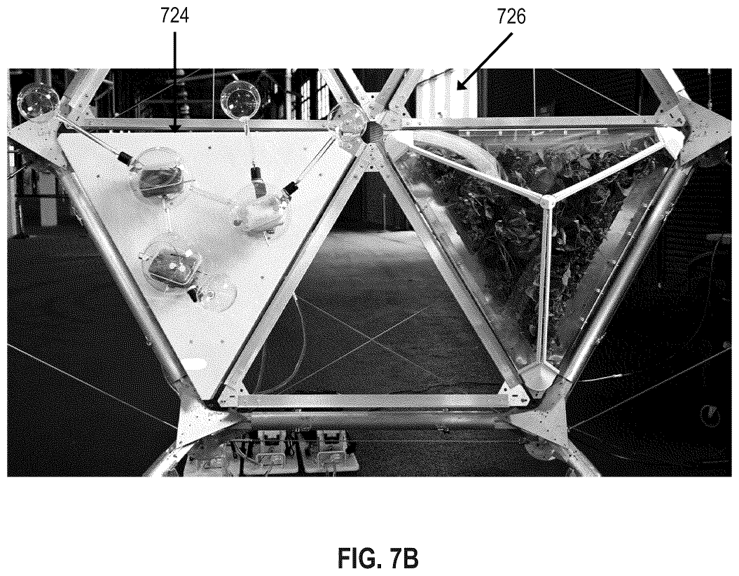

Tiles (functional and/or non-functional) can be attached to the faces of the frame system. The tiles can be installed in a mountable frame of the frame system. The mountable frame can be removably mounted to the frame system. In some examples, the mountable frame is attached to the connectors such that the mountable frame is planar to a hexagonal face or a pentagonal face (e.g., the flat surface of the mountable frame may be approximately parallel to the flat surface of a face). The mountable frame may include a triangular bracket configured to hold one or more triangular tiles. In some examples, up to six triangular brackets can be installed per hexagonal face. For example, FIG. 7A illustrates a rendering of a hexagonal face 720b and a pentagonal face 720a of a frame system (such as frame system 100 of FIG. 1A) with triangular brackets 722 installed, according to some examples. The triangular brackets 722 may be configured to support one or more of a panel (e.g., a non-functional tile) and a baseplate (e.g., a part of a functional tile). As shown in FIG. 7A, the hexagonal face 720b and/or the pentagonal face 720a can include triangular brackets 722. Up to six triangular brackets 722 can be arranged on the hexagonal face 720b, and up to five triangular brackets 722 can be arranged on the pentagonal face 720a. The triangular brackets 722 may be arranged such that two adjacent triangular brackets 722 have two adjoining vertices and one adjoining edge. It is to be understood that the shape of the brackets of the mountable frame are not limited to triangles and could be other shapes.

The shape of the triangular brackets 722 (such as the internal angles, the edge length, etc.) can be adjusted to allow the triangular brackets to fit on different sections of the different faces 720a and 720b. For example, the triangular brackets 722 on the hexagonal face 720b may be approximately regular triangles in shape (e.g., equiangular and equilateral). However, the same shape may not be appropriate for the triangular brackets 722 of the pentagonal face 720a because five regular triangles do not form a pentagon when arranged together. Instead, at least one triangular bracket 722 of the pentagonal face may be an irregular triangle (e.g., not equiangular and/or not equilateral).

FIG. 7B illustrates an image of example tiles attached to triangular brackets on a hexagonal face (e.g., hexagonal face 720b of FIG. 7A) of the frame system, according to some examples. The tiles can include, but are not limited to, functional tiles such as fermentation tiles and green vault tiles. As shown in FIG. 7B, the tiles may be arranged such that one or more functional components of the tiles (e.g., the chambers in which fermentation occurs, plants grow, etc.) are facing inward relative to the center of the geodesic dome. This allows human users to access the functional components of the tiles while inside of the geodesic dome habitat.

Functional tiles may include tiles with one or more functional components (e.g., control panels) accessible to users inside of the dome. A functional tile may include a baseplate upon which the functional components are attached. Functional tiles can be configured to remain functional under a wide range of temperature, humidity, and altitude conditions. In some examples, the functional tiles are configured to function when exposed surfaces of the tiles remain in the temperature range of 32° F. to 104° F. In some examples, tiles are mounted to the frame system as follows: a hexagonal face may be subdivided into six individual tile mounting locations, with a tile being an equally sized equilateral triangle (e.g., triangular brackets 622). The edges of the triangles may be constructed of aluminum L extrusions and include through-holes for fasteners to be inserted from the back (e.g., exterior-facing) surface of one or more (e.g., each) leg. For example, the edges may include five through-holes for ¼″ fasteners for a total of 15 mounting locations. The tiles can incorporate ¼″-20 threaded holes with a minimum thread depth of ½″ matching the location of one or more (e.g., each) through-hole. Threaded holes can be accessible from the back of the assembly, such that a ¼″-20 fastener can be inserted through the hole in the aluminum extrusion and into the threaded feature. One or more (e.g., each) tile can provide this threaded connection point for up to 15 positions per triangle. Threaded inserts or threaded nut plates can be used if the volume can be accommodated. In some aspects, functional tiles can be configured to be as quiet as possible. Noise producing components (e.g., fans) can be located toward the exterior of the geodesic dome to minimize noise transmitted to the interior.

Non-functional tiles can include tiles that have the same shape and/or weight as functional tiles but may not include functional components accessible to users inside of the dome. In some aspects, non-functional tiles may have approximately the same weight as functional tiles to balance the weight distribution of the geodesic dome (e.g., to ensure that the left side of the dome is not significantly heavier than the right side of the dome). A non-functional tile may be referred to herein as a “panel.” The non-functional panel may be configured to provide structural support to the frame system, close gaps in the frame system that are not covered by functional tiles, balance the weight distribution on the frame system, etc.

### Example Electrical Connections

Electrical connections (e.g., wires, lines, cables, etc.) for providing power to one or more components in the geodesic dome (e.g., lights) are compatible with the frame system. Current flows through the electrical connections and does not flow through the frame system itself. The frame structure is grounded and is not used as a current return path, except in fault conditions. The frame system may be configured such that power lines are isolated from the frame system (>1 MOhm). In some aspects, exposed conductive surfaces may be grounded (<0.1 Ohm) through a power supply cable.

Electrical power for attachments (single phase 120 VAC, 60 Hz) can be distributed through the frame system using extension cords supplying a maximum of 15 amps. Tiles can provide a NEMA 5-15 male connector for receiving power. This can incorporate a bulkhead connector (e.g., a NEMA 5-15 power inlet connector, or an IEC style grounded connector) so that the power cord can be completely removed as to not interfere with tile installation. An example of a connector that meets the requirements is TE PEOSXSSX0. Multiple tiles may be fed from the same upstream circuit, and one or more (e.g., all) tiles can be configured according to a maximum power draw for load balancing purposes. The frame system may be compatible with in-line GFCI protection devices upstream of one or more (e.g., all) tile connections. Devices can be used wherever possible to prevent unintentional decoupling of connections.

### Fermentor System for a Geodesic Dome

### Overview

Described herein are systems and methods for creating and operating a fermentor system to be used in a human-scale space habitat comprising a geodesic dome. The fermentor system can include one or more housings (e.g., orbs) that can house one or more thermal plates and one or more ferments. The fermentor system can include a tile plate, which can include one or more receptacles. The one or more receptacles can mate with the one or more housings (e.g., orbs). The fermentor system can operate as a functional tile in a space habitat, such as a geodesic dome. A tile comprising the fermentor system can be removed from and/or reinstalled into the space habitat. The one or more thermal plates can be controlled under a control loop (e.g., a closed loop, such as a proportional-integral (PI) controller), such that a temperature for the one or more thermal plates can reach a temperature setpoint. The one or more thermal plates can be used to adjust and/or maintain the temperature of a ferment, such as yeast, via heat transfer, e.g., conduction.

Survival on extra-terrestrial environments can be challenging. Such environments may not provide natural resources essential for the survival of individuals in space. For example, forms of sustenance, such as food, and resources such as medicine and sanitizing equipment, may not be readily secured from extra-terrestrial environments. One solution to this problem may include bringing consumable resources from Earth, to space, such as packaged foods. Such a solution, however, may be limited to the amount of the brought consumable resources. The complete consumption of the resources may not be replenishable and may accordingly limit the individuals' survival in space. Alternative solutions that provide greater longevity than the use of consumable resources include the use of systems that allow for the propagating of resources. For example, systems capable of cultivating vegetation, or fermenting starter materials, need not be limited to the amount of initially brought consumable resources. Under various ranges of engineered conditions, the initially brought consumable resources can be propagated. Described herein are systems and methods for a fermentor system that can be used on Earth or in space, for the propagation of resources.

In some aspects, the fermentor system may not include mechanisms that rely on the gravitational strength of the environment. For example, the fermentor system of the disclosed examples may not use gravity-assisted pumps to control the flow of fluids. Instead, functions such as ventilation and liquid-based temperature control may rely on active movements, including the use of fans (e.g., electric fans) and/or pumps (e.g., electric peristaltic pumps). The lack of gravity-based mechanisms in the fermentor system allows for the fermentor system to operate without being mitigated by gravitational field strengths typical of extra-terrestrial environments (e.g., microgravity environments). The fermentor system can also be functional tiles, which may be modular with respect to the space habitat. That is, the fermentor system tiles can be attached (when in use), removed and stored (when not in use), and can be reinstalled (e.g., remounted) to the space habitat, via the tile plate, when use is resumed.

The fermentor system described herein may be configured to provide an environment (e.g., controlling the conditions) for cultivating ferments housed in one or more housings, e.g., orbs. The fermentor system can be integrated into a space habitat, such as a geodesic dome. The fermentor system can be integrated, in part, as a tile. The tile can be attached to triangular brackets on a hexagonal face of the geodesic dome. FIG. 7B illustrates an image of example tiles attached to triangular brackets on a hexagonal face (e.g., hexagonal face 726 of FIG. 7B) of the frame system, according to some examples. The tiles can include, but are not limited to, functional tiles such as fermentation tiles and green vault tiles. The functional tiles can be supported by a triangular bracket, as depicted in 724 of FIG. 7B. As also shown in FIG. 7B, the tiles may be arranged such that one or more functional components of the tiles (e.g., the chambers in which fermentation occurs, plants grow, etc.) are facing inward relative to the center of the geodesic dome. This allows human users to access the functional components of the tiles while inside of the geodesic dome habitat.

The fermentor system described herein may be configured to control the conditions for cultivating ferments housed in one or more housings, e.g., orbs. The orbs housing the ferments can be positioned against a tile plate, bracket, and/or tile plate. The frame, and by extension, the fermentor system and the ferments, can be mounted on a space habitat, such as a geodesic dome. The conditions for cultivating the ferments may be achieved at least in part by the fermentor system's regulation of parameters, such as, but not limited to, temperature and ventilation. The temperature may be regulated by a closed temperature control loop comprising one or more temperature sensors and an active thermoelectric chiller-heater. The active thermoelectric chiller-heater can include a liquid chiller for dissipating excess heat. The ventilation is regulated by a ventilation control loop, such as an open control loop, comprising fans. The regulation of the environmental conditions by the fermentor system allows for cultivating the ferment, such as yeast.

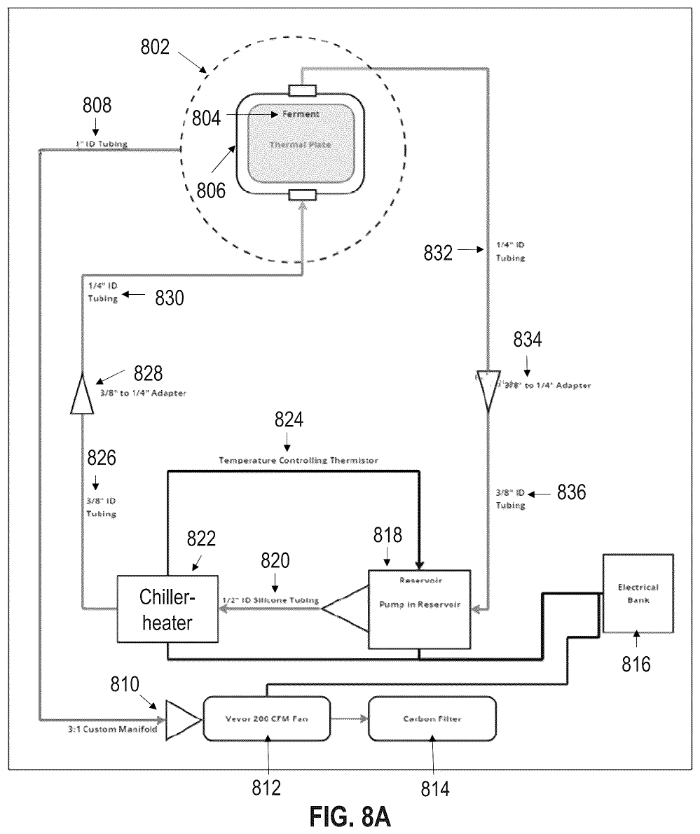

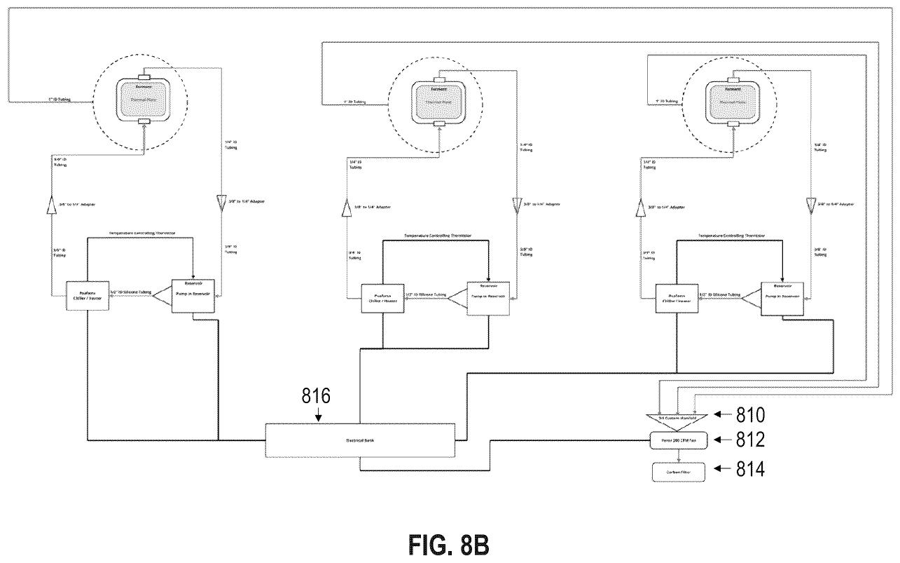

FIG. 8A shows a schematic diagram depicting an example architecture of the fermentor system, according to some examples. The fermentor system may be configured to control the cultivating conditions of a single ferment type (although multiple ferment types could be cultivated under the depicted system). Accordingly, FIG. 8A shows an implementation of the fermentor system where the fermentor system is configured to establish a single temperature setpoint and a single ventilation setpoint at a given time.

The ferment 804 being cultivated may be sealed in, e.g., a pouch that sits on top of a thermal plate 806. The ferment 804 and thermal plate 806 are located inside a housing 802, e.g., an orb. The housing 802 is ventilated, such that air from the housing 802 is drawn out via tubing 808 (e.g., 1″ inner diameter (ID) tubing) connected to a manifold 810 that leads to a fan 812. The fan 812 moves air from the housing 802 to a filter 814 (e.g., a carbon filter). The filter 814 may remove particulates, e.g., pollutants, from the air, before expelling the air into the environment (which may be the environment outside of the housing, which can include the environment outside of the space habitat. The manifold 810 may be a custom manifold, such as a 3:1 inlet:outlet custom manifold, which in the depicted implementation, can comprise unconnected manifold inlets being plugged by a stopper (e.g., a rubber seal). In implementations where more than a single inlet and a single outlet are used (e.g., when air intake comes from more than a single housing, e.g., when the fermentor system comprises more than a single housing), the custom manifold can be used.

The fan speed and the flow rate of the ventilation of the fermentor system can be under open-loop control, as depicted in FIG. 8A. The ventilation can dissipate any excess humidity or pungent odors deriving from the cultivation of the ferment 804. An electrical panel 816 can provide power to the electronic components used for ventilating the fermentor system, such as the fan 812.

The ferment 804 is under temperature control, via control of the temperature of the thermal plate 806. The thermal plate 806 may be regulated by a loop comprising a liquid (e.g., water) that is set at a desired temperature by chiller-heater 822. The chiller-heater 822 can comprise a thermoelectric module to adjust the temperature of the liquid (e.g., water), and the liquid can flow via tubing 826 (e.g., ⅜″ ID tubing) into a tubing adapter 828 (e.g., ⅜″ ID to ¼″ ID adapter), into tubing 830 (e.g., ¼″ ID tubing), and then to the thermal plate 806. The thermal plate 806 can be heated or cooled via the routed liquid originating from the chiller-heater 822. The temperature of the liquid from the chiller-heater 822 can be sensed by a sensor 824, such as a thermistor or a thermocouple, which can be used by a controller to adjust the temperature applied by the chiller-heater 822, as part of a closed-loop control scheme. Once the liquid passes through the thermal plate 806, the liquid can enter tubing 832 (e.g., ¼″ ID tubing), and flow thought adapter 834 (e.g., ⅜″ ID to ¼″ ID tubing) and tubing 836 (e.g., ⅜″ ID tubing), before entering reservoir 818. The reservoir 818 can include a pump, e.g., an active peristaltic pump, to circulate the liquid from the reservoir 818, to the chiller-heater 822 and thermal plate 806, and back to the reservoir 818. The reservoir 818 and its pump can move the liquid to the chiller-heater 822 via a tubing 820 (e.g., ½″ ID silicone tubing). The electrical panel 816 (also referred to as an “electrical bank”) can provide power to the electronic components used for regulating the temperature of the ferment 804. Example electronic components include, but are not limited to, the pump-in reservoir 818 and the chiller-heater 822.

In this manner, the temperature control loop can regulate the temperature of the ferment 804 by adjusting or maintaining the temperature of the thermal plate 806. The temperature of the thermal plate 806 may be adjusted or maintained by circulating a temperature-regulated liquid that is actively cooled or heated by the chiller-heater 822 and sensed by a sensor 824, and the temperature-regulated liquid is circulated through the loop via the reservoir 818.

FIG. 8B shows a schematic diagram depicting the architecture of the fermentor system, for controlling the cultivating conditions of multiple ferments 804, e.g., multiple ferment types. In some examples, the fermentor system may comprise three temperature control loops configured with multiple (e.g., three) temperature setpoints. It is to be understood, however, that in other implementations, greater or less than three temperature control loops can be used in the fermentor system. In some aspects, the manifold 810 is a 3:1 inlet:outlet manifold, such that one or more (e.g., each) inlet receives air from a different housing 802 and its corresponding ferment 804. Thus, a common ventilation system can be used for the plurality of housings 802 and ferments 804 in the fermentor system, as depicted in FIG. 8B, where the air flow converges onto the manifold 810. In implementations where more housings 802, ferments, and temperature control loops are used, the manifold 810 can have the same, e.g., corresponding, number of inlets as the number of housings 802 used. Like in FIG. 8A, in FIG. 8B, the air flow is powered by a fan 812, which can be located downstream of the manifold 810. The drawn air can be directed to a filter 814, which removes particulates, e.g., pollutants, including odorants. In some aspects, one or more (e.g., each) housing 802 and ferment 804 may be configured with independent temperature control schemes. For example, one or more (e.g., each) thermal plate 806 may have a dedicated and independent chiller-heater (such as the chiller-heater 822 in FIG. 8A), pump-in reservoir (such as the pump-in reservoir 818 in FIG. 8A), temperature sensor (such as the temperature sensor 824 in FIG. 8A), and thermal plate (such as the thermal plate 806 in FIG. 8A). A common electrical bank can be used to provide power to one or more (e.g., all) electrical components used for cultivating the ferments 804 of the fermentor system. One or more components included in the fermentor system discussed and depicted in FIG. 8A can also be included in the fermentor system discussed and depicted in FIG. 3B.

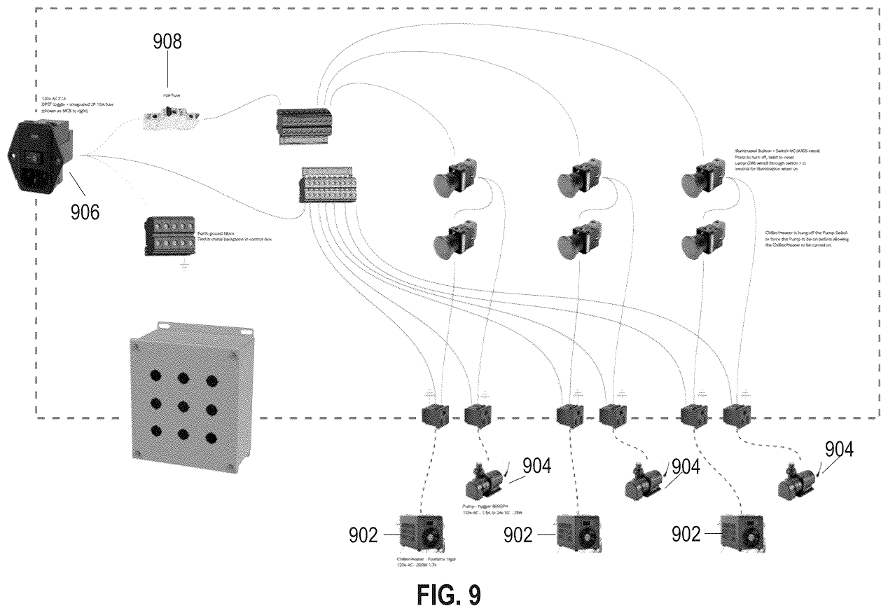

FIG. 9 depicts a high-level connectivity diagram of an example fermentor system configured with multiple temperature setpoints. Alternating current (AC) power can be provided to one or more (e.g., each) chiller-heaters 902 and pump-in reservoirs 904. The power for the chiller-heaters 902 and pump-in reservoirs 904 can be regulated by a kill switch, for example. The originating power source can be provided by AC power (120V C14) and regulated by a double-pole single-throw switch 906 with an integrated 10 A fuse 908. The electrical components can also be grounded by an Earth ground block, which can be secured against a metal plate in a control box, such as the electrical panel 816.

### Example Active Housings

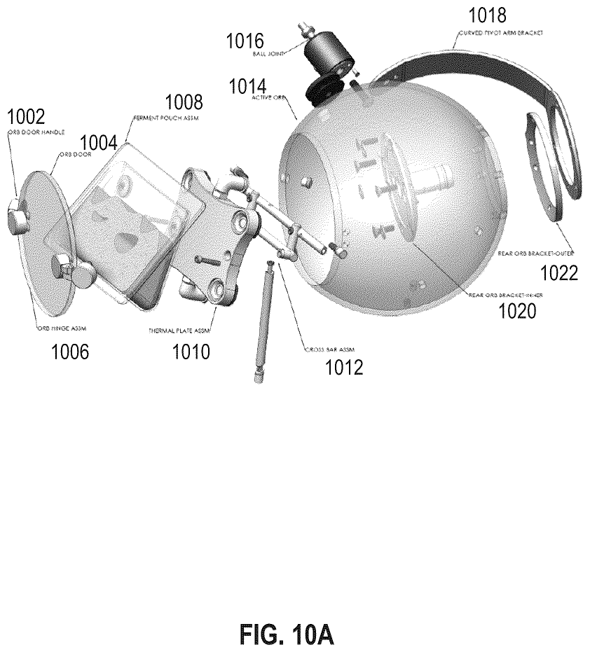

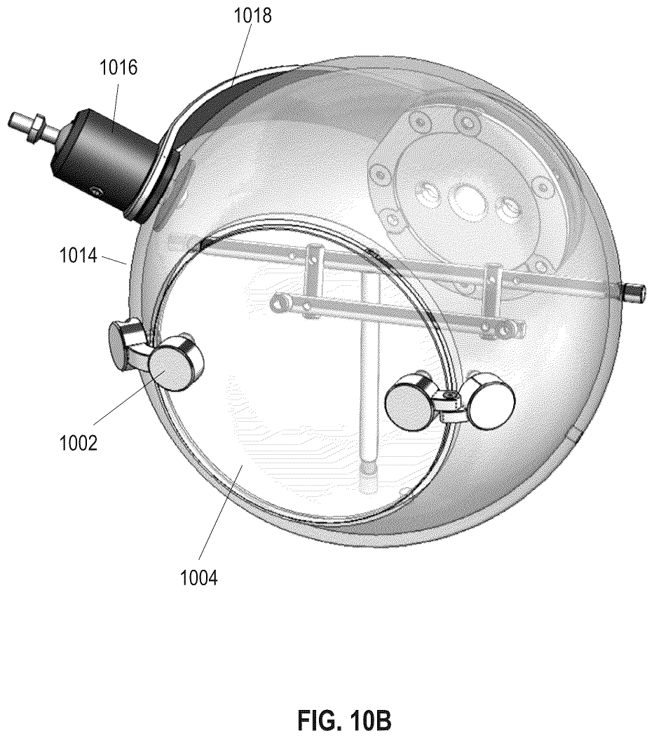

Examples of the disclosure may include one or more active housings and/or one or more inactive housings. FIG. 10A shows an exploded view rendering of the components of an active housing. An active housing refers to a housing (e.g., orb) that can house a ferment. In some examples, an active housing may regulate the environmental conditions of the ferment, such as the temperature and the air quality, including the humidity. In some examples, an inactive housing refers to a housing that is not configured to regulate the environmental conditions of a ferment. The inactive housing may lack one or more components configured to regulate the ferment's environmental conditions, such as a thermal plate.

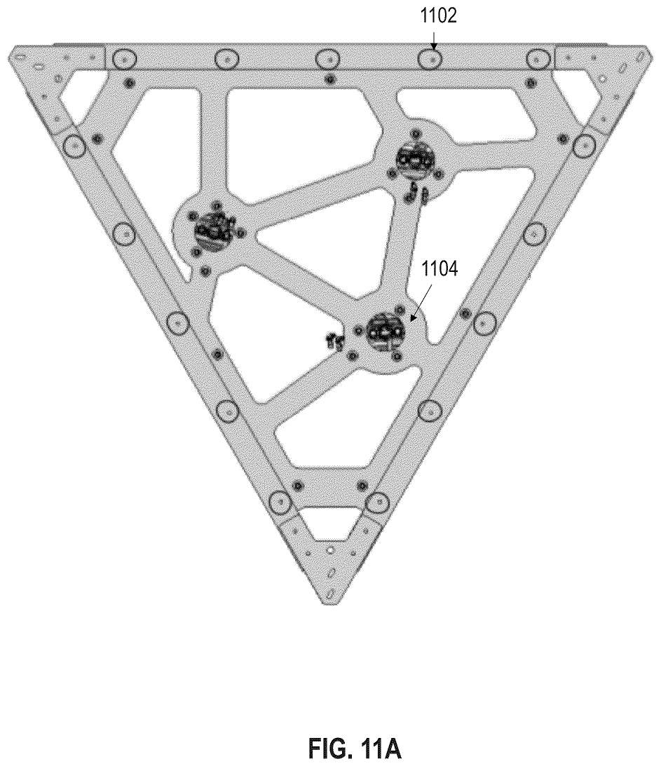

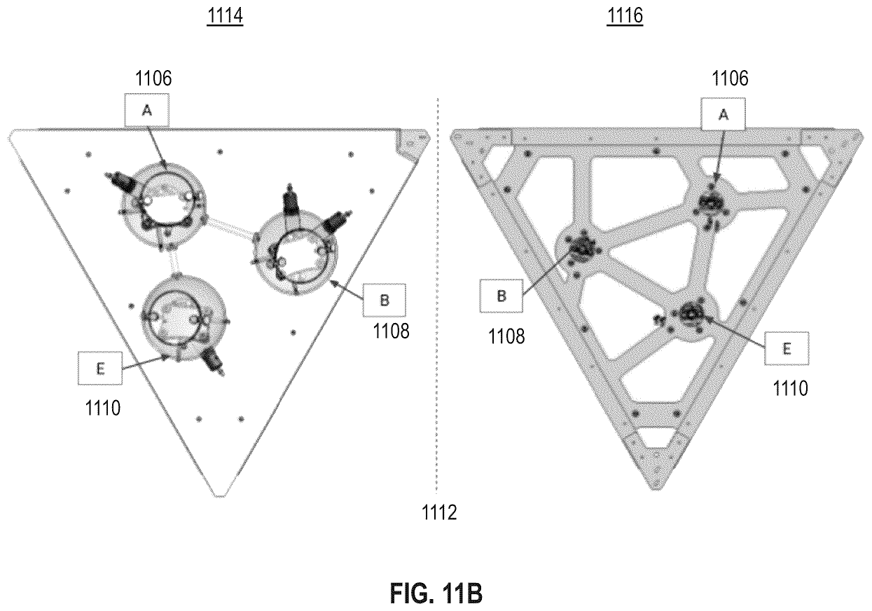

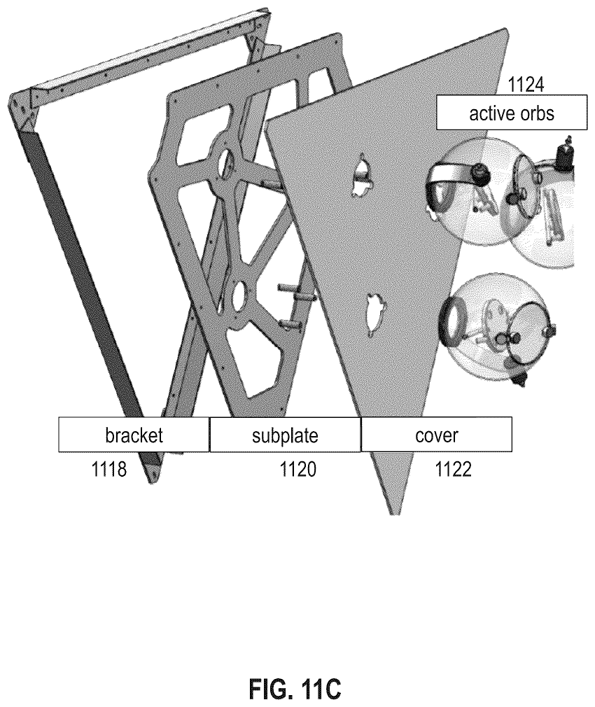

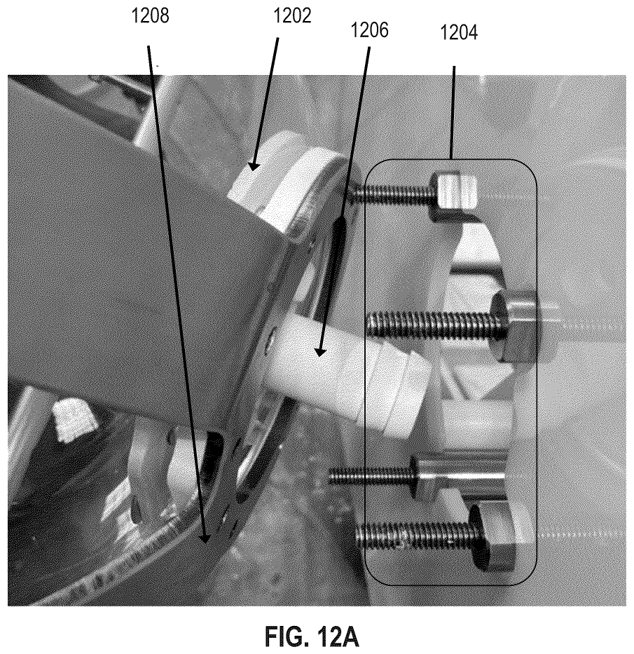

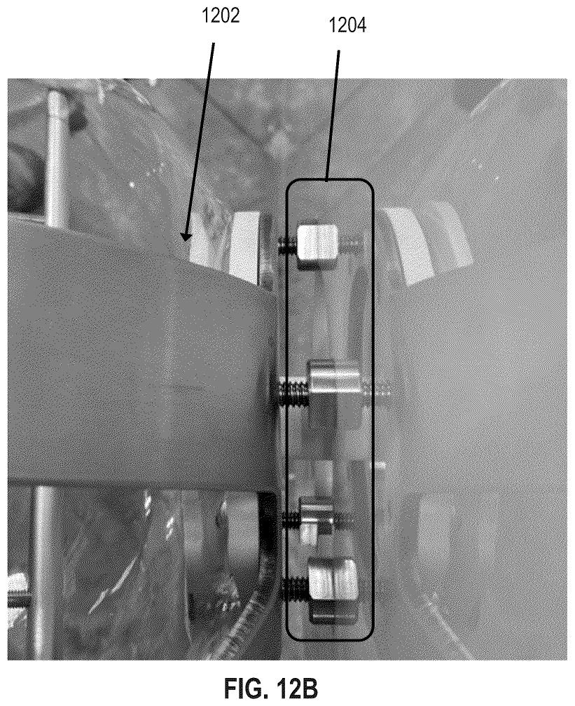

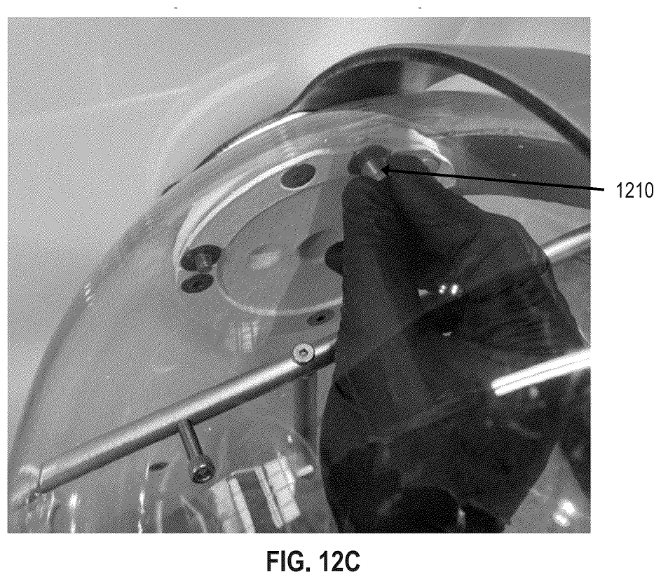

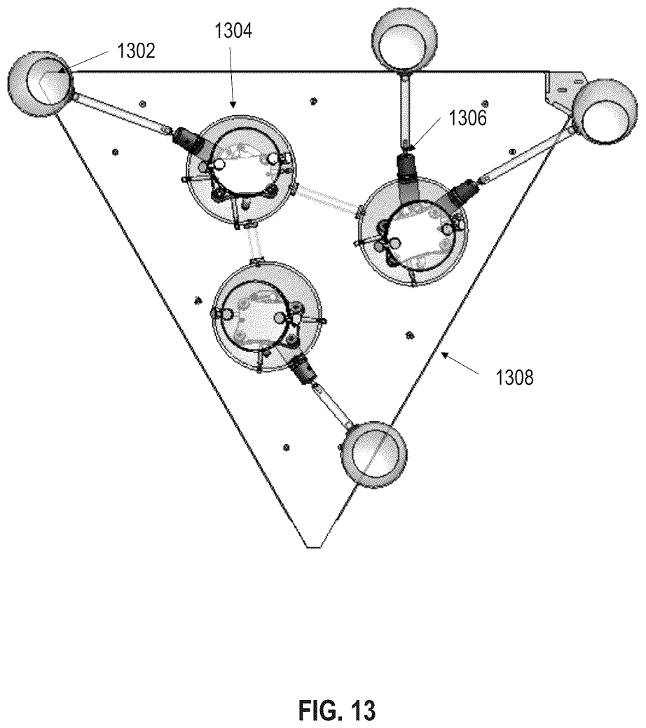

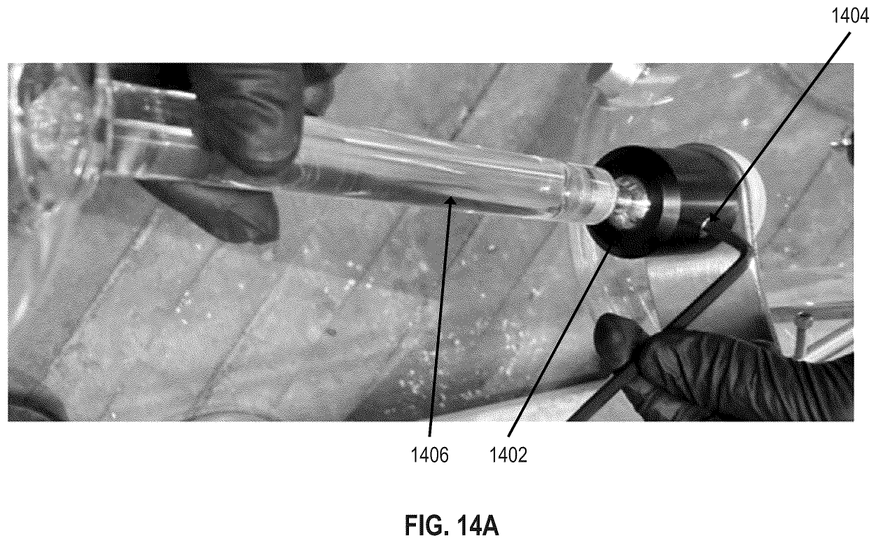

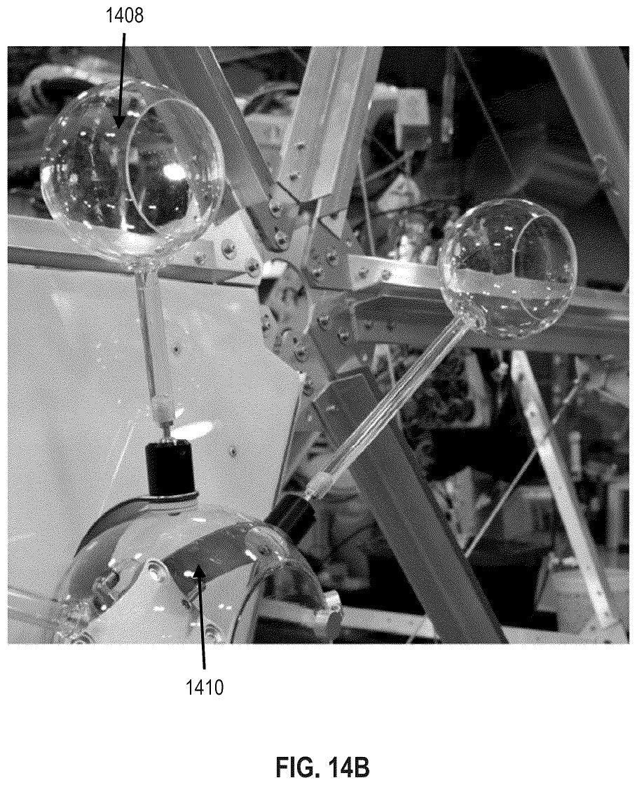

The housing can be an orb comprising glass, and can be spherical (e.g., a glass orb). As shown in FIG. 10A, the housing includes an orb door handle 1002, an orb door 1004, and an orb hinge assembly 1006. These components can be used to physically open and close the housing that regulates the environmental conditions of the ferment. The ferment can be stored in a pouch 1008. The pouch 1008 may be configured to reduce the amount of undesirable spread of the ferment across the housing. The pouch 1008 can rest atop a thermal plate assembly 1010. The thermal plate assembly 1010 can include a cross bar assembly 1012 that can assist in securing the thermal plate assembly 1010 in a desirable orientation in the active orb 1014. The orb 1014 can include a ball joint 1016 that is affixed outside of the orb, to which inactive orbs (as depicted later in FIGS. 13 and 14) can be secured. An inner rear orb bracket 1020, an outer rear orb bracket 1022, and a pivot arm bracket 1018 can operate in conjunction to secure the orb 1014 to a tile plate (as depicted later in FIGS. 11 and 12). FIG. 10B depicts an example rendering of the housing with all the components secured together, e.g., in a non-exploded view. The exterior components of the housing are shown, including the door handle 1002, the orb door 1004, the orb 1014, the ball joint 1016, and the pivot arm 1018.

### Example Tile Plate

The housings, e.g., orbs, can be secured against a tile plate, such as the one depicted in FIG. 11A. The tile plate can be mounted against structural components of a space habitat, such as a geodesic dome. The attachment pattern for mounting the frame against the space habitat is labelled with the callouts along the threaded inserts, such as threaded insert 1102. The frame depicted in FIG. 11A is triangular, in shape, but other shapes for the frame are possible (e.g., pentagonal, rectangular, etc.). The frame can include receptacles, such as receptacle 1104, which can receive and secure the housings. For example, the inner rear bracket 1020 includes through-holes for the fasteners to thread against the threaded holes of receptacle 1104. When the fasteners are threaded against the threaded holes, the housing can be secured against the frame. FIG. 11A shows three receptacles, such as receptacle 1104, for securing three housings.

FIG. 11B shows the correspondence between the receptacles of the frame and the active housings. Dashed line 1112 can be understood as a line of symmetry for a reflection. Left of the line depicts a cover 1114 which can be secured against the subplate 1116. The housings can be secured against the receptacles of the frame in a one-to-one correspondence. For example, position 1106 (A) specifies a position where a first housing can be secured against a first receptacle. Similarly, position 1108 (B) specifies a different position where a second housing can be secured against a second receptacle, and position 1110 (E) specifies yet another position where a third housing can be secured against a third receptacle. In some examples, a housing can be configured to be secured to one receptacle, but not another receptacle (the housings may not inter-mate with different receptacles of the frame).

FIG. 11C provides an exploded view of the structural components that can secure the housings to the space habitat, such as a geodesic dome. The tile plate can comprise a bracket 1118, which can be secured by a subplate 1120. Subplate 1120 can be secured by a cover 1122. The housings, e.g., active orbs 1124, can be secured on top of the bracket 1118, subplate 1120, and cover 1122.

FIG. 12 provides images, e.g., photos, of the housings, e.g., active orbs, being secured to the tile plate. In FIG. 12A, the orb 1202 has not yet been secured to its cognate receptacle 1204. The orb is being aligned to its receptacle, against the cover. In FIG. 12B, the orb 1202 is attached, but not yet secured, to its cognate receptacle 1204. The threads of four screws are inserted in the four through-holes of the orb bracket 1208, and the barb 1206 for moving fluids from the housing is secured against a tubing. In FIG. 12C, the orb is secured to its cognate receptacle 1204. Nuts, such as nut 1210, are being hand-tightened against the threads of the screws in the orb 1202.

### Example Inactive Housings

Inactive housings can be secured against the active housings via ball joints (such as ball joint 1016 depicted in FIG. 10A, ball joint 1306 in FIG. 13, or ball joint 1402 in FIG. 14A) and a rod structure 1406. The inactive housings can be used for storing materials, such as excess materials related to fermenting. The inactive housings may differ from the active housings, in that their environments may not be actively regulated for cultivating ferments. For example, inactive housings may not be configured for temperature regulation or air quality regulation. In some examples, the components that can be stored in the inactive housings may not be powered. FIG. 13 depicts a rendering of four inactive housings, such as inactive housing 1302, that are secured against three active housings, such as active housing 1304, via the ball joints, such as ball joint 1306, while the active housings are secured against the tile plate 1308. FIG. 14A provides a photo of a ball joint 1402 of an inactive orb being secured by the hand-tightening of a set screw 1404. FIG. 14B provides a photo of two inactive orbs, such as inactive orb 1408, secured against an active orb housing 1410.

### Example Temperature System

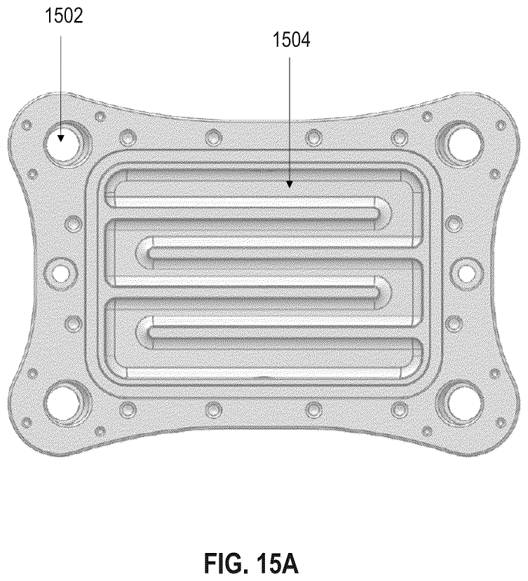

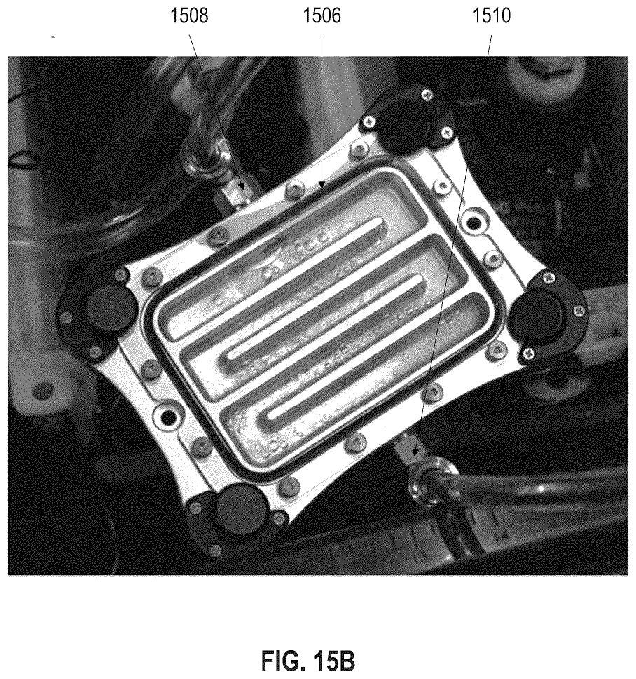

The fermentor system may include a temperature system that can control the temperature of a ferment in a housing. The temperature system includes one or more thermal plates thermally coupled to the ferment. FIGS. 15A and 15B depict the inside of a thermal plate portion used for regulating the temperature of a ferment. FIG. 15A provides a rendering of the thermal plate portion, and FIG. 15B provides a photo of the thermal plate portion. Two of the depicted thermal plate portions in FIG. 15, where one thermal plate portion similar to the other thermal plate portion, can be combined together, to form a thermal plate. The thermal plate portion can be made of a material with high thermal conductivity and high machinability, such as aluminum (e.g., aluminum alloys A6061 and AA7075) or copper. The thermal plate portion includes insets, such as inset 1502, for securing a plurality of identical or similarly shaped thermal plate portions together, such as two thermal plate portions that are similar to one another, in their shapes. In some examples, the insets 1502 may be used for securing a sealable pouch that can store the ferment. The thermal plate portion comprises an internal channel 1504 along which liquid flows, to evenly disperse the temperature across the thermal plate. The thermal plate portion also comprises an o-ring 1506 that provides a water-tight seal when two thermal plate portions are secured together, thereby reducing the liquid, e.g., water, that flows through the internal channel 1504 from leaking out. Inlet/outlet 1508 and outlet/inlet 1510 denote points of entry and/or exit of the water, as it enters or exits the internal channel 1504 of the functional thermal plate. The inlet/outlet 1508 and outlet/inlet 1510 can operate as an inlet or outlet depending on the direction with which the water flows.

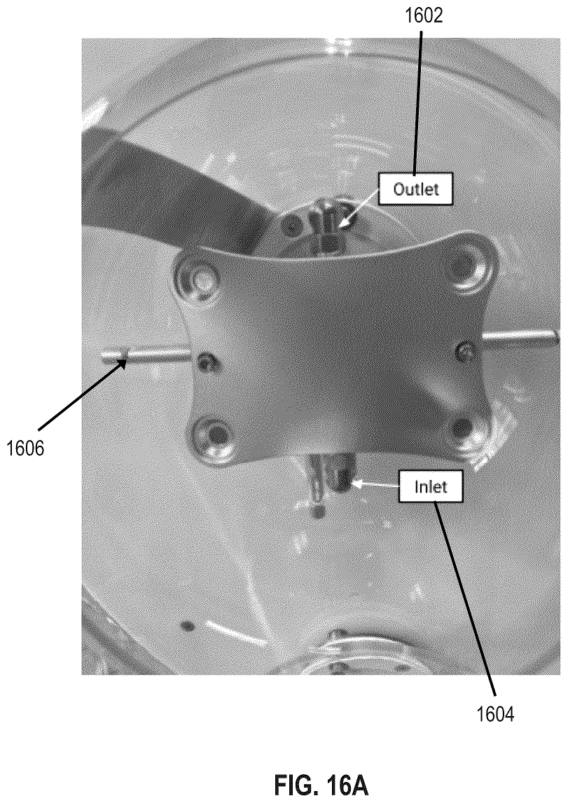

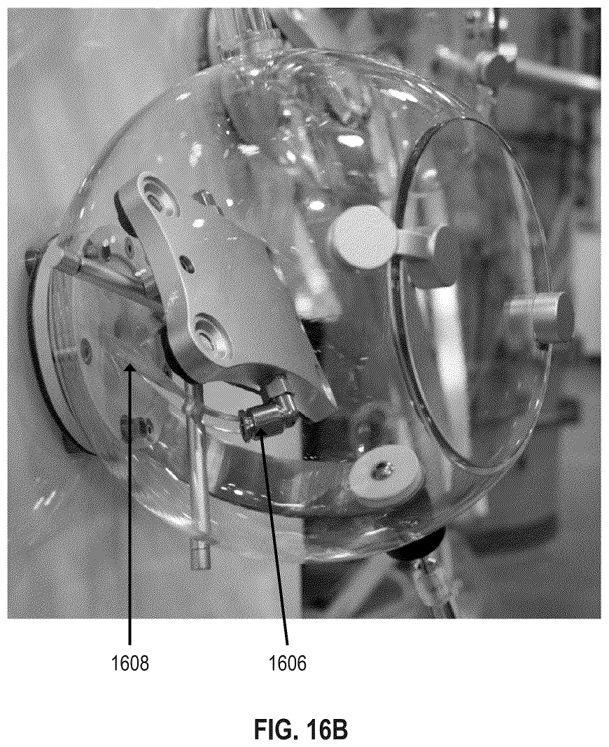

FIG. 16A depicts an assembled thermal plate secured in an active housing. The thermal plate is secured against a crossbar 1606 (as depicted also in FIG. 10A as crossbar assembly 1012). The outlet 1602 and the inlet 1604 are depicted with elbow-connectors connected to the outlet 1602 and inlet 1604. FIG. 16B provides an additional view of the thermal plate secured inside the housing. The elbow connector 1606 is connected to flexible tubing 1608, which allows the liquid, such as a coolant, e.g., water, to be routed through the thermal plate.

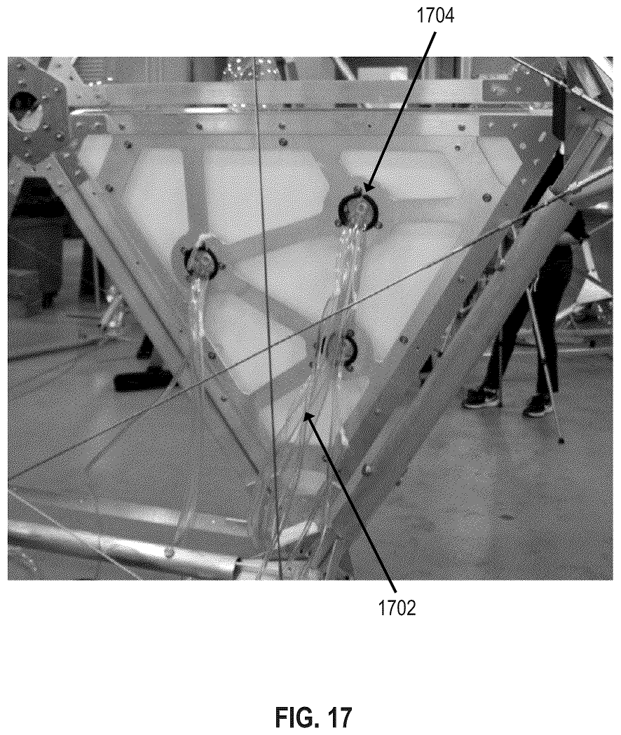

FIG. 17 depicts the backside of a tile plate of the fermentor system, including the tubing supporting the cultivating conditions for the ferments in the housings. The tubings 1702 include tubings that route the liquid from one or more (e.g., each) thermal plates for temperature control, as well as the air from one or more (e.g., each) housings, for ventilation. The backside of one or more (e.g., each) receptacles, such as receptacle 1704, includes the tubings that carry the fluids for the temperature control and ventilation.

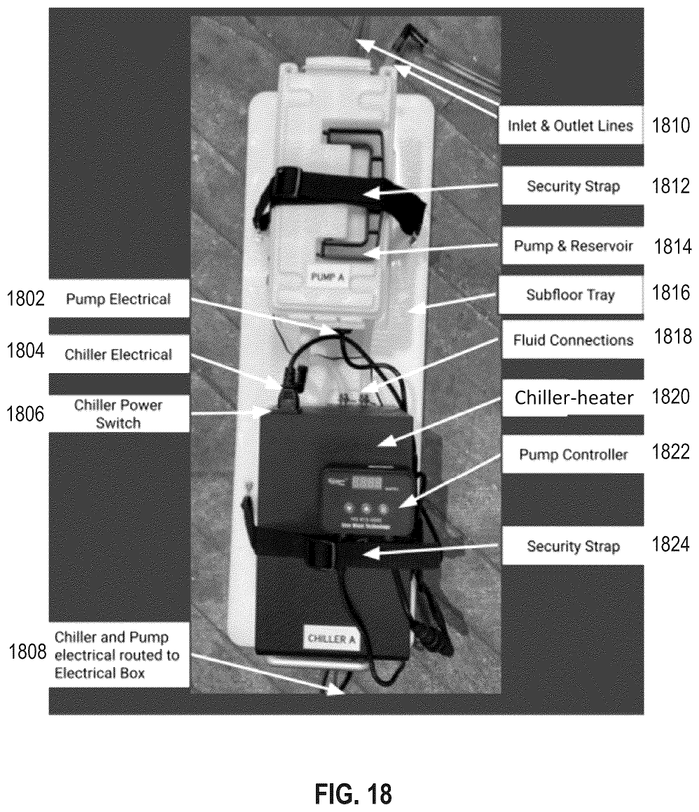

FIG. 18 depicts a chiller-heater and a pump-in reservoir for controlling the temperature of a thermal plate and ferment in a housing. Controlling the temperature of the housing includes circulating a liquid (e.g., coolant, such as water) to a thermal plate using a pump and reservoir 1814, and returning the liquid to the pump and reservoir 1814. In some aspects, the coolant may be used to cool the thermal plate and ferment and/or used to warm the thermal plate and/or ferment, e.g., warm the thermal plate and/or ferment above ambient temperatures. A biocide can be added to the coolant to prevent the growth of unwanted microorganisms (e.g., 1 mL of biocide per 12 gallons of coolant). The tubing used to circulate the coolant can be flexible, such as tubing made of polyvinyl chloride. The inlet and outlet lines 1810 facilitate the circulation of the liquid from the pump to the thermal plate and the chiller-heater 1820. The rate at which the pump circulates the liquid can be controlled by the pump controller 1822. A first security strap 1812 secures the pump and reservoir to a subfloor tray 1816, and a second security strap 1824 secures the chiller-heater 1820 to the subfloor tray 1816. Fluid connections 1818 route the fluid between the pump and reservoir 1814 and the chiller-heater 1820. The pump's electrical components 1802 and the chiller-heater's electrical components 1804 are routed to an electrical box 1808 (depicted in part in FIG. 18). The chiller-heater 1820 also includes a power switch 1806.

### Example Ventilation System

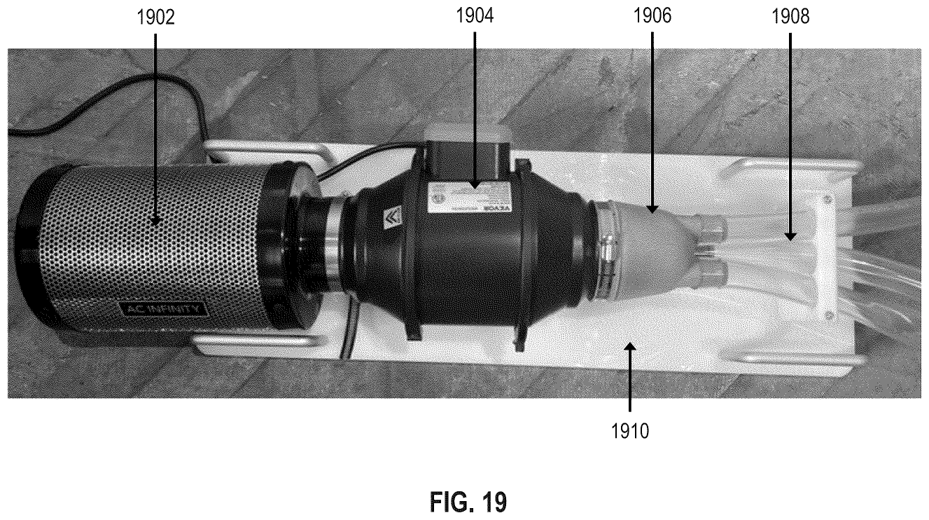

FIG. 19 depicts the ventilation system for the fermentor system. The ventilation system may be configured to ventilate the housings of the fermentor system to remove excess humidity and/or odors that may arise from the fermenting process. The air from the housings (e.g., active orbs) is drawn in via the tubings 1908, and converge into a manifold 1906 (e.g., a 3:1 inlet:outlet manifold). The air is drawn in via the electric exhaust fan 1904, which can operate, for example, anywhere between 0-200 CPM. In the case that the exhaust fan is being used for three active orbs, the air flow per orb is approximately 66.7 CFM. The fan can run quietly, relative to the limits of human audition, e.g., at 50 dB or less, such that the operation of the fan does not distract the habitants of the space habitat. The air drawn from the housings may enter a filter 1902 (e.g., a carbon filter). Part of the tubings 1908, the manifold 1906, fan 1904, and filter 1902, may be secured atop a fan tray 1910.

### Example Electrical System

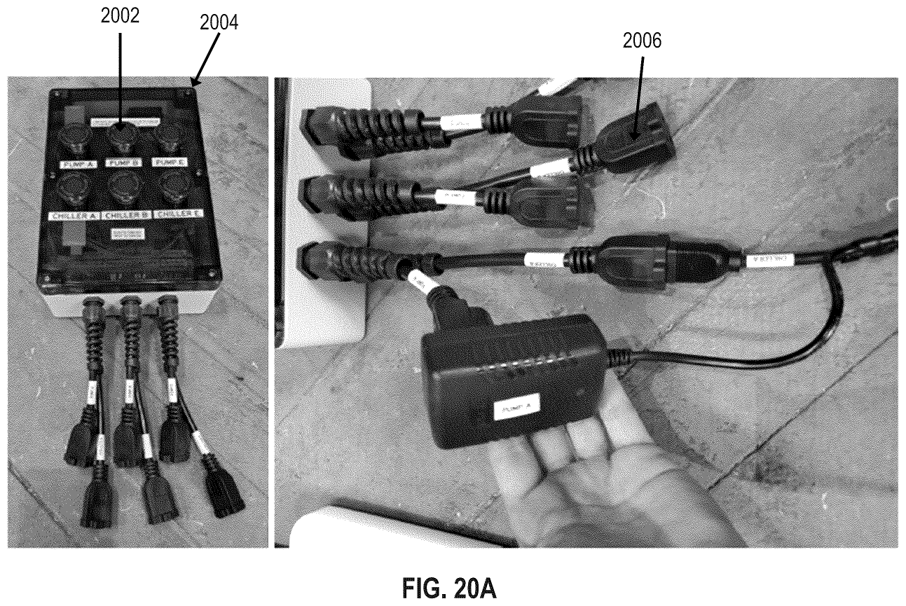

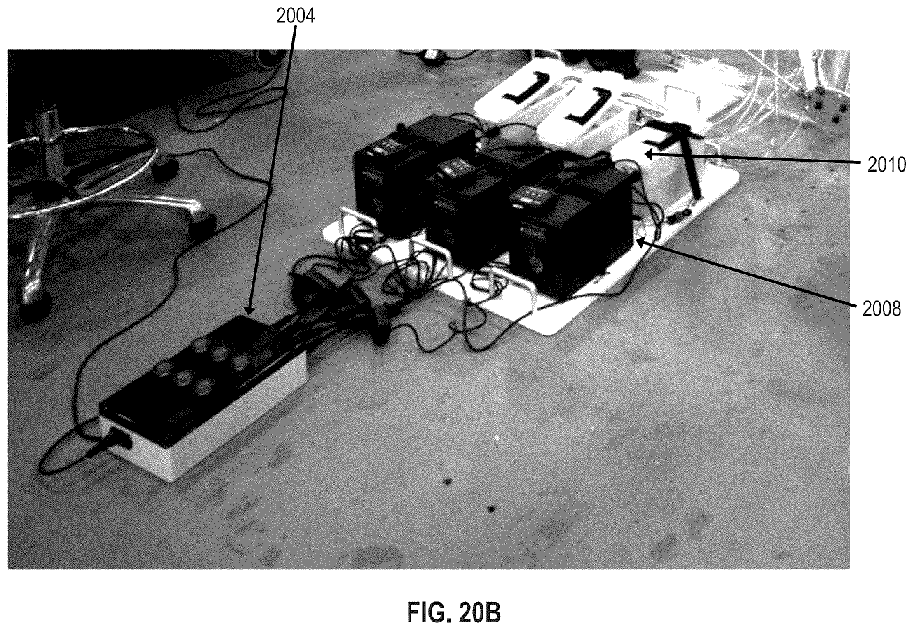

FIGS. 20A-20B provide photos of the electrical control panel that controls the chiller-heaters and pumps (e.g., pump-in reservoirs) associated with the temperature control. FIG. 20A provides photos of the electrical control panel 2004 with kill switches, such as kill switch 2002, for three pump-in reservoirs and three chiller-heaters, as well as their corresponding cables, such as cable 2006. FIG. 20B shows the electrical control panel 2004 connected to three sets of chiller-heaters, such as chiller-heater 2008, and pump-in reservoirs, such as pump-in reservoir 2010. The electrical control panel 2004 can be configured to prevent one or more pumps (e.g., pump-in reservoirs) from being turned on after one or more chiller-heaters. The electrical control panel 2004 can be configured to prevent one or more electrical components of the fermentor system from drawing a threshold amount (e.g., 10 A or more) of current. The electrical panel can be in the underfloor enclosure of the geodesic dome. As discussed previously, the underfloor enclosure can be located at least partially beneath the floor of the floor system and can include components that are used in conjunction with the fermentor system. The electrical components of the fermentor system can receive an input alternating current of 60 Hz, 120 V, in single phase. The electrical components can include the chiller-heaters, the pump-in reservoirs, the electric fan, a thermoelectric device, or any combination thereof.

### Example Ferments

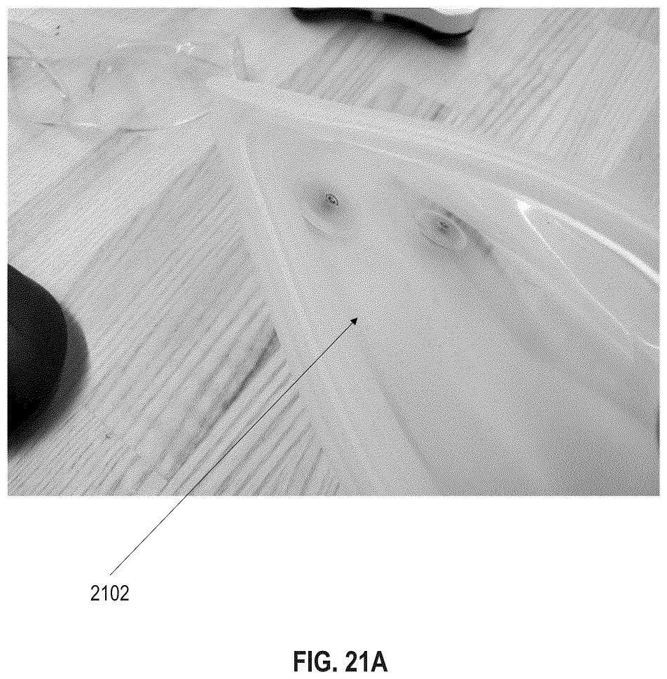

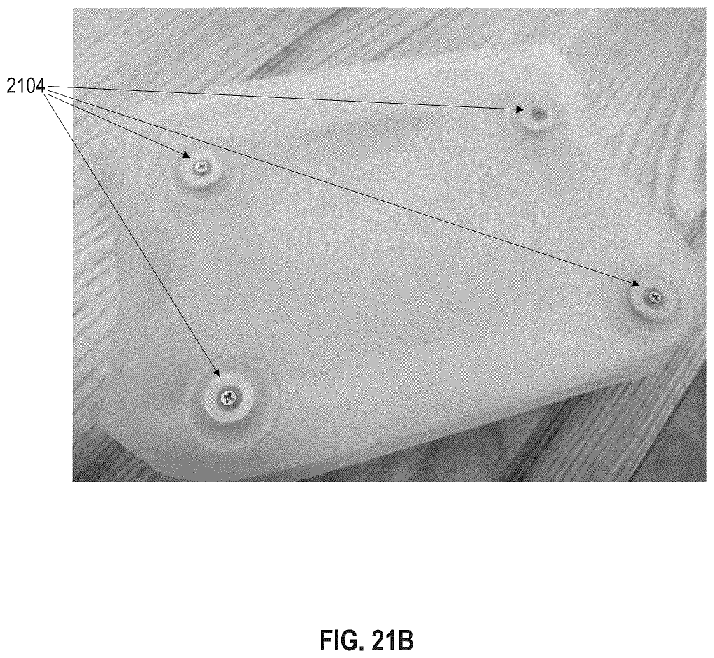

The fermentor system can provide environmental conditions for cultivating a broad range of ferments. The ferments can be enclosed in one or more sealable pouches, such that the ferment is contained, and does not spread outside the thermal plate. The sealable pouch 2102 is depicted in FIGS. 21A and 21B. FIG. 21A provides a photo of a side of the sealable pouch 2102, with the pouch open. FIG. 21B provides a photo of the bottom of the sealable pouch 2102. The sealable pouch 2102 includes sealed magnets, such as magnet 2104. The magnets 2104 are sealed with a room temperature-vulcanizing silicone, such that the magnets cannot directly contact the ferment when the ferment is inside the pouch. For example, the magnets 2104 can be disc-shaped and can be sandwiched between two 3D-printed pieces that are clamped onto the pouch with a single fastener through the center of the disc-shaped magnets 2104. The magnets 2104 are positioned such that they can mate with recesses, e.g., insets, of the thermal plate. Mating the recesses of the thermal plate may increase the contact between the pouch and the surface of the thermal plate, allowing better thermal control of the ferment. The ferment can fill the pouch to approximately two thirds of the volume of the pouch. In some examples, the pouch may not be bulging or ballooning.

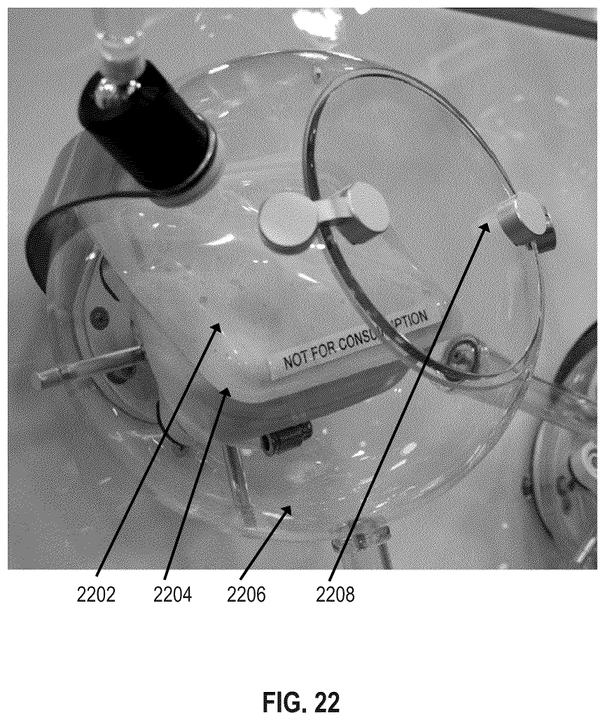

FIG. 22 provides a photo of ferment 2202 inside the sealable pouch 2204, being cultivated inside an active orb 2206. The door 2208 of active orb 2206 is sealed, and the temperature and air inside the active orb 2206 are regulated, such that the ferment 2202 can be cultivated. As one non-limiting example, the ferment being cultivated can be a sourdough starter. The sourdough starter can be cultivated based on a temperature range between 75 to 82 degrees Fahrenheit (approximately 23 to 28 degrees Celsius). In some examples, the ferment being cultivated can be a yeast starter.

### Example Method for Assembling a Fermentor System

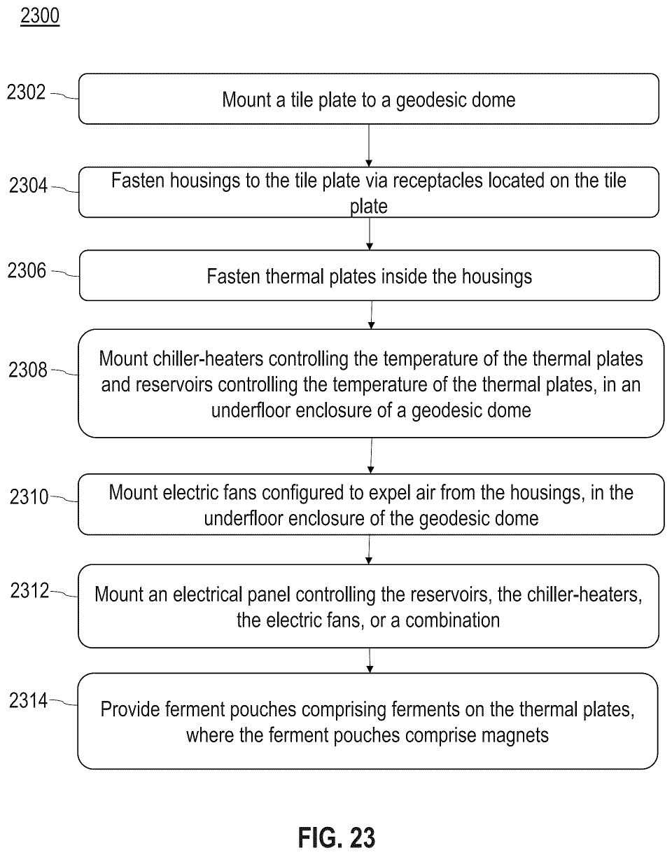

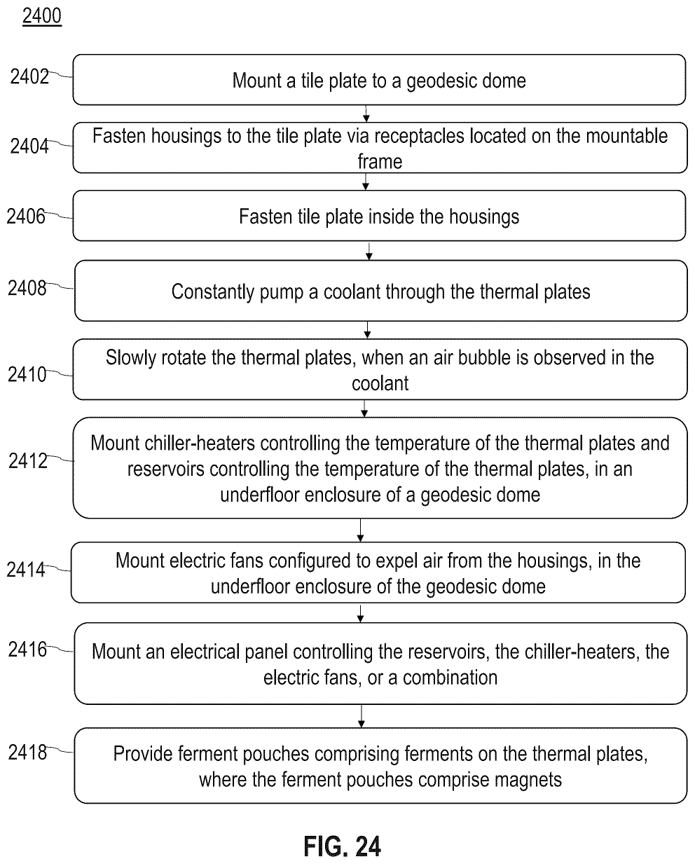

In some aspects, the methods disclosed herein describe a method for assembling a fermentor system. Two implementations of assembling the fermentor system are depicted in FIGS. 23 and 24, in processes 2300 and 2400. FIG. 23 differs from FIG. 24 in that the former includes two extra steps regarding the set-up of the temperature control loop. That is, the set-up of the temperature control loop can include step 2408, where a coolant is constantly pumped through the thermal plates, and step 2410, where the thermal plates are slowly rotated when an air bubble is seen in the coolant, so that the air bubble is released.

In FIG. 23, a tile plate is mounted to a geodesic dome at step 2302. At step 2304, one or more housings are fastened to the tile plate via one or more receptacles located on the tile plate. At step 2306, one or more thermal plates are fastened inside one or more housings via a tubing, or a crossbar fastened to the one or more housings. At step 2308, one or more chiller-heaters (controlling, at least in part, the temperature of the one or more thermal plates) and one or more reservoirs (controlling, at least in part, the temperature of the one or more thermal plates) are mounted in an underfloor enclosure of a geodesic dome. At step 2310, one or more electric fans configured to expel air from the one or more housings are mounted, in the underfloor enclosure of the geodesic dome. At step 2312, an electrical panel controlling, at least in part, the one or more reservoirs, the one or more chiller-heaters, the one or more electric fans, or a combination thereof, are mounted. At step 2314, one or more pouches comprising one or more ferments, on the one or more thermal plates, are provided, wherein a pouch of the one or more pouches comprises a magnet.

In FIG. 24, a tile plate is mounted to a geodesic dome at step 2402, which is the same step as step 2302. At step 2404, which is the same as step 2304 (of FIG. 23), one or more housings are fastened to the tile plate via one or more receptacles located on the tile plate. At step 2406, which is the same as step 2306 (of FIG. 23), one or more thermal plates are fastened inside one or more housings via a tubing, or a crossbar fastened to the one or more housings. In FIG. 24, step 2406 can also include step 2408, where a coolant may be pumped through the one or more thermal plates. In step 2410, the one or more thermal plates slowly rotates, in accordance with a determination that an air bubble is present in the coolant. In some aspects, pumping the coolant and/or rotating the thermal plates helps ensure that there are little to no air bubbles in the coolant when it flows through the thermal plates. Reducing the air bubbles may help increase the thermal contact of the coolant to the thermal plate, allowing better thermal control of the ferment. At step 2412, which is the same as step 2308 (of FIG. 23), one or more chiller-heaters (controlling, at least in part, the temperature of the one or more thermal plates) and one or more reservoirs (controlling, at least in part, the temperature of the one or more thermal plates) are mounted in an underfloor enclosure of a geodesic dome. At step 2414, which is the same as step 2310 (of FIG. 23), one or more electric fans configured to expel air from the one or more housings are mounted, in the underfloor enclosure of the geodesic dome. At step 2416, which is the same as step 2312 (of FIG. 23), an electrical panel controlling, at least in part, the one or more reservoirs, the one or more chiller-heaters, the one or more electric fans, or a combination thereof, are mounted. At step 2418, which is the same as step 2314 (of FIG. 23), one or more pouches comprising one or more ferments, on the one or more thermal plates, are provided, wherein a pouch of the one or more pouches comprises a magnet.

In process 2300 or 2400, some blocks are, optionally, combined, the order of some blocks is, optionally, changed, and some blocks are, optionally, omitted. In some examples, additional steps may be performed in combination with the process 2300 or 2400. Accordingly, the operations as illustrated (and described in greater detail below) are exemplary by nature and, as such, should not be viewed as limiting.

### Example Computer Systems and Networks

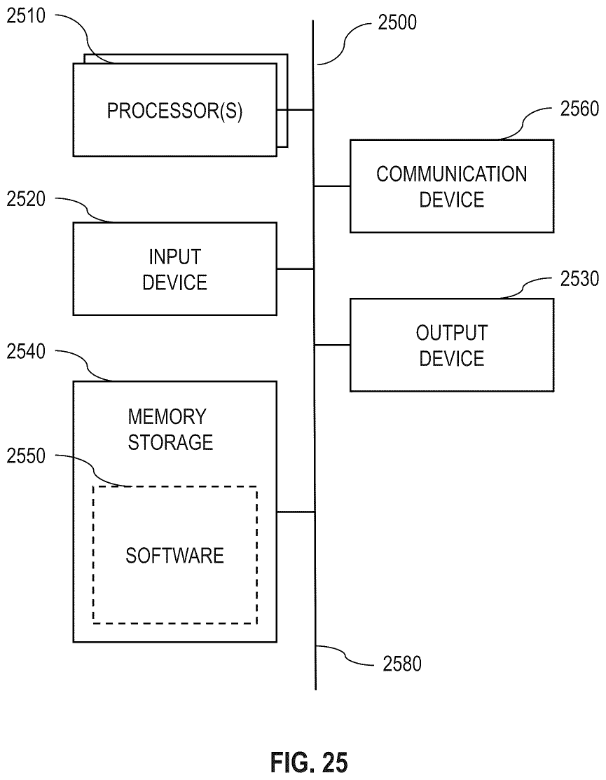

FIG. 25 illustrates an example of a computing device or system in accordance with one embodiment. Device 2500 can be a host computer connected to a network. Device 2500 can be a client computer or a server. As shown in FIG. 25, device 2500 can be any suitable type of microprocessor-based device, such as a personal computer, workstation, server, or handheld computing device (portable electronic device) such as a phone or tablet. The device can include, for example, one or more processor(s) 2510, input devices 2520, output devices 2530, memory or storage devices 2540, communication devices 2560, and nucleic acid sequencers 2570. Software 2550 residing in memory or storage device 2540 may comprise, e.g., an operating system as well as software for executing the methods described herein. Input device 2520 and output device 2530 can generally correspond to those described herein, and can either be connectable or integrated with the computer.

Input device 2520 can be any suitable device that provides input, such as a touch screen, keyboard or keypad, mouse, or voice-recognition device. Output device 2530 can be any suitable device that provides output, such as a touch screen, haptics device, or speaker.

Storage 2540 can be any suitable device that provides storage (e.g., an electrical, magnetic, or optical memory including a RAM (volatile and non-volatile), cache, hard drive, or removable storage disk). Communication device 2560 can include any suitable device capable of transmitting and receiving signals over a network, such as a network interface chip or device. The components of the computer can be connected in any suitable manner, such as via a wired media (e.g., a physical system bus 2580, Ethernet connection, or any other wire transfer technology) or wirelessly (e.g., Bluetooth®, Wi-Fi®, or any other wireless technology).

Software 2550, which can be stored as executable instructions in storage 2540 and executed by processor(s) 2510, can include, for example, an operating system and/or the processes that embody the functionality of the methods of the present disclosure (e.g., as embodied in the devices as described herein).

Software 2550 can also be stored and/or transported within any non-transitory computer-readable storage medium for use by or in connection with an instruction execution system, apparatus, or device, such as those described herein, that can fetch instructions associated with the software from the instruction execution system, apparatus, or device and execute the instructions. In the context of this disclosure, a computer-readable storage medium can be any medium, such as storage 2540, that can include or store processes for use by or in connection with an instruction execution system, apparatus, or device. Examples of computer-readable storage media may include memory units like hard drives, flash drives and distribute modules that operate as a single functional unit. Also, various processes described herein may be embodied as modules configured to operate in accordance with the embodiments and techniques described above. Further, while processes may be shown and/or described separately, those skilled in the art will appreciate that the above processes may be routines or modules within other processes.

Software 2550 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

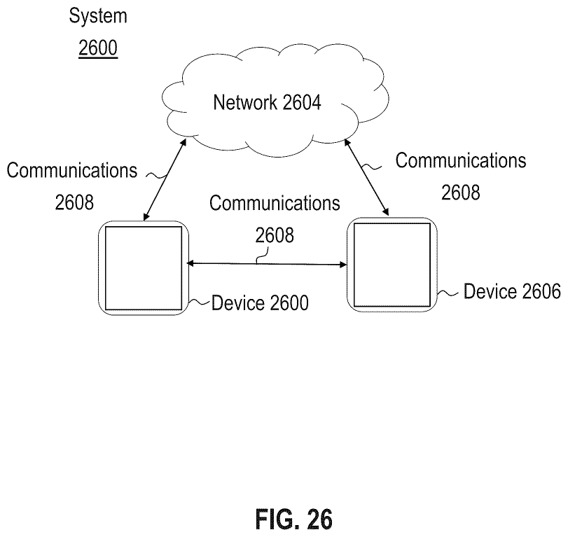

Device 2500 may be connected to a network (e.g., network 2604, as shown in FIG. 26 and/or described below), which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 2500 can be implemented using any operating system, e.g., an operating system suitable for operating on the network. Software 2550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example. In some embodiments, the operating system is executed by one or more processors, e.g., processor(s) 2510.

Devices 2500 and 2606 may communicate, e.g., using suitable communication interfaces via network 2604, such as a Local Area Network (LAN), Virtual Private Network (VPN), or the Internet. In some embodiments, network 2604 can be, for example, the Internet, an intranet, a virtual private network, a cloud network, a wired network, or a wireless network. Devices 2500 and 2606 may communicate, in part or in whole, via wireless or hardwired communications, such as Ethernet, IEEE 802.11b wireless, or the like. Additionally, devices 2500 and 2606 may communicate, e.g., using suitable communication interfaces, via a second network, such as a mobile/cellular network. Communication between devices 2500 and 2606 may further include or communicate with various servers such as a mail server, mobile server, media server, telephone server, and the like. In some embodiments, Devices 2500 and 2606 can communicate directly (instead of, or in addition to, communicating via network 2604), e.g., via wireless or hardwired communications, such as Ethernet, IEEE 802.11b wireless, or the like. In some embodiments, devices 2500 and 2606 communicate via communications 2608, which can be a direct connection or can occur via a network (e.g., network 2604).

One or all of devices 2500 and 2606 generally include logic (e.g., http web server logic) or are programmed to format data, accessed from local or remote databases or other sources of data and content, for providing and/or receiving information via network 2604 according to various examples described herein.

### Green System for a Geodesic Dome

### Overview

Described herein are systems and methods for creating and operating a green system to be used in a human-scale space habitat comprising a geodesic dome. The green system includes one or more plant receptacles for plant containment; a tile plate configured to receive the one or more plant receptacles, a vault enclosure configured to attach to the tile plate, and one or more irrigation systems configured to irrigate the plant receptacles.

Survival on extra-terrestrial environments can be challenging. Such environments may not provide natural resources essential for the survival of individuals in space. For example, forms of sustenance, such as food, and resources such as medicine and sanitizing equipment, may not be readily secured from extra-terrestrial environments. One solution to this problem may include bringing consumable resources from Earth, to space, such as packaged foods. Such a solution, however, may be limited to the amount and/or type of the consumable resources brought from Earth. The complete consumption of the resources may be limited (e.g., may not be replenishable) and may accordingly limit the individuals' survival in space. Alternative solutions that provide greater longevity than the use of consumable resources include the use of systems that allow for propagation of resources. For example, systems capable of cultivating vegetation, or fermenting starter materials, need not be limited to the amount and/or type of consumable resources initially brought from Earth. Under various ranges of engineered conditions, the consumable resources initially brought from Earth can be propagated. Described herein are systems and methods for a green system that can be used on Earth or in space, for the propagation of resources.

In some aspects, the green system may include mechanisms that do not rely on the gravitational strength of the environment. For example, the green system of the disclosed examples may use fewer or no gravity-assisted pumps to control the flow of fluids. Functions such as irrigation and gas exchange may rely on active movements, including the use of electric fans and/or aeroponic misters. The use of fewer or no gravity-based mechanisms in the green system allows for the green system to operate without being mitigated by gravitational field strengths typical of extra-terrestrial environments (e.g., microgravity environments). The green system can be functional tiles, which may be modular with respect to the space habitat. That is, the green system tiles can be attached (when in use), removed and stored (when not in use), and can be reinstalled (e.g., remounted) to the space habitat, via a mountable frame, when use is resumed.

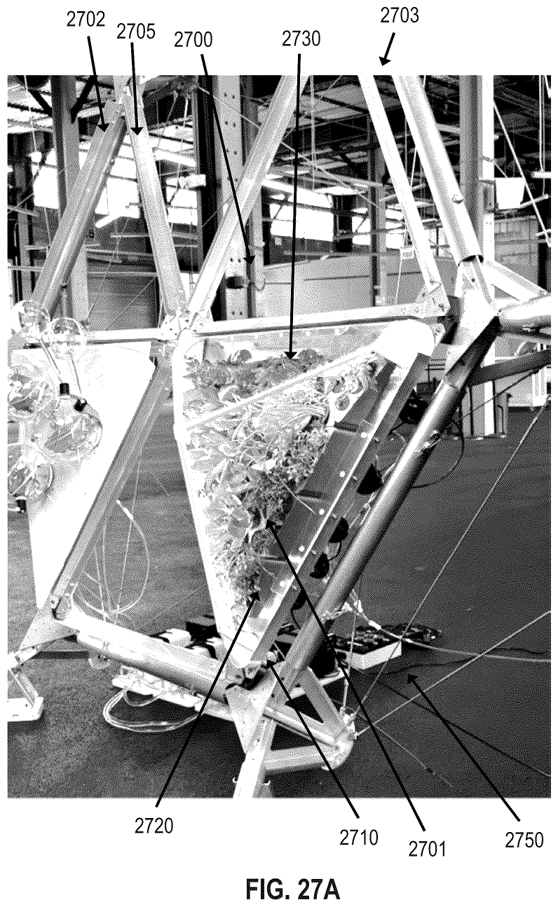

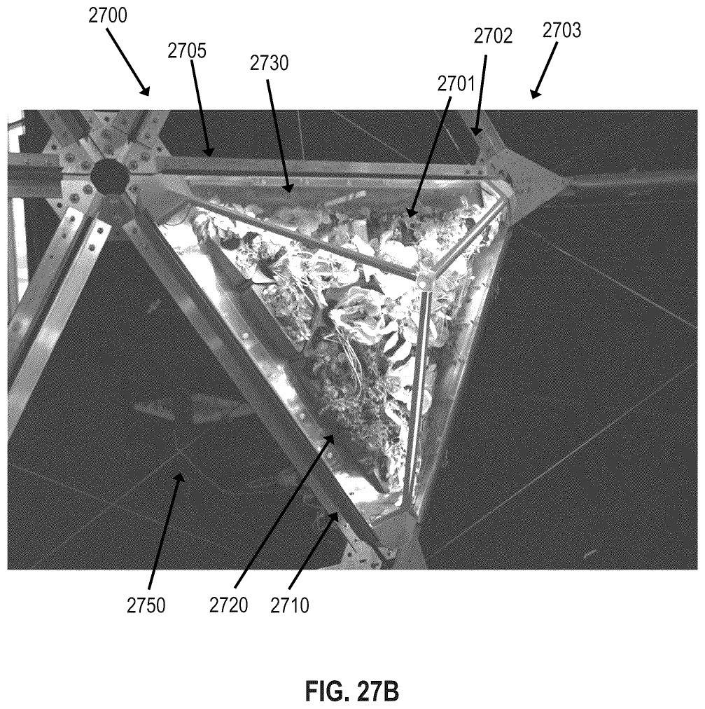

FIGS. 27A and 27B illustrate different views of a green system 2700 including plant mass 2701 that is growing, according to some examples. The green system 2700 may be mounted on a frame 2702 of a geodesic dome 2703, including the underfloor enclosure 2750, for example. The green system may be mounted on brackets 2705, a frame 2702 of a geodesic dome 2703, or both. The green system 2700 comprises a one or more plant receptacles 2720 for plant containment, a tile plate 2710 configured to receive one or more plant receptacles 2720, a vault enclosure 2730 configured to attach to the tile plate 2710, and one or more irrigation systems configured to irrigate one or more plant receptacles. In some embodiments, the green system 2700 is configured to operate in one or both of gravity and microgravity environments. The green system 2700 may be configured to operate in any orientation in space to account for one or both of gravity and micro gravity environments.

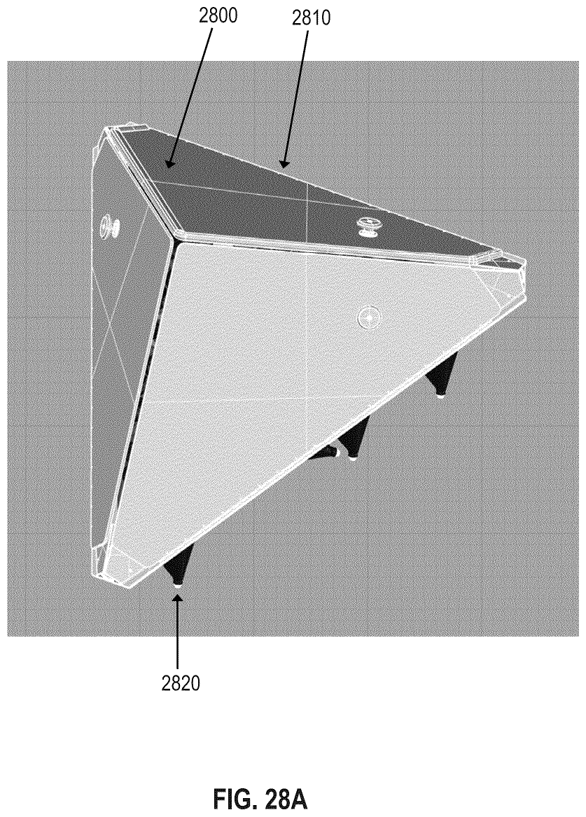

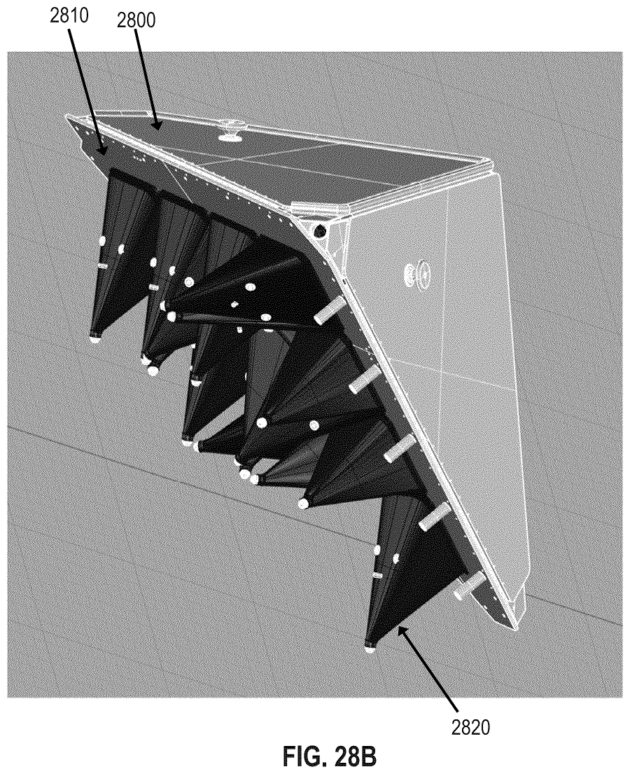

FIGS. 28A and 28B illustrate views of a rendering of an example vault enclosure 2800, tile plate 2810, and plant receptacles 2820, according to some examples. As a non-limiting example, the vault enclosure 2800 and the tile plate 2810 may form a pyramid-shaped enclosure, creating an enclosed environment suitable for plant mass growth and maintenance. Although the figures illustrate an enclosure 2800 having a pyramid shape, examples of the disclosure may include enclosures having other shapes, such as rectangular, elliptical, etc.

### Example Support Structures

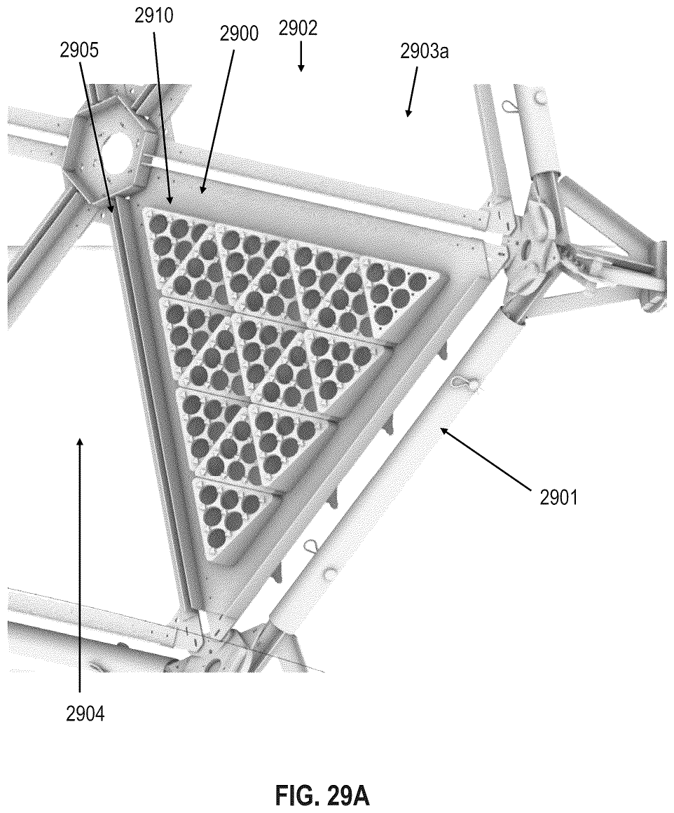

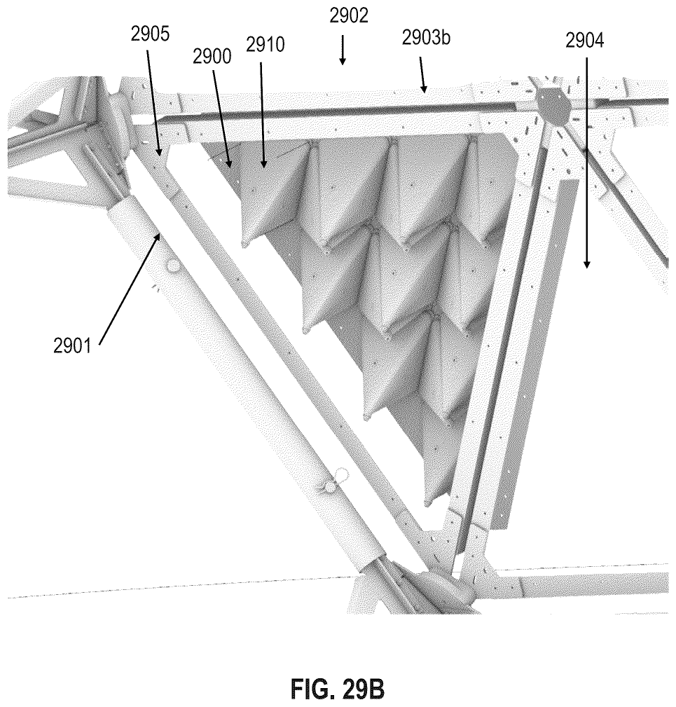

FIGS. 29A and 29B illustrate a tile plate 2900 with plant receptacles 2910 attached wherein a vault enclosure is removed, according to some examples. The tile plate 2900 may be configured to be connected to and/or removed from a frame 2901 and/or brackets 2905 of the geodesic dome 2902. The tile plate 2900 may be configured to connect to an outer face 2903a and an inner face 2903b of the geodesic dome 2902. The tile plate 2900 may be configured to connect to a frame 2901 and/or brackets 2905 when rotated and attached into place. The tile plate 2900, in some embodiments, is triangular in shape in order to fit into triangular-shaped openings 2904 on a geodesic dome 2902, though the tile plate 2900 may be other shapes compatible with fitting into different shaped openings 2904. The tile plate 2900 may be inserted into the openings 2904 and connected to the geodesic dome 2902 by a series of screws, bolts, latches, or other connecting hardware.

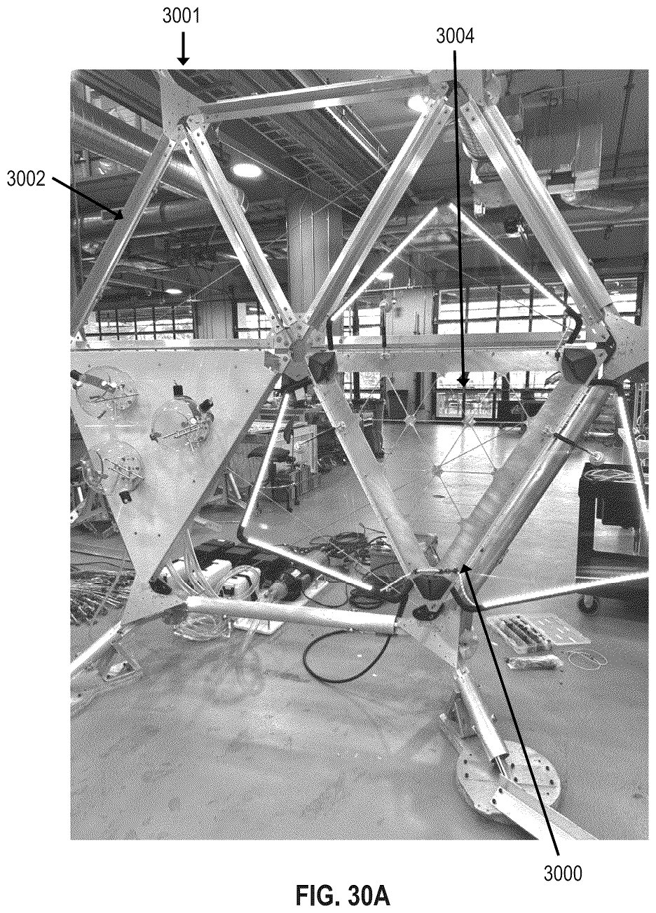

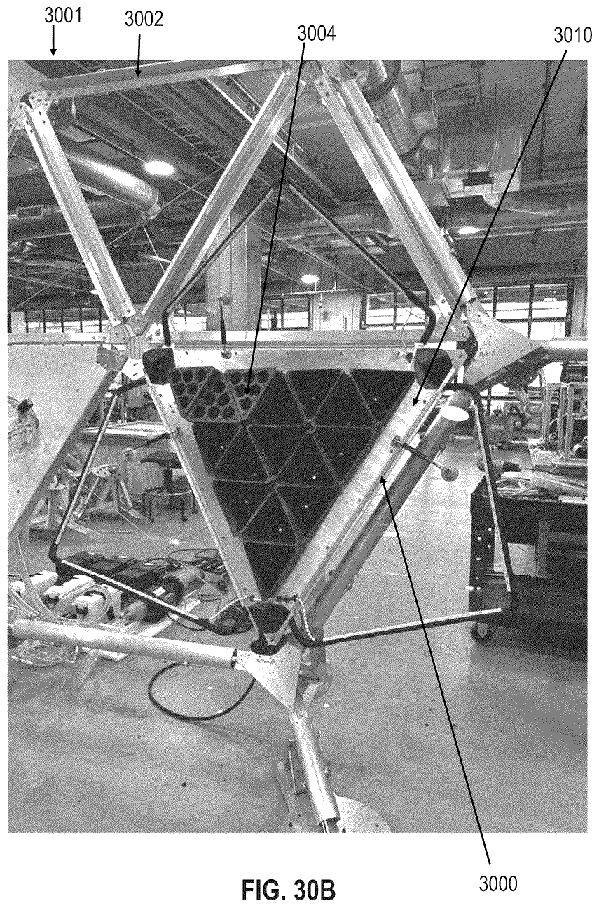

FIGS. 30A and 30B illustrate a tile plate 3000 mounted to a frame 3002 of a geodesic dome 3001 where the plant receptacles 3010 have been removed and attached, according to some examples. The tile plate 3000 is configured to receive plant receptacles 3010 through one or more openings 3004 in the tile plate 3000, according to some embodiments. In some embodiments, the openings 3004 are triangular in shape, though they may comprise other shapes such that different shapes of plant receptacles 3010 may be used. The openings 3004 on the tile plate 3000 may also be different sizes capable of receiving plant receptacles 3010 of different sizes.

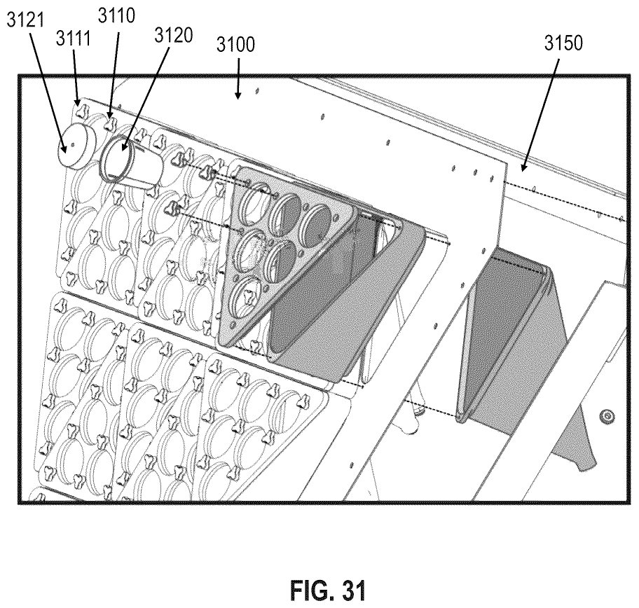

FIG. 31 illustrates a method for attaching components of plant receptacles 3110 to a tile plate 3100, according to some examples. The plant receptacles 3110 are configured to attach to the tile plate 3100, in some embodiments, by one or more screws, bolts, latches, or other connecting hardware 3111. These connecting hardware 3111 hold, in some embodiments, parts of the plant receptacles 3110 together and/or the plant receptacles 3110 to the tile plate 3100. These connecting hardware 3111 may connect, in some embodiments, the tile plate 3100 to the frame of a geodesic dome, the brackets 3150, or both. The plant receptacles 3110 are configured to receive plant pots 3120 which, in some embodiments, are configured to attach to the plant receptacles 3110 by a series of screws, bolts, latches, or other connecting hardware 3111. As a non-limiting example, the plant pots 3120 can be between 2 and 4 inches in diameter. In another non-limiting example, the plant pots 3120, can be between 1 and 3 inches in diameter. In another non-limiting example, the plant pots 3120, can be between 3 and 5 inches in diameter. By configuring the plant receptacles 3110 and plant pots 3120 to be removable, the plants may be easily exchanged, harvested, and/or maintained, which may create small, enclosed environments for plant growth. The plant pots 3120, in some embodiments, make use of plant collars 3121 to hold plant mass in place within the pots 3120.

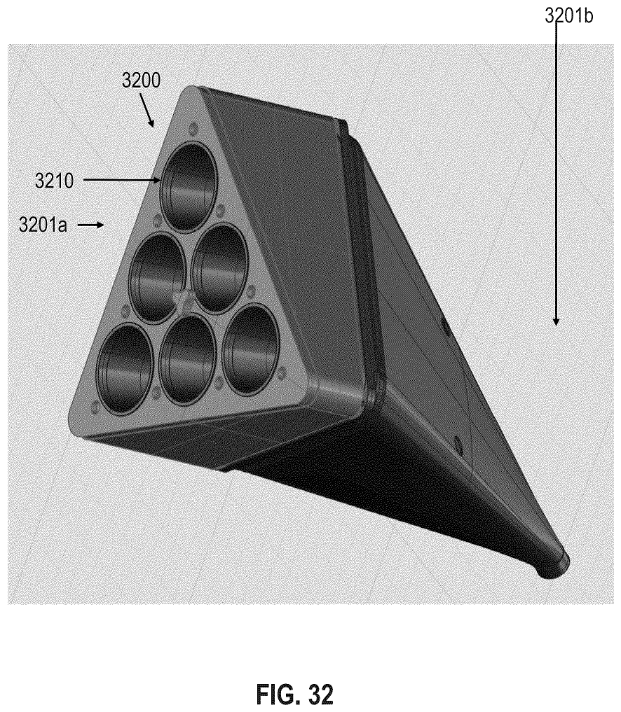

FIG. 32 illustrates a plant receptacle 3200 capable of receiving plant mass, according to some examples. These plant receptacles 3200, in some embodiments, are hollow pods with first 3201a side that has exposed openings for receiving plant mass and exposing plant mass to light, and a second side 3201b with a funnel end for funneling out excess liquids (e.g., nutrient mixtures, water). In some embodiments, the first side with the exposed openings uses plant pots 3210 for including the plant mass. In some aspects, the plant pots 3210 may include the roots, reduce spillage, reduce contamination, among other reasons. These plant receptacles 3200 can be configured to attach to an irrigation system for irrigating the plant mass included in them.

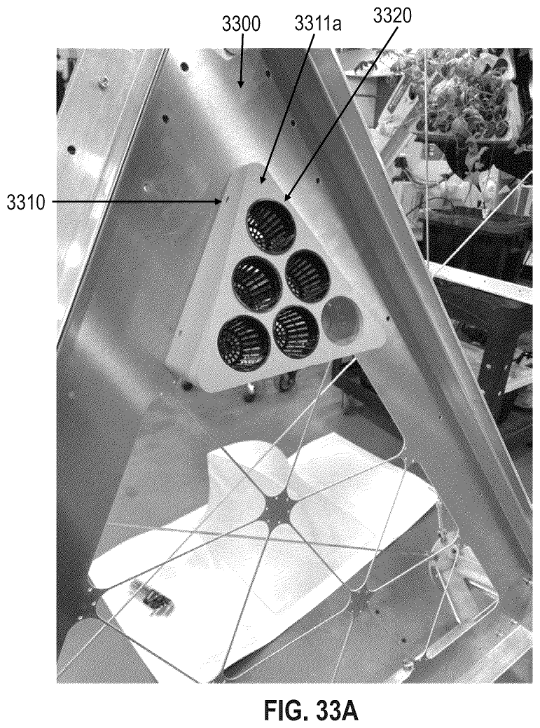

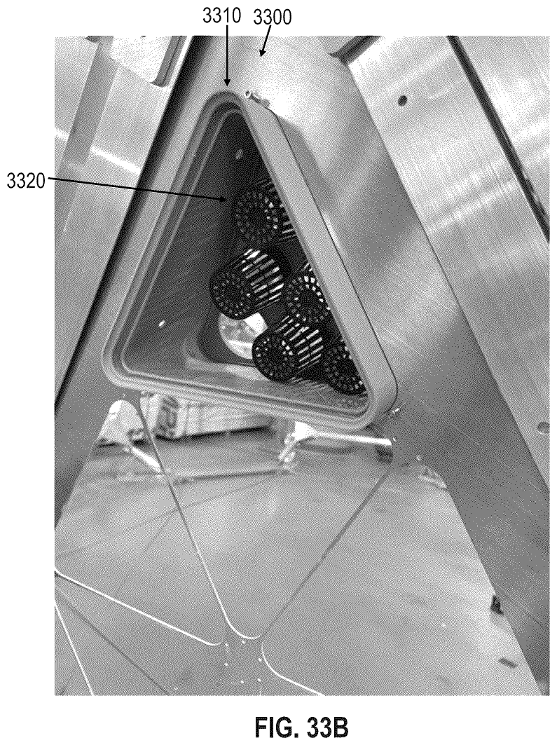

FIGS. 33A and 33B illustrate a plant receptacle 3310 mounted to a tile plate 3300 including netted plant pots 3320, according to some examples. The plant receptacles 3310, in some embodiments, are configured to receive plant pots 3320 for plant mass containment. In some embodiments, these plant pots 3320 are plant nets. In another embodiment, the plant pots 3320 are plant bags. The plant pots 3320 are configured to attach to the exposed part 3311a of the plant receptacle in order to allow exposure to the lighting system to facilitate plant mass growth. The plant pots 3320 may make use of plant collars, according to some embodiments. The plant collars, according to some non-limiting examples, can be between 2 and 4 inches in diameter. In another non-limiting example, the plant collars can be between 1 and 3 inches in diameter. In another non-limiting example, the plant collars can be between 3 and 5 inches in diameter.

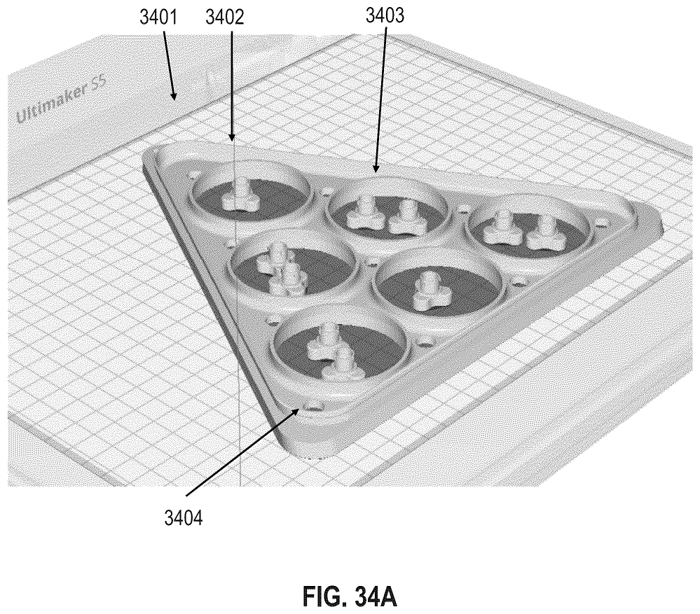

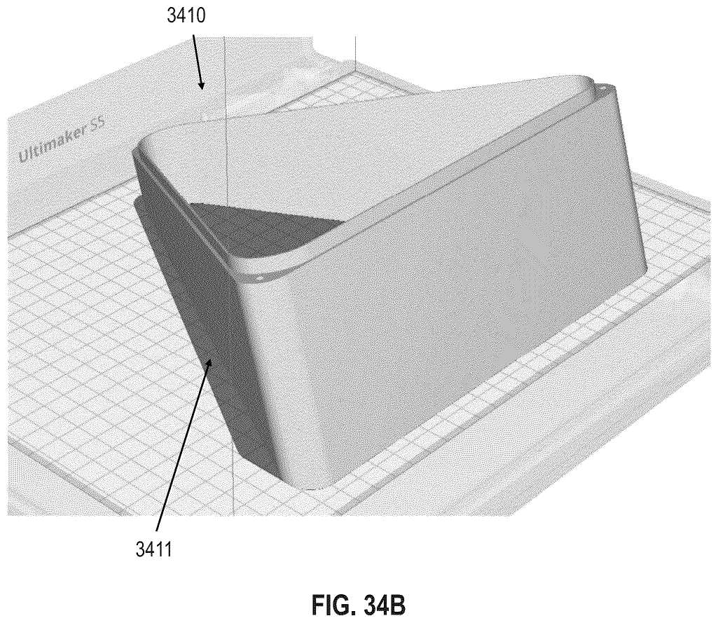

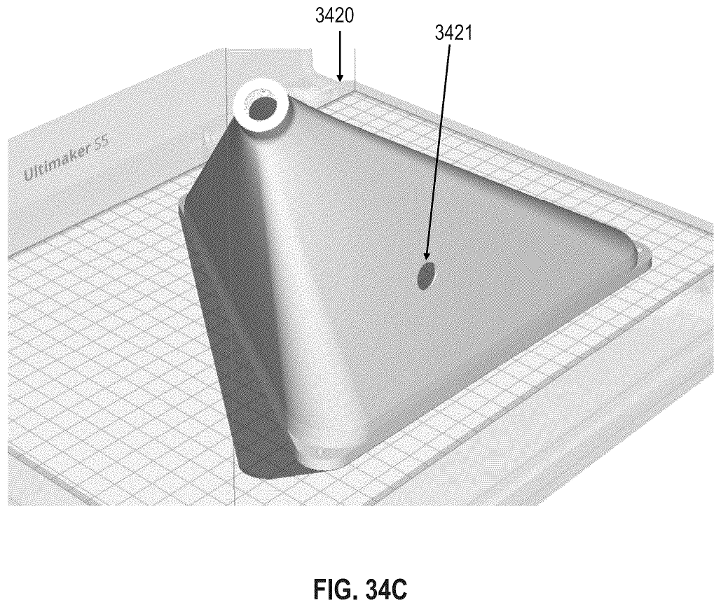

FIGS. 34A-34C illustrate plant receptacle components, according to some examples. The plant receptacles, according to some embodiments, comprise a receptacle lid 3401, a receptacle bottom 3410, and a funnel 3420. FIG. 34A illustrates an example receptacle lid 3401, according to some embodiments. The receptacle lid 3401, in some embodiments, is a triangular plate 3402 with openings 3403 for plant pots and places for attachment 3404 to the receptacle bottom 3410. The receptacle lid 3401, in some embodiments, receives plant pots for plant mass containment, which may be attached by attachment hardware (e.g., rotating latches). FIG. 34B illustrates an example receptacle bottom 3410, according to some embodiments. The receptacle bottom 3410, in some embodiments, is a triangular-shaped hollow tube component 3411 capable of attaching to the plant receptacle lid 3401 and a side of the tile plate. In some embodiments, the receptacle bottom 3410 may also attach to the funnel 3420. The receptacle bottom 3410 creates space for the plant pots inside. FIG. 34C illustrates an example receptacle lid 3420, according to some embodiments. In some embodiments, the funnel 3420 is configured to attach to the opposite side of the tile plate. In some embodiments, the funnel 3420 can also be attached to the receptacle bottom 3410. The funnel 3420, in some embodiments, has holes 3421 for drainage and can connect to the irrigation system and funnel away excess liquid. Having the plant receptacle attach in such a configuration enables creation of a watertight seal, enhancing plant growth and reducing loss of liquids. This configuration also encases the roots and other plant mass within the receptacle to protect them from light exposure.

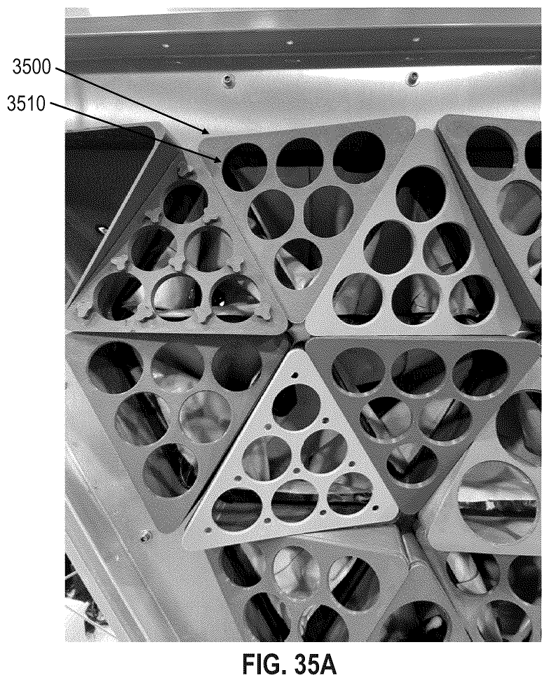

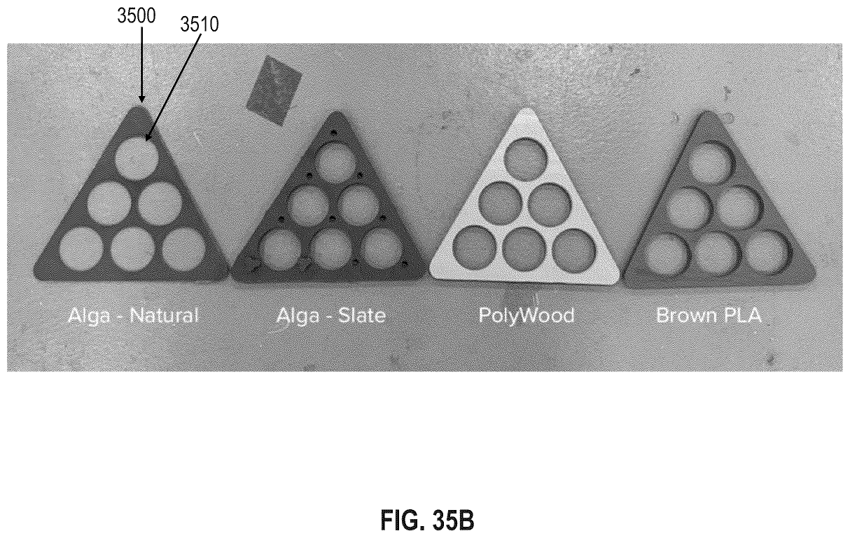

In some aspects, the plant receptables 3500 may comprise a wide variety of materials, such as shown in FIGS. 35A and 35B. Example materials include, but are not limited to, plastic, wood, and polylactic acid. In some aspects, the plant receptables 3500 may comprise openings 3510 of different sizes for receiving different sizes of plant pots.

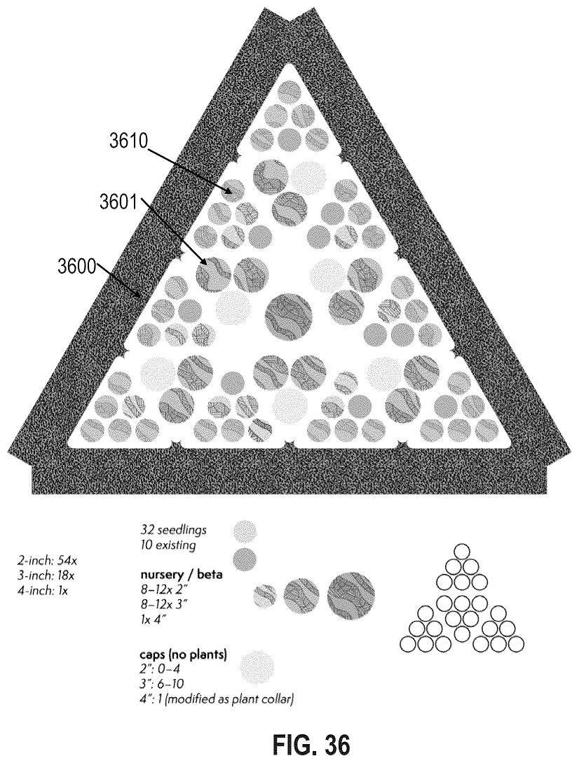

FIG. 36 illustrates a diagram of an assembly of plant mass 3601 and plant pots 3610 within the plant receptacles 3600, according to some examples. The plant receptacles 3600 may be adaptable and capable of receiving a variety of different plant mass 3601. In some embodiments, the plant receptacles 3600 can grow a variety of different kinds of varieties of plants at once in different sized plant pots 3610. In some embodiments, the plant pots 3610 may be configured to grow edible plant mass 3601 such as chili peppers. The plant receptacles 3600 can be configured to grow plant mass 3601 with and without collars on the plant pots 3610, for example, simultaneously. In some embodiments, the plant mass 3601 includes one or more of: roots, leaves, and stems. This plant mass 3601 can be grown and maintained within the plant receptacles 3600 for extended periods of time including, in one embodiment, two weeks or more. The plant mass 3601 can be grown with minimal (e.g., little to no) human involvement, for example.

### Example Vault Enclosure

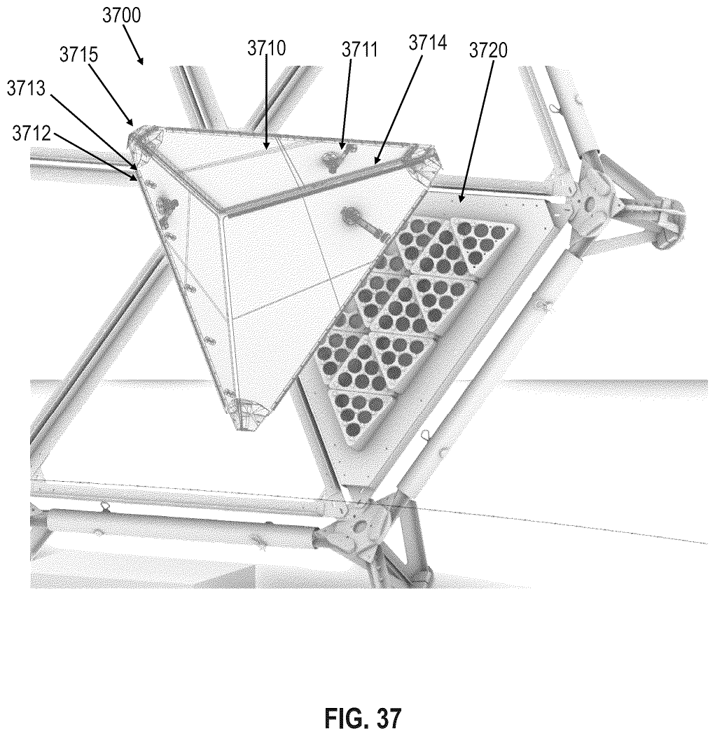

FIG. 37 illustrates a green system 3700 where a vault enclosure 3710 is detached from a tile plate 3720, according to some examples. The enclosure 3710 can be removable from the tile plate 3720. The enclosure 3710 may have handles 3711 (e.g., machined handles) and attachments 3712 (e.g., spring attachments) for opening and removing the enclosure 3710. The enclosure 3710 can be configured to attach to the tile plate 3720 and lock into place, forming a vacuum seal. The enclosure may have a flexible trim 3713, such as a rubber trim or vinyl decals that helps with creating a vacuum seal when locked into place. This vacuum seal is useful, for example, for growing plant mass in non-Earth environments to ensure proper humidity levels, temperature levels, and/or gas exchanges. In some embodiments, the enclosure 3710 comprises triangular panels 3714 that together form a pyramid-shaped enclosure 3710. In some embodiments, the panels 3714 comprise a transparent material (e.g., clear acrylic) configured to allow the plant mass growing to be viewed/observed. The panels 3714 may be hinged panels configured to lock together. In some embodiments, the hinged panels 3714 may use springs (e.g., gas springs) in order to hinge and lock into place. The panels 3714 may also have 3D printed corners 3715. In some embodiments, the enclosure 3710 is vacuum-formed, and, in some embodiments, does not have panels.

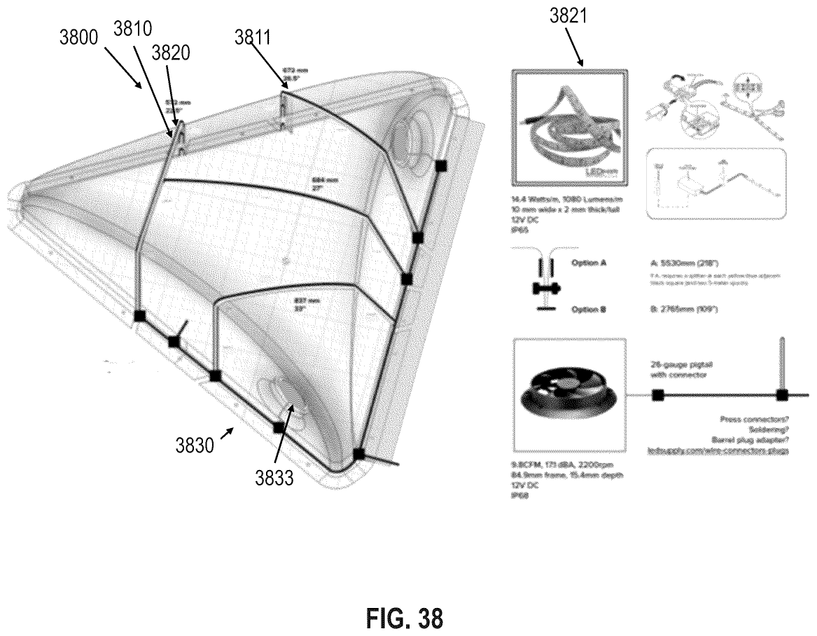

FIG. 38 illustrates a diagram of the wiring 3810, lighting 3820, and fan 3830 of a vault enclosure 3800, according to some examples. According to some examples, the enclosure 3800 comprises one or more lights 3821 and wires 3811 to provide lighting to the plant mass included within the enclosure 3800. In some embodiments, the lights 3821 are LED lights attached to the enclosure 3800, and the wires 3811 run along the enclosure 3800 to connect the lights 3821 to an electrical system. In some embodiments, the lights 3821 are controlled by a timer and are directed towards the plant mass. The lights 3821 provide the light for plant mass growth in non-Earth environments, such as environments with less or no sunlight, or with irregular lighting schedules. The lights 3821 can be configured to operate at a brightness that is conducive to plant mass growth and/or at a brightness that may be pleasant to the human eye (e.g., 1500 to 3000 lumens per square foot, 1000 to 2500 lumens per square foot, 2000 to 3500 lumens per square foot).

In some embodiments, the enclosure 3800 comprises inlets, outlets, and fans 3833 configured to reduce condensation buildup, circulate air inside the vault enclosure 3800, promote plant growth, and/or create a more difficult environment for pests. In some embodiments, the outlets comprise gaps in the panels. In some instances, the configuration of the gaps may be based on the shape of the enclosure 3800. In some embodiments, the enclosure 3800 comprises one or more sensors for monitoring conditions within the enclosure 3800. Example sensors include, but are not limited to, a thermometer, a carbon dioxide sensor, and a humidity sensor. The carbon dioxide sensor may be configured to detect carbon dioxide levels within the enclosure 3800 and adjust fan speed to maintain healthy levels of carbon dioxide for plant mass growth. The humidity sensor may be configured to detect humidity within the enclosure 3800 and adjust fan speed to maintain humidity levels (e.g., targeted humidity levels) for plant mass growth.

### Example Irrigation System

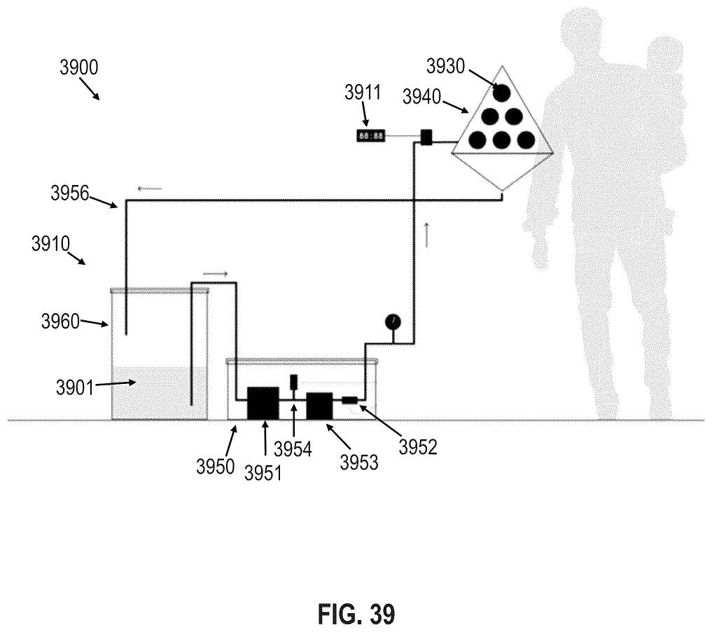

FIG. 39 illustrates a diagram of an irrigation system 3900 where nutrient mixtures 3901 are pumped from an underfloor enclosure 3910 to aeroponic misters within plant receptacles 3930 attached to a tile plate 3940 and then the excess is removed back to the underfloor enclosure 3910, according to some examples. In some embodiments, the irrigation systems 3900 are configured to feed one or more nutrient mixtures 3901 to the plant receptacles 3930. The irrigation system 3900 may feed the nutrient mixtures 3901 to the plant receptacles 3930 according to a timer 3911. The irrigation system can provide water and nutrients to plant mass growing within the plant receptacles with minimal human involvement. The nutrient mixture 3901 may comprise, but is not limited to: water, nitrogen, potassium, salts, or a combination thereof. The nutrient mixture 3901 may be monitored by a pH meter and/or an electrical conductivity meter. Using the pH meter and/or an electrical conductivity meter may allow a person monitoring the system to be able to maintain nutrient mixtures 3901 ideal for plant mass growth. In some non-limiting examples, the system is configured to operate at a pH of 6.0-6.5 for cultivating plant mass. In another non-limiting example, the system is configured to operate at a pH of 5.5-6.0. In another non-limiting example, the system is configured to operate at a pH of 6.5-7.0. The pH system is configured to operate based on the plant mass being cultivated.

These nutrient mixtures 3901 may be comprised of one or more growth mixtures that are diluted separately to reduce nutrient lockout, in some aspects. The proportions of growth mixtures mixed together may be changed depending on a stage of plant mass growth. A growth mixture may comprise, but is not limited to: nitrogen, calcium, micronutrients, trace minerals, or a combination thereof. In some examples, this growth mixture is a foundational growth mixture which may provide the foundation for plant growth. In other embodiments, a growth mixture may comprise, but is not limited to: nitrogen and/or potassium for stimulating structural and foliar growth. In some examples, this growth mixture is a stimulating growth mixture which may stimulate growth. In other embodiments, a growth mixture may comprise, but is not limited to: phosphorus, potassium, magnesium, sulfur, or a combination thereof. In some examples, this growth mixture is a flowering/fruiting growth mixture which may support the fruiting and/or flowering stage of plant development.

In some examples, three growth mixtures are mixed together in the following proportions: three parts of a first growth mixture per gallon of water, two parts of a second growth mixture per gallon of water, and one part of a third growth mixture ratio per gallon of water. In some examples, this growth mixture is made of three parts stimulating growing mixture per gallon of water, two parts foundational growth mixture per gallon of water, and one part flowering/fruiting growth mixture per gallon of water.

The irrigation system 3900 may also comprise a pump system 3950, which may comprise a pump 3951, a pressure switch 3952, an accumulator tank 3953, a safety valve 3954, a filter, and one or more irrigation lines 3956. The pressure switch 3952 may control whether the pump 3951 is on or off depending on whether pressure in one or more irrigation lines 3956 is above a lower pressure threshold and/or below an upper pressure threshold. In some non-limiting examples, the lower pressure threshold is 80 psi, and the upper pressure threshold is 100 psi, providing the capability to irrigate in non-Earth environments. In another non-limiting example, the lower pressure threshold is 70 psi, and the upper pressure threshold is 90 psi. In another non-limiting example, the lower pressure threshold is 90 psi, and the upper pressure threshold is 110 psi. The accumulator tank 3953 may be pre-pressurized to reduce pump load. The safety valve 3954 can actuate when pressure in one or more irrigation lines 3956 exceeds a safe threshold.

The irrigation lines 3956 may be configured to connect to a filter and to one or more aeroponic misters. The irrigation lines 3956 may be configured to draw up one or more nutrient mixtures 3901 through the filter and pump it through one or more aeroponic misters. Excess liquid from the irrigation may fall into the plant receptacle 3930 funnel and be pumped back to a nutrient container 3960.

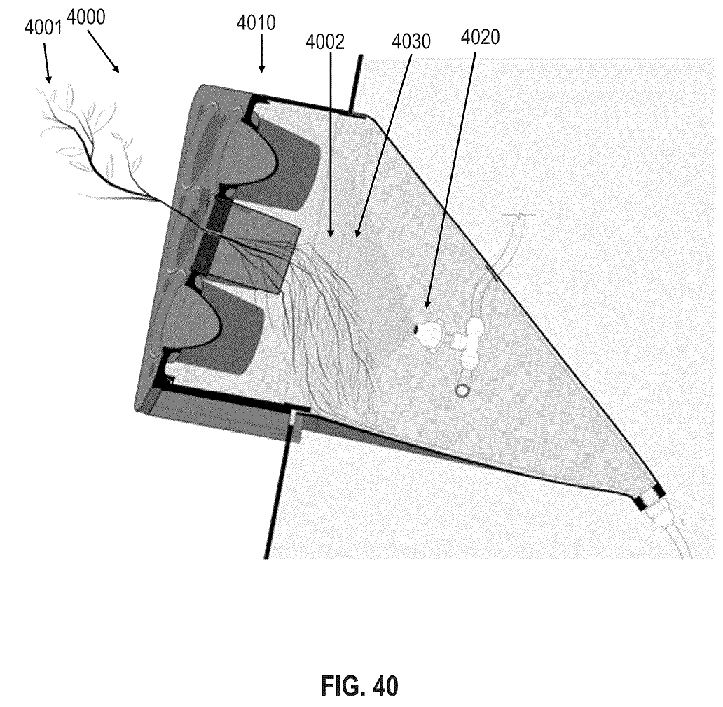

FIG. 40 illustrates a diagram of an example irrigation system 4000 of plant mass 4001 within plant receptacles 4010 using aeroponic misters 4020, according to some examples. In some embodiments, the irrigation systems 4000 are comprised of one or more aeroponic misters 4020.

These aeroponic misters 4020 may supply the nutrient mixtures 4030 to a root zone 4002 of the plant mass 4001 in the form of droplets. In some non-limiting examples, the droplets may be 5-50 microns in diameter. In another non-limiting example, the droplets may be 3-40 microns in diameter. In another non-limiting example, the droplets may be 10-60 microns in diameter. In some embodiments, the release of the nutrient mixtures 4030 through the aeroponic misters 4020 is controlled by a solenoid. Release of the nutrient mixtures 4030 through the aeroponic misters 4020 can provide localized, controlled irrigation of plants independent of gravity, making it suitable for growing plant mass in both Earth and non-Earth environments. The irrigation systems 4000 may be configured to irrigate in close proximity to roots of plant mass and at pressures greater than a high-pressure threshold, which may be based on gravity environments, micro gravity environments, or both.

### Example Underfloor Enclosure

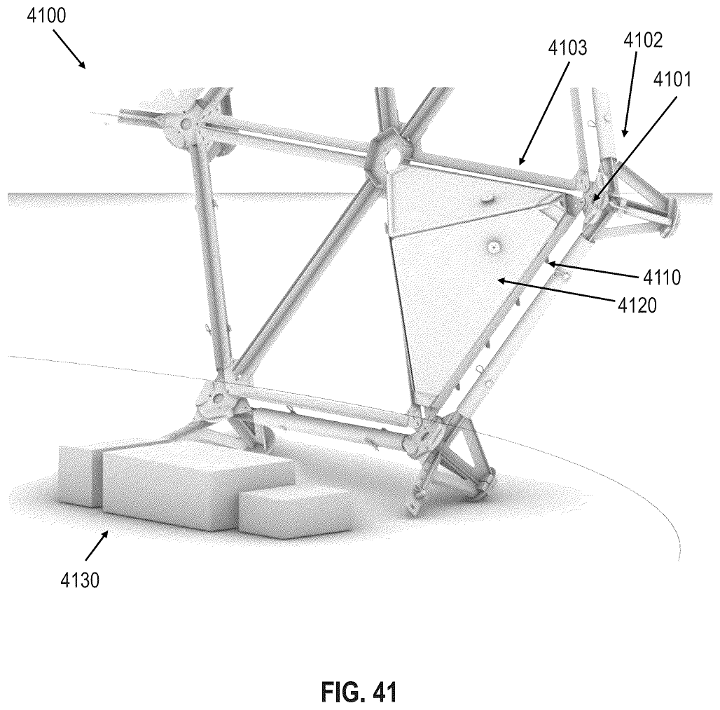

FIG. 41 illustrates a rendering of an example green system 4100 where a tile plate 4110 is attached to a frame 4101 (or brackets 4103, or both) of a geodesic dome 4102, a vault enclosure 4120 is attached, and which is connected to an underfloor enclosure 4130, according to some examples. As discussed previously, an underfloor enclosure can be located at least partially beneath the floor of the floor system and can include components that are used in conjunction with the green system. In some embodiments, the tile plate 4110 is connected to an underfloor enclosure 4130. Allowing for removable connections to the underfloor enclosure 4130 allows for different tile plates 4110 to be swapped out, or for easy replacement of components of the underfloor enclosure 4130 (e.g., for maintenance).

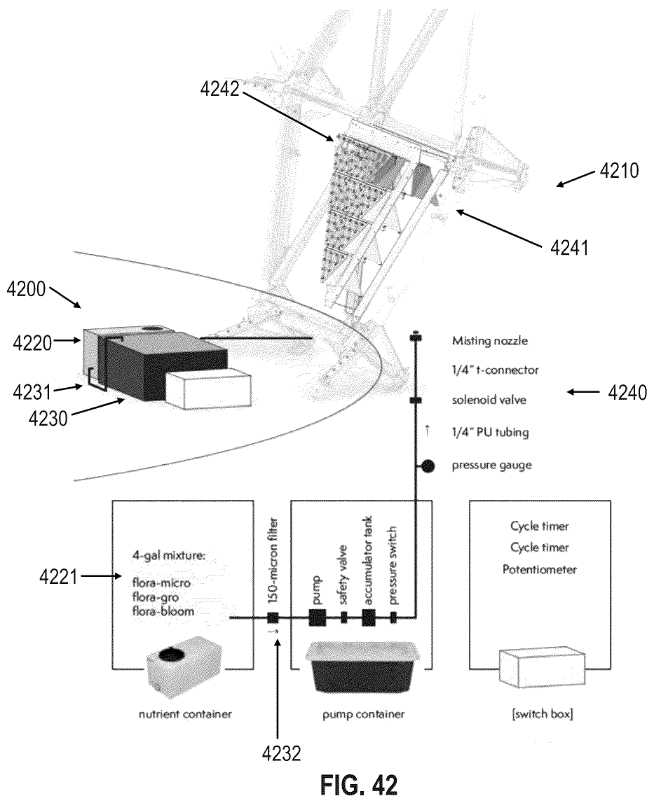

FIG. 42 illustrates a diagram of an example underfloor enclosure 4200 attached to the rest of the green system 4210, according to some examples. The underfloor enclosure 4200 may house a nutrient container 4220 that holds one or more nutrient mixtures 4221. The nutrient container 4220 may be configured to feed the nutrient mixtures 4221 to the pump container 4230 via one or more lines 4231 with one or more filters 4232. The nutrient container 4220 may be configured to receive excess nutrient mixture 4221 supplied by the irrigation systems 4240 from a root zone 4241 of the plant receptacles 4242. Receiving the excess nutrient mixture 4221 allows for reduced loss of excess fluids, a step that may be desirable for environments that have finite amounts of available liquid, such as non-Earth environments.

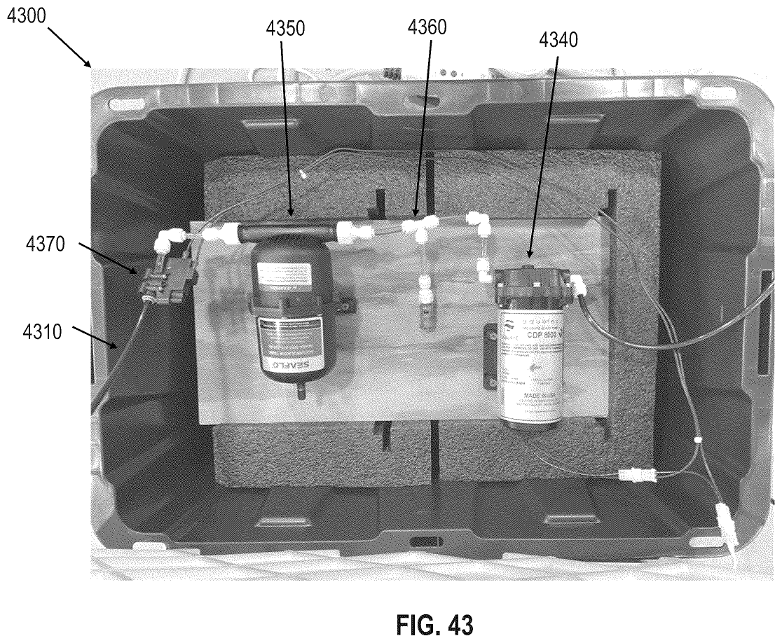

FIG. 43 illustrates an example pump container 4300 within the underfloor enclosure, according to some examples. In some embodiments, the underfloor container comprises: a pump container 4300 configured to pump one or more nutrient mixtures to the irrigation systems via one or more lines 4310 connected to one or more of: a solenoid valve and a pressure gauge. The pump container 4300 may comprise a pump 4340, an accumulation tank 4350, one or more safety valves 4360, and one or more pressure switches 4370.

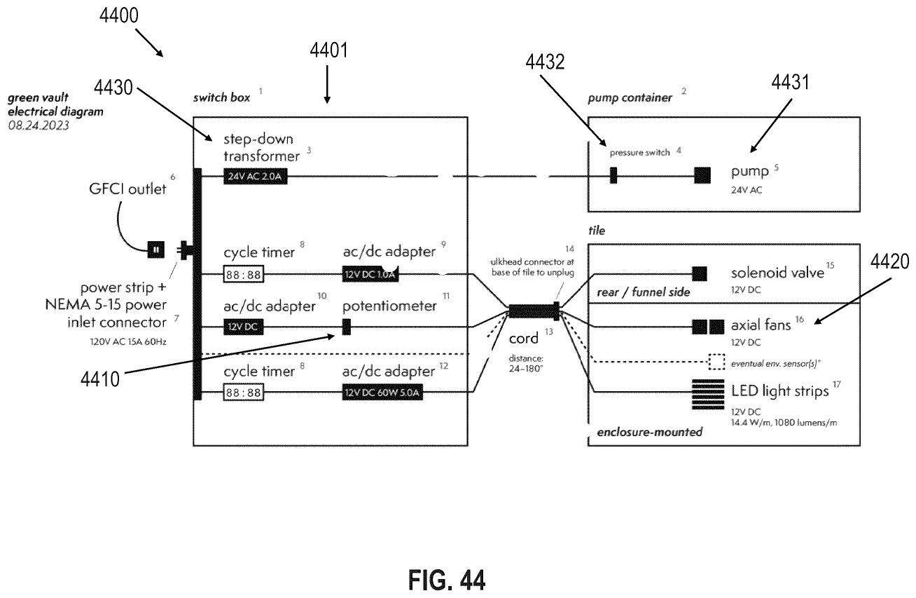

FIG. 44 illustrates a diagram of an example electrical system 4400, according to come examples. In some embodiments, the underfloor enclosure comprises a switch box 4401 configured to house an electrical system 4400 that controls conditions within the vault enclosure. The electrical system 4400 may be connected to one or more sensors, enabling control of conditions within the vault. The switch box 4401 may comprise one or more potentiometers 4410 configured to adjust the speed of the fans 4420 within the vault enclosure. The potentiometers 4410 may be manually operated, for example. Further, the switch box 4401 may also comprise one or more transformers 4430 configured to connect to a pump 4431 and one or more pressure switches 4432.

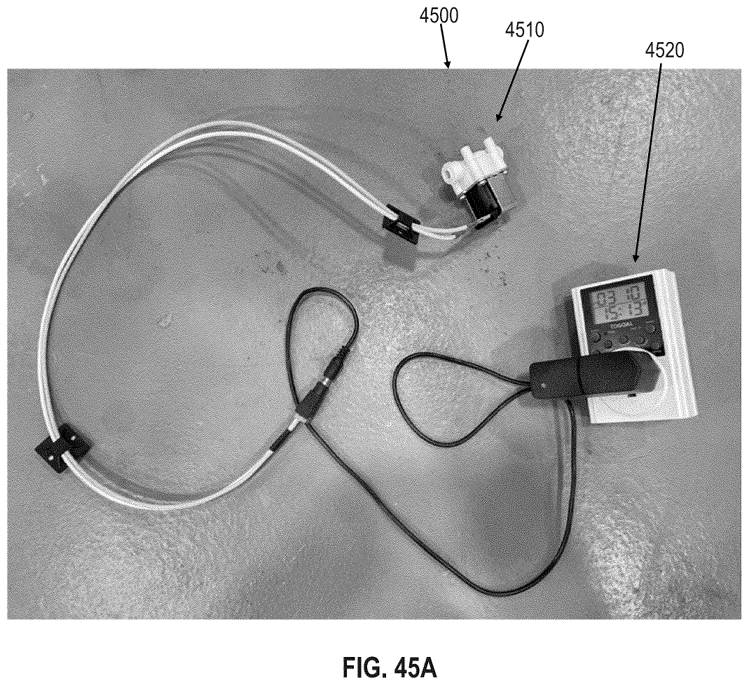

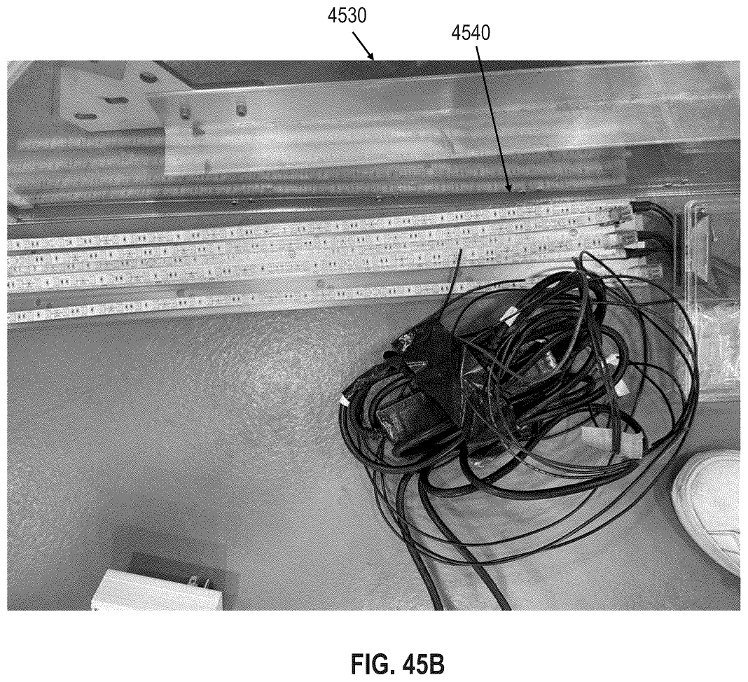

FIG. 45A illustrates an example pump control setup 4500 using a solenoid 4510 and a timer 4520, according to some examples. In some embodiments, the switch box comprises one or more cycle timers 4520 configured to adjust a solenoid 4510 valve for irrigation. FIG. 45B illustrates an example lighting control setup 4530 using a timer, according to some examples. In some embodiments, the switch box comprises one or more cycle timers configured to adjust a brightness of lights 4540 within the vault enclosure.

### Example Methods for Assembling and Operating a Green System

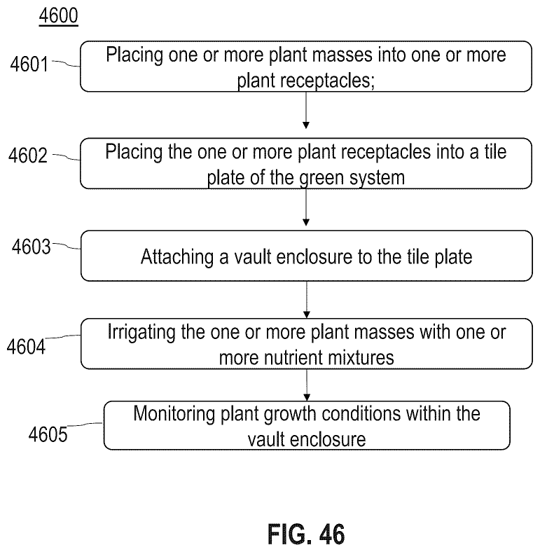

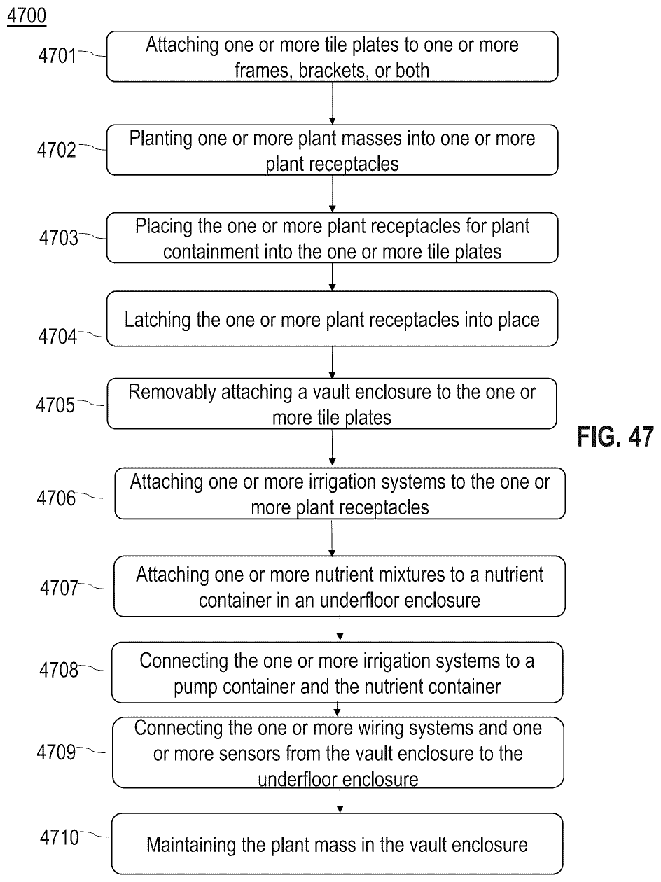

In some aspects, the methods disclosed herein describe a method for operating and assembling a green system. Implementations of assembling and operating the disclosed green system are depicted in FIGS. 46 and 47, in processes 4600 and 4700, respectively. FIG. 46 differs from FIG. 47 in that the latter includes extra steps regarding the initial set-up of the green system such as attaching one or more tiles plates to a frame and/or bracket, attaching and connecting the one or more irrigation systems, and connecting the one or more wiring systems and one or more sensors.

In FIG. 46, one or more plant masses are placed into one or more plant receptacles in step 4601. At step 4602, the plant receptacles are placed into a tile plate of the green system. At step 4603, a vault enclosure is attached to the tile plate. At step 4604, the plant masses are irrigated with one or more nutrient mixtures. At step 4605, the growth conditions within the vault enclosure are monitored. In some embodiments, placing the plant masses may comprise planting one or more root bundles in one or more plant pots. Plant receptacles may be configured to receive one or both of soil-based plant mass or soil-less plant mass. In some embodiments, receptacle lids of the plant receptacles may be placed first. In some embodiments, plant mass may be placed with a plant collar. A switch box may be used to control the termination of the system operation.

In FIG. 47, one or more tile plates are attached to one or more frames, brackets, or both in step 4701. One or more plant masses are planted into one or more plant receptacles at step 4702. The plant receptacles for plant containment are placed into the tile plates at step 4703. The plant receptacles are latched into place at step 4704. A vault enclosure is removably attached to the tile plates at step 4705. One or more irrigation systems are attached to the plant receptables at step 4706. One or more nutrient mixtures are added to a nutrient container in an underfloor enclosure at step 4707. The irrigations systems are connected to a pump container and the nutrient container at step 4708. One or more wiring systems and one or more sensors from the vault enclosure are connected to the underfloor enclosure at step 4709. The plant mass and the vault enclosure are maintained at step 4710. In some embodiments, a vault enclosure may be configured to be locked into place. The irrigation system may comprise one or more exchangeable aeroponic misters. The irrigation systems may be configured to supply nutrient mixtures to the plant receptacles, remove excess liquid from the plant receptacles, or a combination thereof. In some embodiments, the irrigation systems are configured to remove the excess liquid back to the nutrient container.

### Enumerated Embodiments

The following enumerated embodiments are representative of some aspects of the invention.

A1. A frame system for a geodesic dome, the frame system comprising:
a plurality of struts arranged along edges of the geodesic dome;
a plurality of tension cables; and
at least one connector comprising:
   a plurality of rods, wherein each rod of the plurality of rods is configured to connect to at least one strut from the plurality of struts and comprises a first through-hole, and
   an adapter plate configured to connect to at least one tension cable from the plurality of tension cables.

A2. The frame system of embodiment A1, wherein the at least one connector is arranged to form a vertex of the geodesic dome.

A3. The frame system of embodiment A1, wherein the at least one connector is configured to be interchangeable with another connector.

A4. The frame system of embodiment A1, wherein the plurality of rods is configured to loosely connect to the at least one strut from the plurality of struts such that the geodesic dome is deformable.

A5. The frame system of embodiment A1, wherein the plurality of rods extend from a central connection point of the connector.

A6. The frame system of embodiment A1, wherein the plurality of rods comprises at least three rods.

A7. The frame system of embodiment A1, wherein the plurality of struts comprises at least one hollow strut configured to receive at least one rod from the plurality of rods and comprises a second through-hole.

A8. The frame system of embodiment A7, wherein the frame system further comprises at least one pin configured to connect the at least one hollow strut to the at least one rod through the first through-hole and the second through-hole.

A9. The frame system of embodiment A1, wherein the plurality of struts is arranged such that the frame system forms at least one pentagonal face and at least one hexagonal face.

A10. The frame system of embodiment A1, wherein the plurality of struts is configured to be interchangeable with one another.

A11. The frame system of embodiment A1, wherein the plurality of struts comprises at least one rigid strut.

A12. The frame system of embodiment A1, wherein the geodesic dome is a truncated icosahedron dome.

A13. The frame system of embodiment A1, wherein the frame system is oriented such that a pentagonal face of the frame system is located at a crown of the geodesic dome.

A14. The frame system of embodiment A1, wherein the plurality of tension cables is configured to extend between the at least one connector and a plurality of connectors such that the plurality of tension cables is planar to a face of the frame system.

A15. The frame system of embodiment A1, wherein at least one tension cable of the plurality of tension cables is configured to be adjustably connected to the adapter plate such that a tension force of the at least one tension cable is adjustable.

A16. The frame system of embodiment A1, further comprising at least one mountable frame configured to connect to the at least one connector such that the at least one mountable frame is planar to a hexagonal face of the geodesic dome.

A17. The frame system of embodiment A16, wherein the at least one mountable frame is configured to support one or both of a panel and a baseplate, and wherein the at least one mountable frame is arranged along the hexagonal face of the geodesic dome.

A18. The frame system of embodiment A16, wherein the at least one mountable frame comprises a triangular bracket.

A19. The frame system of embodiment A1, further comprising at least one foot comprising:
a flat panel configured to lay flush against a floor, and
a hollow strut configured to receive at least one rod from the plurality of rods and connected to the flat panel at an angle relative to a surface of the flat panel,
wherein the at least one foot is configured to support the frame system above the floor.

A20. The frame system of embodiment A19, wherein the angle of the hollow strut is 30-90 degrees.

A21. A method for assembling a geodesic dome frame system, the method comprising:
connecting a plurality of struts of the geodesic dome frame system to each other via a plurality of connectors of the geodesic dome frame system,
   wherein each connector of the plurality of connectors comprises a first through-hole configured to connect to at least one strut from the plurality of struts, the at least one strut comprising a second through-hole, and
   wherein each connector is connected to the at least one strut via a pin running through the first through-hole and the second through-hole such that the geodesic dome frame system is deformable;
connecting a plurality of tension cables of the geodesic dome frame system to the plurality of connectors such that the plurality of tension cables is planar to a face of the frame system, wherein the plurality of tension cables is configured to be adjustably connected to the plurality of connectors such that a tension force of each tension cable of the plurality of tension cables is adjustable; and
assembling the geodesic dome frame system by increasing the tension force of at least one cable of the plurality of cables such that the geodesic dome frame system is no longer deformable.

A22. The method of embodiment A21, wherein the plurality of connectors are arranged to form vertices of the geodesic dome frame system.

A23. The method of embodiment A21, wherein each of the plurality of connectors is configured to be interchangeable with another connector.

A24. The method of embodiment A21, wherein a plurality of rods extend from a central connection point of the connector, wherein each rod of the plurality of rods is configured to connect to at least one strut from the plurality of struts and comprises at least one through-hole.

A25. The method of embodiment A24, wherein the plurality of rods comprises at least three rods.

A26. The method of embodiment A24, wherein the plurality of struts comprises at least one hollow strut configured to receive at least one rod from the plurality of rods.

A27. The method of embodiment A21, wherein the plurality of struts is arranged such that the frame system forms at least one pentagonal face and at least one hexagonal face.

A28. The method of embodiment A21, wherein the plurality of struts is configured to be interchangeable with one another.

A29. The method of embodiment A21, wherein the plurality of struts comprises at least one rigid strut.

A30. The method of embodiment A21, wherein the geodesic dome frame system forms a truncated icosahedron dome.

A31. The method of embodiment A21, wherein the geodesic dome frame system is oriented such that a pentagonal face of the geodesic dome frame system is located at a crown of the geodesic dome frame system.

A32. The method of embodiment A21, wherein the geodesic dome frame system further comprises at least one mountable frame configured to connect to the plurality of connectors such that the at least one mountable frame is planar to a hexagonal face of the geodesic dome frame system.

A33. The method of embodiment A32, wherein the at least one mountable frame is configured to support one or both of a panel and a baseplate, and wherein the at least one mountable frame is arranged along the hexagonal face of the geodesic dome.

A34. The method of embodiment A32, wherein the at least one mountable frame comprises a triangular bracket.

A35. The method of embodiment A21, wherein the geodesic dome frame system further comprises at least one foot comprising:
a flat panel configured to lay flush against a floor, and
a hollow strut configured to receive at least one rod from the plurality of rods and connected to the flat panel at an angle relative to a surface of the flat panel,
wherein the at least one foot is configured to support the frame system above the floor.

A36. The method of embodiment A35, wherein the angle of the hollow strut is 30-90 degrees.

A37. A connector for a geodesic dome frame system, the connector comprising:
a plurality of rods, wherein each rod of the plurality of rods is configured to connect to at least one strut from the plurality of struts and comprises a through-hole; and
an adapter plate configured to connect to at least one tension cable from the plurality of tension cables, wherein the adapter plate is configured to face outward relative to the center of the geodesic dome frame system once assembled.

B1. A frame system for a geodesic dome, the frame system comprising:
a plurality of struts arranged along edges of the geodesic dome;
a plurality of tension cables; and
at least one connector comprising:
a plurality of rods, wherein each rod of the plurality of rods is configured to connect to at least one strut from the plurality of struts and comprises a first through-hole, and
an adapter plate configured to connect to at least one tension cable from the plurality of tension cables.

B2. The frame system of embodiment B1, wherein the at least one connector is arranged to form a vertex of the geodesic dome.

B3. The frame system of embodiment B1, wherein the at least one connector is configured to be interchangeable with another connector.

B4. The frame system of embodiment B1, wherein the plurality of rods is configured to loosely connect to the at least one strut from the plurality of struts such that the geodesic dome is deformable.

B5. The frame system of embodiment B1, wherein the plurality of rods extend from a central connection point of the connector.

B6. The frame system of embodiment B1, wherein the plurality of rods comprises at least three rods.

B7. The frame system of embodiment B1, wherein the plurality of struts comprises at least one hollow strut configured to receive at least one rod from the plurality of rods and comprises a second through-hole.

B8. The frame system of embodiment B7, wherein the frame system further comprises at least one pin configured to connect the at least one hollow strut to the at least one rod through the first through-hole and the second through-hole.

B9. The frame system of embodiment B1, wherein the plurality of struts is arranged such that the frame system forms at least one pentagonal face and at least one hexagonal face.

B10. The frame system of embodiment B1, wherein the plurality of struts is configured to be interchangeable with one another.

B11. The frame system of embodiment B1, wherein the plurality of struts comprises at least one rigid strut.

B12. The frame system of embodiment B1, wherein the geodesic dome is a truncated icosahedron dome.

B13. The frame system of embodiment B1, wherein the frame system is oriented such that a pentagonal face of the frame system is located at a crown of the geodesic dome.

B14. The frame system of embodiment B1, wherein the plurality of tension cables is configured to extend between the at least one connector and a plurality of connectors such that the plurality of tension cables is planar to a face of the frame system.

B15. The frame system of embodiment B1, wherein the at least one tension cable is configured to be adjustably connected to the adapter plate such that a tension force of the at least one tension cable is adjustable.

B16. The frame system of embodiment B1, further comprising at least one mountable frame configured to connect to the at least one connector such that the at least one mountable frame is planar to a hexagonal face of the geodesic dome.

B17. The frame system of embodiment B16, wherein the at least one mountable frame is configured to support one or both of a panel and a baseplate, wherein the at least one mountable frame is arranged along the hexagonal face of the geodesic dome.

B18. The frame system of embodiment B16, wherein the at least one mountable frame comprises a triangular bracket.

B19. The frame system of embodiment B1, further comprising at least one foot comprising:
a flat panel configured to lay flush against a floor, and
a hollow strut configured to receive at least one rod from the plurality of rods and connected to the flat panel at an angle relative to a surface of the flat panel,
wherein the at least one foot is configured to support the frame system above the floor.

B20. The frame system of embodiment B19, wherein the angle of the hollow strut is 30-90 degrees.

B21. A method for assembling a geodesic dome frame system, the method comprising:
connecting a plurality of struts to each other via a plurality of connectors,
wherein each connector of the plurality of connectors comprises a first through-hole configured to connect to at least one strut from the plurality of struts, the at least one strut comprising a second through-hole, and
wherein each connector is connected to the at least one strut via a pin running through the first through-hole and the second through-hole such that the geodesic dome is deformable;
connecting a plurality of tension cables to the plurality of connectors such that the plurality of tension cables is planar to a face of the frame system, wherein the plurality of tension cables is configured to be adjustably connected to the plurality of connectors such that a tension force of each tension cable of the plurality of tension cables is adjustable; and
increasing the tension force of at least one cable of the plurality of cables such that the geodesic dome is no longer deformable.

B22. A connector for a geodesic dome frame system, the connector comprising:
a plurality of rods, wherein each rod of the plurality of rods is configured to connect to at least one strut from the plurality of struts and comprises a through-hole; and
an adapter plate configured to connect to at least one tension cable from the plurality of tension cables.

C.1 A fermentor system comprising:
one or more housings configured to house one or more thermal plates and one or more ferments;
a tile plate comprising one or more receptacles, wherein the one or more receptacles are configured to mate with the one or more housings; and
one or more outlets configured to expel air from the one or more housings.

C2. The fermentor system of embodiment C1, wherein the air expelled by the one or more outlets are controlled by one or more electric fans.

C3. The fermentor system of embodiment C2, wherein the one or more electric fans are configured to expel the air at a volumetric flow rate of at least a first predetermined volumetric flow rate.

C4. The fermentor system of embodiment C2 or C3, wherein the one or more electric fans are configured to expel the air at an average flow velocity of at least a first predetermined average flow velocity.

C5. The fermentor system of any of embodiments C1-C4, wherein an electric fan of the one or more electric fans comprises 3 to 8 fan blades.

C6. The fermentor system of any of embodiments C1-C5, wherein the one or more outlets comprise one or more filters.

C7. The fermentor system of embodiment C6, wherein at least one of the one or more filters is a carbon filter.

C8. The fermentor system of any of embodiments C1-C7, wherein the one or more electric fans are located in an underfloor enclosure of a geodesic dome.

C9. The fermentor system of any of embodiments C1-C8, wherein the geodesic dome comprises the fermentor system.

C10. The fermentor system of any of embodiments C1-C9, wherein of the one or more outlets, a plurality of outlets is controlled by a single fan and a single filter.

C11. The fermentor system of embodiment C10, wherein the plurality of outlets comprises three outlets.

C12. The fermentor system of any of embodiments C1-C11, comprising a multi-to-one inlet-to-outlet manifold air configured to expel, at least in part, the air from the one or more housings.

C13. The fermentor system of embodiment C12, wherein the multi-to-one inlet-to-outlet manifold is a three-to-one inlet-to-outlet manifold.

C14. The fermentor system of any of embodiments C1-C13, wherein the one or more outlets are configured to be controlled by a same number of fans as the one or more outlets and a same number of filters as the one or more outlets.

C15. The fermentor system of any of embodiments C1-C14, wherein the one or more outlets are connected to one or more tubings.

C16. The fermentor system of embodiment C15, wherein the one or more tubings comprise polyvinyl chloride.

C17. The fermentor system of embodiment C15 or C16, wherein the one or more tubings comprise an inner diameter of 0.250″, 0.50″ or 0.375″.

C18. The fermentor system of any of embodiments C15-C17, wherein the one or more tubings are configured to expel the air at the volumetric flow rate of at least a second predetermined volumetric flow rate.

C19. The fermentor system of any of embodiments C15-C18, wherein the one or more tubings are configured to expel the air at the average flow velocity of at least a second predetermined average flow velocity.

C20. The fermentor system of embodiment C19, wherein each of the one or more outlets is configured to be controlled independently from one or more other outlets.

C21. The fermentor system of any of embodiments C1-C20, wherein the control comprises control of the volumetric flow rate or the average flow velocity.

C22. The fermentor system of any of embodiments C1-C21, the one or more outlets are configured to expel oxygen from the one or more housings.

C23. The fermentor system of any of embodiments C1-C22, wherein the one or more thermal plates are temperature controlled, at least in part, by one or more reservoirs and one or more chiller-heaters.

C24. The fermentor system of embodiment C23, wherein of the one or more thermal plates, a plurality of thermal plates is controlled by a single reservoir of the one or more reservoirs and a single chiller-heater of the one or more chiller-heaters.

C25. The fermentor system of embodiment C23 or C24, wherein the one or more thermal plates are configured to be controlled by a same number of reservoirs as the one or more thermal plates and a same number of chiller-heaters as the one or more thermal plates.

C26. The fermentor system of any of embodiments C23-C25, wherein the one or more reservoirs or the one or more chiller-heaters are located on a tray.

C27. The fermentor system of any of embodiments C23-C26, wherein the one or more reservoirs or the one or more chiller-heaters are located in an underfloor enclosure of a geodesic dome.

C28. The fermentor system of any of embodiments C1-C27, wherein the one or more thermal plates are temperature controlled by one or more thermoelectric devices.

C29. The fermentor system of embodiment C28, wherein the one or more thermal plates are configured to be controlled by a same number of the one or more thermoelectric devices as the one or more thermal plates.

C30. The fermentor system of any of embodiments C1-C29, wherein the one or more thermal plates are configured to be controlled independently from one or more other thermal plates.

C31. The fermentor system of any of embodiments C1-C30, wherein the one or more thermal plates are configured to target a setpoint temperature of approximately C18-C33 degrees Celsius.

C32. The fermentor system of any of embodiments C1-C31, wherein the one or more thermal plates comprise aluminum.

C33. The fermentor system of any of embodiments C1-C32, wherein the one or more thermal plates are configured to pass a coolant through the one or more thermal plates.

C34. The fermentor system of embodiment C33, wherein the coolant comprises water.

C35. The fermentor system of embodiment C34, wherein the coolant comprises a biocide.

C36. The fermentor system of any of embodiments C1-C35, wherein the one or more thermal plates comprise two thermal plate portions and a gasket.

C37. The fermentor system of any of embodiments C1-C36, wherein the one or more thermal plates comprise one or more internal channels to pass the coolant through the one or more thermal plates.

C38. The fermentor system of embodiment C37, wherein the one or more internal channels comprise one or more inlets and one or more outlets.

C39. The fermentor system of any of embodiments C1-C38, further comprising an electrical panel controlling, at least in part, the one or more reservoirs, the one or more chiller-heaters, the one or more thermoelectric devices, the one or more electric fans, or a combination thereof.

C40. The fermentor system of embodiment C39, wherein the electrical panel prevents one or more pumps configured to provide flow to the coolant from being turned on after the one or more chiller-heaters turn on.

C41. The fermentor system of embodiment C39 or C40, wherein the electrical panel prevents one or more electrical components of the fermentor system from drawing 10 A or more current.

C42. The fermentor system of any of embodiments C39-C41, wherein the electrical panel is located in the underfloor enclosure of the geodesic dome.

C43. The fermentor system of any of embodiments C39-C42, wherein the one or more electrical components of the fermentor system receives an input alternating current of 60 Hz, 120 V, and single phase.

C44. The fermentor system of any of embodiments C1-C43, wherein the one or more housings are transparent.

C45. The fermentor system of any of embodiments C1-C44, wherein the one or more housings are spherical.

C46. The fermentor system of any of embodiments C1-C45, wherein the one or more housings comprise glass, acrylic, or both.

C47. The fermentor system of any of embodiments C1-C46, wherein each of the one or more housings is configured to mate with only one of the one or more receptacles.

C48. The fermentor system of any of embodiments C1-C47, wherein the one or more housings are 1, 2, 3, 4, 5, 6, or 7 housings.

C49. The fermentor system of any of embodiments C1-C48, wherein each housing of the one or more housings comprise a different shape from one or more other housings.

C50. The fermentor system of any of embodiments C1-C49, further comprising: one or more inactive housings that do not house one or more thermal plates.

C51. The fermentor system of embodiment C50, wherein the one or more inactive housings are affixed to the one or more housings.

C52. The fermentor system of embodiment C51, wherein the one or more inactive housings are affixed to the one or more housings via one or more ball joints and one or more ball joint sockets.

C53. The fermentor system of any of embodiments C50-C52, wherein the one or more inactive housings each comprise a rod structure.

C54. The fermentor system of embodiment C53, wherein each rod structure of each of the one or more inactive housings is of a different length from one or more other rod structures.

C55. The fermentor system of embodiment C53 or C54, wherein the rod structure comprises a ball joint of the one or more ball joints.

C56. The fermentor system of any of embodiments C1-C55, wherein the tile plate is triangular in shape.

C57. The fermentor system of any of embodiments C1-C56, wherein the fermentor system is configured to attach to a bracket of a geodesic dome, a frame of a geodesic dome, or both.

C58. The fermentor system of any of embodiments C1-C57, wherein a ferment of the one or more ferments comprises a yeast ferment.

C59. The fermentor system of embodiment C58, wherein the ferment comprises a sourdough ferment.

C60. The fermentor system of embodiment C58 or C59, wherein the ferment is housed in a pouch.

C61. The fermentor system of embodiment C60, wherein the pouch is filled to approximately two-thirds of the volume of the pouch, with the ferment.

C62. The fermentor system of embodiment C60 or C61, wherein the pouch is filled in accordance with a determination that the pouch is not bulging or ballooning.

C63. The fermentor system of any of embodiments C60-C62, wherein the pouch comprises a magnet.

C64. The fermentor system of embodiment C63, wherein the magnet is sealed with a room-temperature-vulcanizing silicone.

C65. The fermentor system of embodiment C63 or C64, wherein the magnet mates with a recess on a surface of a thermal plate of the one or more thermal plates.

C66. The fermentor system of embodiment C65, wherein the mating of the magnet with the recess is configured to increase contact between the pouch and the surface of the thermal plate.

C67. A method for operating a fermentor system, comprising:
controlling or more setpoint temperatures of one or more thermal plates located in one or more housings;
mating the one or more housings with one or more receptacles located on a tile plate;
expelling air from the one or more housings via one or more outlets connected to the one or more housings; and
propagating one or more ferments located on the one or more thermal plates.

C68. The method of embodiment C67, wherein the method further comprises flowing a coolant through the one or more thermal plates.

C69. The method of embodiment C68, wherein the coolant comprises water.

C70. The method any of embodiments C67-C69, wherein the one or more ferments are capable of being checked for signs of healthy or positive growth.

C71. The method of any of embodiments C67-C70, wherein an electrical panel controls one or more pumps configured to provide flow to the coolant and the one or more chiller-heaters.

C72. The method of embodiment C71, wherein the electrical panel prevents the one or more pumps from being turned on after the one or more chiller-heaters turn on.

C73. A method for assembling a fermentor system comprising:
mounting a tile plate to a geodesic dome;
fastening one or more housings to the tile plate via one or more receptacles located on the tile plate;
fastening one or more thermal plates inside the one or more housings via a tubing or a crossbar fastened to the one or more housings;
mounting one or more chiller-heaters controlling, at least in part, the temperature of the one or more thermal plates and one or more reservoirs controlling, at least in part, the temperature of the one or more thermal plates, in an underfloor enclosure of a geodesic dome;
mounting one or more electric fans configured to expel air from the one or more housings, in the underfloor enclosure of the geodesic dome;
mounting an electrical panel controlling, at least in part, the one or more reservoirs, the one or more chiller-heaters, the one or more electric fans, or a combination thereof; and
providing one or more pouches comprising one or more ferment, on the one or more thermal plates, wherein a pouch of the one or more pouches comprises a magnet.

C74. The method of embodiment C73, wherein the fastening the one or more thermal plates further comprises:
constantly pumping a coolant through the one or more thermal plates, wherein the coolant comprises water; and
slowly rotating the one or more thermal plates, in accordance with a determination that an air bubble is observed in the coolant.

C75. The method of embodiment C73 or C74, wherein the providing the one or more pouches comprises mating the magnet with a recess on a surface of a thermal plate of the one or more thermal plates.

C76. The method of any of embodiments C73-C75, wherein an electrical panel controls one or more pumps configured to provide flow to the coolant and the one or more chiller-heaters.

C77. The method of embodiment C76, wherein the electrical panel prevents the one or more pumps configured from being turned on after the one or more chiller-heaters turn on.

C78. The method of any of embodiments C74-C77, wherein the electrical panel prevents one or more electrical components of the fermentor system from drawing 10 A or more current.

D1. A green system, comprising:
one or more plant receptacles for plant containment;
a tile plate configured to receive the one or more plant receptacles;
a vault enclosure configured to attach to the tile plate; and
one or more irrigation systems configured to irrigate the one or more plant receptacles.

D2. The green system of embodiment D1, wherein a geodesic dome comprises the green system.

D3. The green system of any of embodiment D1 or D2, wherein the green system is configured to attach to a bracket of a geodesic dome, a frame of a geodesic dome, or both.

D4. The green system of any of embodiments D1-D3, wherein the tile plate comprises one or more openings for the one or more plant receptacles and attachment hardware.

D5. The green system of any of embodiments D1-D4, wherein at least two of the one or more plant receptacles are different sizes, and the tile plate is configured to receive the different-sized plant receptables.

D6. The green system of any of embodiments D1-D5, wherein the one or more plant receptacles are configured to be replaced and removed from the tile plate.

D7. The green system of any of embodiments D1-D6, wherein the one or more plant receptacles are configured to accept plant mass comprising one or more of: leaves, stems, and roots.

D8. The green system of embodiment D7, wherein the plant mass is an edible plant mass grown and maintained for at least two weeks.

D9. The green system of any of embodiments D1-D8, wherein the one or more plant receptacles comprise openings of one or more sizes to accept plant pots of one or more sizes.

D10. The green system of embodiment D9, wherein the plant pots are configured to accept plant collars.

D11. The green system of any of embodiments D1-D10, wherein at least one of the one or more plant receptacles comprises one or more of: a receptacle lid with rotating latches, one or more bottoms configured to latch onto one or more funnels and a first side of the tile plate to create a watertight seal, and one or more funnels configured to attach to the one or more bottoms of the one or more plant receptables and a second side of the tile plate, wherein the first side of the tile plate is different from the second side.

D12. The green system of embodiment D11, wherein the receptable lid is configured to:
receive a plant mass through an opening; and
lock onto one or more bottoms of the one or more plant receptables.

D13. The green system of embodiment D11 or D12, wherein the one or more funnels comprise one or more holes for irrigation drainage, wherein the one or more funnels are made of a single material that protects plant mass from light exposure.

D14. The green system of any of embodiments D1-D13, wherein the vault enclosure is removable and configured to lock in place onto the tile plate.

D15. The green system of any of embodiments D1-D14, wherein the vault enclosure is configured to form a vacuum when locked into place.

D16. The green system of any of embodiments D1-D15, wherein the vault enclosure comprises one or more hinged panels configured to attach to other hinged panels to create an enclosed space.

D17. The green system of embodiment D16, wherein the one or more hinged panels are triangular in shape.

D18. The green system of embodiment D16 or D17, wherein the one or more hinged panels comprise transparent acrylic panels with 3D printed corners and a flexible trim.

D19. The green system of any of embodiments D1-D18, wherein the vault enclosure comprises: one or more springs configured to allow removal of the vault enclosure from the tile plate.

D20. The green system of embodiment D19, wherein the springs are gas springs.

D21. The green system of any of embodiments D1-D20, further comprising: one or more lights and one or more wires, wherein the one or more lights configured to attach to the vault enclosure and provide lighting for plant growth.

D22. The green system of embodiment D21, wherein the one or more lights are controlled by a timer and are directed toward plant mass.

D23. The green system of embodiment D21 or D22, wherein the one or more lights operate at a brightness that is conducive to plant growth, pleasant to the human eye, or a combination thereof.

D24. The green system of any of embodiments D1-D23, wherein the vault enclosure further comprises:

one or more sensors configured to detect temperature, carbon dioxide, humidity, or a combination thereof.

D25. The green system of embodiment D24, wherein at least one of the one or more sensors comprises: a carbon dioxide sensor configured to measure carbon dioxide levels, the measured carbon dioxide levels used to adjust fan speed to maintain carbon dioxide levels for plant growth; or a humidity sensor configured to measure humidity levels of the green system, the humidity levels used to adjust fan speed to obtain target humidity levels for plant growth.

D26. The green system of any of embodiments D1-D25, wherein the vault enclosure comprises one or more inlets and one or more outlets configured to maintain or adjust humidity using one or more fans, reduce condensation buildup, circulate air inside the vault enclosure, promote plant growth, create a more difficult environment for pests, or a combination thereof.

D27. The green system of any of embodiments D1-D26, wherein the vault enclosure comprises one or more inlets and one or more outlets configured to maintain or adjust humidity, reduce condensation buildup, circulate air inside the vault enclosure, promote plant growth, create a more difficult environment for pests, or a combination thereof, wherein the one or more inlets comprise one or more fans, and the one or more outlets comprise one or more gaps between vault enclosure panels.

D28. The green system of any of embodiments D1-D27, wherein the one or more irrigation systems are configured to irrigate proximate to roots of plant mass at an irrigation pressure higher than a high-pressure threshold, wherein the irrigation pressure is based on a pressure of a gravity environment, a pressure of a micro gravity environment, or both.

D29. The green system of any of embodiments D1-D28, wherein the one or more irrigation systems are configured to feed one or more nutrient mixtures to the one or more plant receptacles.

D30. The green system of embodiment D29, wherein the one or more nutrient mixtures comprises: water, nitrogen, potassium, salts, or a combination thereof.

D31. The green system of embodiment D29, wherein the one or more nutrient mixtures are monitored by a pH meter and an electrical conductivity meter.

D32. The green system of embodiment D29, wherein the one or more nutrient mixtures comprise: one or more growth mixtures that are diluted separately to reduce nutrient lockout, wherein proportions of the one or more growth mixtures are based on a stage of plant growth.

D33. The green system of embodiment D32, wherein the one or more growth mixtures comprise: nitrogen, calcium, micronutrients, trace minerals, potassium, phosphorus, magnesium, sulfur, or a combination thereof.

D34. The green system of embodiment D32, wherein the one or more growth mixtures comprises three parts of a first growth mixture per gallon of water, two parts of a second growth mixture per gallon of water, and one part of a third growth mixture per gallon of water.

D35. The green system of any of embodiments D1-D34, wherein the one or more irrigation systems feed the one or more plant receptacles at time intervals in accordance with a timer.

D36. The green system of any of embodiments D1-D35, wherein the one or more irrigation systems comprises: one or more aeroponic misters.

D37. The green system of embodiment D36, wherein the one or more aeroponic misters supply the one or more nutrient mixtures to a root zone of the plant in the form of droplets.

D38. The green system of embodiment D37, further comprising: a solenoid configured to control release of the one or more nutrient mixtures through the aeroponic misters.

D39. The green system of any of embodiments D1-D38, wherein the one or more irrigation systems further comprise: a pump system, comprising: a pump, a pressure switch, an accumulator tank, a safety valve, a filter, and one or more irrigation lines.

D40. The green system of embodiment D39, wherein the pressure switch controls whether the pump is on or off depending on whether pressure in the one or more irrigation lines is above a lower pressure threshold and below an upper pressure threshold.

D41. The green system of embodiment D39, wherein the accumulator tank is pre-pressurized to reduce pump load.

D42. The green system of embodiment D39, wherein the safety valve actuates when pressure in the one or more irrigation lines exceeds a safe threshold.

D43. The green system of embodiment D39, wherein the one or more irrigation lines are configured to connect to the filter and to one or more aeroponic misters.

D44. The green system of embodiment D39, wherein the one or more irrigation lines are configured to draw up one or more nutrient mixtures through the filter and pump it through one or more aeroponic misters.

D45. The green system of any of embodiments D1-D44, wherein the tile plate is connected to an underfloor enclosure of a geodesic dome.

D46. The green system of embodiment D45, wherein the underfloor enclosure comprises: a nutrient container configured to house one or more nutrient mixtures.

D47. The green system of embodiment D46, wherein the nutrient container is configured to feed the one or more nutrient mixtures to a pump container via one or more lines with one or more filters.

D48. The green system of embodiment D47, wherein the nutrient container is configured to receive excess nutrient mixture supplied by the one or more irrigation systems from a root zone of the one or more plant receptacles.

D49. The green system of embodiment D45, wherein the underfloor enclosure comprises: a pump container configured to pump one or more nutrient mixtures to the one or more irrigation systems via one or more lines connected to one or more of: a solenoid valve and a pressure gauge. D50. The green system of embodiment D49, wherein the pump container comprises: a pump, an accumulation tank, one or more safety valves, and one or more pressure switches.

D51. The green system of any of embodiments D1-D50, comprising: a switch box configured to house an electrical system that controls conditions within the vault enclosure.

D52. The green system of embodiment D51, wherein the electrical system is connected to one or more sensors.

D53. The green system of embodiment D51, wherein the switch box comprises one or more of:
one or more cycle timers configured to adjust a solenoid valve for irrigation;
one or more cycle timers configured to adjust a brightness of lights within the enclosure;
one or more potentiometers configured to adjust a speed of fans within the enclosure; and
one or more transformers configured to connect to a pump and one or more pressure switches.

D54. The green system of embodiment D53, wherein the one or more potentiometers are configured to be manually operated.

D55. The green system of any of embodiments D1-D54, wherein the tile plate is configured to be connected to a frame of the geodesic dome, brackets, or both.

D56. The green system of any of embodiments D1-D55, wherein the tile plate is configured to be removed from a frame of the geodesic dome, brackets, or both.

D57. The green system of any of embodiments D1-D56, wherein the tile plate is configured to be connected to both an outer face and an inner face of the geodesic dome.

D58. The green system of any of embodiments D1-D57, wherein the tile plate is configured to connect to a frame, bracket, or both when rotated and bolted into place.

D59. The green system of any of embodiments D1-D58, wherein the vault enclosure and the tile plate form a pyramid shaped enclosure.

D60. The green system of any of embodiments D1-D59, wherein the green system is configured to operate in one or both of gravity and micro gravity environments.

D61. The green system of any of embodiments D1-D60, wherein the green system is configured to operate in any orientation in space to account for one or both of gravity and micro gravity environments.

D62. A method for operating a green system, comprising:
placing one or more plant masses into one or more plant receptacles;
placing the one or more plant receptacles into a tile plate of the green system;
attaching a vault enclosure to the tile plate;
irrigating the one or more plant masses with one or more nutrient mixtures; and
monitoring plant growth conditions within the vault enclosure.

D63. The operating method of embodiment D62, wherein placing the one or more plant masses comprises: one or more root bundles planted in one or more plant pots.

D64. The operating method of embodiment D62 or D63, wherein the plant receptacles are configured to receive one or both of soil-based plant mass or soil-less plant mass.

D65. The operating method of any of embodiments D62-D64, wherein the plant mass is placed with a plant collar.

D66. The operating method of any of embodiments D62-D65, wherein the receptacle lids of the plant receptacles are placed first.

D67. The operating method of any of embodiments D62-D66, wherein the system operation termination is controlled by a switch box.

D68. A method for assembling and operating a green system, comprising:
attaching one or more tile plates to one or more frames, brackets, or both;
planting one or more plant masses into one or more plant receptacles;
placing the one or more plant receptacles for plant containment into the one or more tile plates;
latching the one or more plant receptacles into place;
removably attaching a vault enclosure to the one or more tile plates;
attaching one or more irrigation systems to the one or more plant receptables;
adding one or more nutrient mixtures to a nutrient container in an underfloor enclosure;
connecting the one or more irrigation systems to a pump container and the nutrient container;
connecting one or more wiring systems and one or more sensors from the vault enclosure to the underfloor enclosure; and
maintaining the plant mass and the vault enclosure.

D69. The operating and assembling method of embodiment D68, wherein the vault enclosure is configured to be locked into place.

D70. The operating and assembling method of embodiment D68 or D69, wherein the irrigation system comprises one or more exchangeable aeroponic misters.

D71. The operating and assembling method of any of embodiments D68-D70, wherein the one or more irrigation systems are configured to supply nutrient mixtures to the plant receptacles, remove excess liquid from the plant receptacles, or a combination thereof.

D72. The operating and assembling method of embodiment D71, wherein the one or more irrigation systems are configured to remove the excess liquid back to the nutrient container.

E1. A geodesic dome habitat comprising:
a frame system for providing structural support for the geodesic dome habitat, the frame system comprising:
   a plurality of struts arranged along edges of the geodesic dome habitat,
   a plurality of tension cables arranged planar to a face of the geodesic dome habitat, and
   at least one connector arranged along a vertex of the geodesic dome habitat; and
at least one tile configured to attach to the face of the geodesic dome habitat.

E2. The geodesic dome habitat of embodiment E1, wherein the at least one connector comprises:
a plurality of rods, wherein each rod of the plurality of rods is configured to connect to at least one strut from the plurality of struts and comprises a first through-hole, and
a connection plate configured to connect to at least one tension cable from the plurality of tension cables.

E3. The geodesic dome habitat of embodiment E1, wherein the at least one connector is configured to be interchangeable with another connector.

E4. The geodesic dome habitat of embodiment E2 or E3, wherein the plurality of rods is configured to connect to the at least one strut from the plurality of struts such that the geodesic dome is deformable.

E5. The geodesic dome habitat of any one of embodiments E2-E4, wherein the plurality of rods extends from a central connection point of the at least one connector.

E6. The geodesic dome habitat of any one of embodiments E2-E5, wherein the plurality of rods comprises at least three rods.

E7. The geodesic dome habitat of any one of embodiments E2E-6, wherein a tension cable of the plurality of tension cables is configured to be adjustably connected to the connection plate such that a tension force of the at least one tension cable is adjustable.

E8. The geodesic dome habitat of any one of embodiments E1-E7, wherein a tension cable of the plurality of tension cables is configured to extend between the connection plate of the at least one connector and a connection plate of another connector.

E9. The geodesic dome habitat of any one of embodiments E2-E8, wherein the plurality of struts comprises at least one hollow strut configured to receive at least one rod from the plurality of rods and comprises a second through-hole.

E10. The geodesic dome habitat of embodiment E9, wherein the frame system further comprises at least one pin configured to connect the at least one hollow strut to the at least one rod through the first through-hole and the second through-hole.

E11. The geodesic dome habitat of any one of embodiments E1-E10, wherein the plurality of struts is arranged such that the frame system forms at least one pentagonal face and at least one hexagonal face of the geodesic dome habitat.

E12. The geodesic dome habitat of any one of embodiments E1-E11, wherein the plurality of struts is configured to be interchangeable with one another.

E13. The geodesic dome habitat of any one of embodiments E1-E12, wherein the plurality of struts comprises at least one rigid strut.

E14. The geodesic dome habitat of any one of embodiments E1-E13, wherein the geodesic dome habitat is a truncated icosahedron dome.

E15. The geodesic dome habitat of any one of embodiments E1-E14, wherein the frame system is oriented such that a pentagonal face of the frame system is located at a crown of the geodesic dome habitat.

E16. The geodesic dome habitat of any one of embodiments E1-E15, further comprising a floor system comprising:
a floor positioned at a base of the geodesic dome habitat, wherein a surface of the floor is sloped such that a center of the floor is lower than an edge of the floor adjacent to the frame system;
a catwalk extending from the edge of the floor toward the center of the floor, wherein the catwalk is arranged above the surface of the floor; and
an underfloor enclosure, wherein the underfloor enclosure is configured to include one or more systems compatible with the at least one tile of the geodesic dome habitat.

E17. The geodesic dome habitat of embodiment E16, wherein the underfloor enclosure is configured to connect to one or more functional tiles.

E18. The geodesic dome habitat of embodiment E16 or E17, wherein the underfloor enclosure is configured to include one or more of:
a nutrient container configured to house one or more nutrient mixtures for a green system;
a pump container configured to pump one or more nutrient mixtures for a green system; or
a switch box configured to house an electrical system for a green system.

E19. The geodesic dome habitat of any one of embodiments E16-E19, wherein the underfloor enclosure is configured to include one or more of:
one or more housings configured to house one or more thermal plates and one or more ferments;
a tile plate comprising one or more receptacles, wherein the one or more receptacles are configured to mate with the one or more housings; or
one or more outlets configured to expel air from the one or more housings.

E20. The geodesic dome habitat of any one of embodiments E16-E19, further comprising at least one foot comprising:
a flat panel configured to lay flush against the surface of the floor, and
a hollow strut configured to receive a portion of the at least one connector and connected to the flat panel at an angle relative to a surface of the flat panel,
wherein the at least one foot is configured to support the frame system above the surface of the floor system.

E21. The geodesic dome habitat of any one of embodiments E17-E20, wherein the angle of the hollow strut is 30-90 degrees.

E22. The geodesic dome habitat of any one of embodiments E17-E21, wherein the at least one foot is adjacent to the edge of the floor.

E23. The geodesic dome habitat of any one of embodiments E1-E22, wherein the at least one tile comprises a functional tile for performing a specific functional task.

E24. The geodesic dome habitat of embodiment E23, wherein the functional tile is configured to attach to the frame system such that a functional component of the functional tile faces inward relative to a center of the geodesic dome habitat.

E25. The geodesic dome habitat of embodiment E23 or E24, wherein the functional tile comprises:
one or more plant receptacles for plant containment;
a tile plate configured to receive the one or more plant receptacles;
a vault enclosure configured to attach to the tile plate; and
one or more irrigation systems configured to irrigate the one or more plant receptacles.

E26. The geodesic dome habitat of any one of embodiments E23-E25, wherein the functional tile comprises:
one or more housings configured to house one or more thermal plates and one or more ferments;
a mountable frame comprising one or more receptacles, wherein the one or more receptacles are configured to mate with the one or more housings; and
one or more outlets configured to expel air from the one or more housings.

E27. The geodesic dome habitat of any one of embodiments E1-E26, further comprising at least one mountable frame configured to connect to the at least one connector such that the at least one mountable frame is planar to a hexagonal face of the geodesic dome.

E28. The geodesic dome habitat of embodiment E27, wherein the at least one mountable frame is configured to support the at least one tile and is arranged along the hexagonal face of the geodesic dome habitat.

E29. A geodesic dome habitat comprising:
a frame system for providing structural support for the geodesic dome habitat; and
a fermentor system, comprising:
   one or more housings configured to house one or more thermal plates and one or more ferments;
   a tile plate comprising one or more receptacles, wherein the one or more receptacles are configured to mate with the one or more housings; and
   one or more outlets configured to expel air from the one or more housings.

E30. The geodesic dome habitat of embodiment E29, wherein the air expelled by the one or more outlets are controlled by one or more electric fans.

E31. The geodesic dome habitat of embodiment E30, wherein the one or more electric fans are configured to expel the air at a volumetric flow rate of at least a first predetermined volumetric flow rate.

E32. The geodesic dome habitat of embodiment E30 or E31, wherein the one or more electric fans are configured to expel the air at an average flow velocity of at least a first predetermined average flow velocity.

E33. The geodesic dome habitat of any one of embodiments E30-E32, wherein an electric fan of the one or more electric fans comprises 3 to 8 fan blades.

E34. The geodesic dome habitat of any one of embodiments E29-E33, wherein the one or more outlets comprise one or more filters.

E35. The geodesic dome habitat of embodiment E34, wherein at least one of the one or more filters is a carbon filter.

E36. The geodesic dome habitat of any one of embodiments E30-E35, wherein the one or more electric fans are located in an underfloor enclosure of a geodesic dome.

E37. The geodesic dome habitat of any one of embodiments E29-E36, wherein of the one or more outlets, a plurality of outlets is controlled by a single fan and a single filter.

E38. The geodesic dome habitat of embodiment E37, wherein the plurality of outlets comprises three outlets.

E39. The geodesic dome habitat of any one of embodiments E29-E38, comprising a multi-to-one inlet-to-outlet manifold air configured to expel, at least in part, the air from the one or more housings.

E40. The geodesic dome habitat of embodiment E39, wherein the multi-to-one inlet-to-outlet manifold is a three-to-one inlet-to-outlet manifold.

E41. The geodesic dome habitat of any one of embodiments E29-E40, wherein the one or more outlets are configured to be controlled by a same number of fans as the one or more outlets and a same number of filters as the one or more outlets.

E42. The geodesic dome habitat of any one of embodiments E29-E41, wherein the one or more outlets are connected to one or more tubings.

E43. The geodesic dome habitat of embodiment E42, wherein the one or more tubings comprise polyvinyl chloride.

E44. The geodesic dome habitat of embodiment E42 or E43, wherein the one or more tubings comprise an inner diameter of 0.250″, 0.50″ or 0.375″.

E45. The geodesic dome habitat of any one of embodiments E42-E44, wherein the one or more tubings are configured to expel the air at the volumetric flow rate of at least a second predetermined volumetric flow rate.

E46. The geodesic dome habitat of any one of embodiments E42-E45, wherein the one or more tubings are configured to expel the air at the average flow velocity of at least a second predetermined average flow velocity.

E47. The geodesic dome habitat of embodiment E46, wherein each of the one or more outlets is configured to be controlled independently from one or more other outlets.

E48. The geodesic dome habitat of any one of embodiments E29-E47, wherein the control comprises control of the volumetric flow rate or the average flow velocity.

E49. The geodesic dome habitat of any one of embodiments E29-E48, the one or more outlets are configured to expel oxygen from the one or more housings.

E50. The geodesic dome habitat of any one of embodiments E29-E49, wherein the one or more thermal plates are temperature controlled, at least in part, by one or more reservoirs and one or more chiller-heaters.

E51. The geodesic dome habitat of embodiment E50, wherein of the one or more thermal plates, a plurality of thermal plates is controlled by a single reservoir of the one or more reservoirs and a single chiller-heater of the one or more chiller-heaters.

E52. The geodesic dome habitat of embodiment E50 or E51, wherein the one or more thermal plates are configured to be controlled by a same number of reservoirs as the one or more thermal plates and a same number of chiller-heaters as the one or more thermal plates.

E53. The geodesic dome habitat of any one of embodiments E49-E51, wherein the one or more reservoirs or the one or more chiller-heaters are located on a tray.

E54. The geodesic dome habitat of any one of embodiments E50-E53, wherein the one or more reservoirs or the one or more chiller-heaters are located in an underfloor enclosure of a geodesic dome.

E55. The geodesic dome habitat system of any one of embodiments E29-E54, wherein the one or more thermal plates are temperature controlled by one or more thermoelectric devices.

E56. The geodesic dome habitat of embodiment E55, wherein the one or more thermal plates are configured to be controlled by a same number of the one or more thermoelectric devices as the one or more thermal plates.

E57. The geodesic dome habitat of any one of embodiments E29-E56, wherein the one or more thermal plates are configured to be controlled independently from one or more other thermal plates.

E58. The geodesic dome habitat of any one of embodiments E29-E57, wherein the one or more thermal plates are configured to target a setpoint temperature of approximately 18-33 degrees Celsius.

E59. The geodesic dome habitat of any one of embodiments E29-E58, wherein the one or more thermal plates comprise aluminum.

E60. The geodesic dome habitat of any one of embodiments E29-E59, wherein the one or more thermal plates are configured to pass a coolant through the one or more thermal plates.

E61. The geodesic dome habitat of embodiment E60, wherein the coolant comprises water.

E62. The geodesic dome habitat of embodiment E61, wherein the coolant comprises a biocide.

E63. The geodesic dome habitat of any one of embodiments E29-E62, wherein the one or more thermal plates comprise two thermal plate portions and a gasket.

E64. The geodesic dome habitat of any one of embodiments E29-E63, wherein the one or more thermal plates comprise one or more internal channels to pass the coolant through the one or more thermal plates.

E65. The geodesic dome habitat of embodiment E64, wherein the one or more internal channels comprise one or more inlets and one or more outlets.

E66. The geodesic dome habitat of any one of embodiments E29-E65, further comprising an electrical panel controlling, at least in part, the one or more reservoirs, the one or more chiller-heaters, the one or more thermoelectric devices, the one or more electric fans, or a combination thereof.

E67. The geodesic dome habitat of embodiment E66, wherein the electrical panel prevents one or more pumps configured to provide flow to the coolant from being turned on after the one or more chiller-heaters turn on.

E68. The geodesic dome habitat of embodiment E66 or E67, wherein the electrical panel prevents one or more electrical components of the fermentor system from drawing 10 A or more current.

E69. The geodesic dome habitat of any one of embodiments E66-E68, wherein the electrical panel is located in the underfloor enclosure of the geodesic dome.

E70. The geodesic dome habitat of any one of embodiments E66-E69, wherein the one or more electrical components of the fermentor system receives an input alternating current of 60 Hz, 120 V, and single phase.

E71. The geodesic dome habitat of any one of embodiments E29-E70, wherein the one or more housings are transparent.

E72. The geodesic dome habitat of any one of embodiments E29-E71, wherein the one or more housings are spherical.

E73. The geodesic dome habitat of any one of embodiments E29-E72, wherein the one or more housings comprise glass, acrylic, or both.

E74. The geodesic dome habitat of any one of embodiments E29-E73, wherein each of the one or more housings is configured to mate with only one of the one or more receptacles.

E75. The geodesic dome habitat of any one of embodiments E29-E74, wherein the one or more housings are 1, 2, 3, 4, 5, 6, or 7 housings.

E76. The geodesic dome habitat of any one of embodiments E29-E75, wherein each housing of the one or more housings comprises a different shape from one or more other housings.

E77. The geodesic dome habitat of any one of embodiments E29-E76, further comprising: one or more inactive housings that do not house one or more thermal plates.

E78. The geodesic dome habitat of embodiment E77, wherein the one or more inactive housings are affixed to the one or more housings.

E79. The geodesic dome habitat of embodiment E78, wherein the one or more inactive housings are affixed to the one or more housings via one or more ball joints and one or more ball joint sockets.

E80. The geodesic dome habitat of any one of embodiments E77-E79, wherein the one or more inactive housings each comprise a rod structure.

E81. The geodesic dome habitat of embodiment E80, wherein each rod structure of each of the one or more inactive housings is of a different length from one or more other rod structures.

E82. The geodesic dome habitat of embodiment E80 or E81, wherein the rod structure comprises a ball joint of the one or more ball joints.

E83. The geodesic dome habitat of any one of embodiments E29-E82, wherein the tile plate is triangular in shape.

E84. The geodesic dome habitat of any one of embodiments E29-E83, wherein the fermentor system is configured to attach to a bracket of a geodesic dome, a frame of a geodesic dome, or both.

E85. The geodesic dome habitat of any one of embodiments E29-E84, wherein a ferment of the one or more ferments comprises a yeast ferment.

E86. The geodesic dome habitat of any one of embodiments E29-E85, wherein a ferment of the one or more ferments comprises a yeast ferment.

E87. The geodesic dome habitat of embodiment E86, wherein the ferment comprises a sourdough ferment.

E88. The geodesic dome habitat of embodiment E86 or E87, wherein the ferment is housed in a pouch.

E89. The geodesic dome habitat of embodiment E88, wherein the pouch is filled to approximately two-thirds of the volume of the pouch, with the ferment.

E90. The geodesic dome habitat of embodiment E88 or E89, wherein the pouch is filled in accordance with a determination that the pouch is not bulging or ballooning.

E91. The geodesic dome habitat of any one of embodiments E88-E90, wherein the pouch comprises a magnet.

E92. The geodesic dome habitat of embodiment E91, wherein the magnet is sealed with a room-temperature-vulcanizing silicone.

E93. The geodesic dome habitat of embodiment E91 or E92, wherein the magnet mates with a recess on a surface of a thermal plate of the one or more thermal plates.

E94. The geodesic dome habitat of embodiment E93, wherein the mating of the magnet with the recess is configured to increase contact between the pouch and the surface of the thermal plate.

E95. A geodesic dome habitat, comprising:
a frame system for providing structural support for the geodesic dome habitat; and
a green system, comprising:
   one or more plant receptacles for plant containment;
   a tile plate configured to receive the one or more plant receptacles;
   a vault enclosure configured to attach to the tile plate; and
   one or more irrigation systems configured to irrigate the one or more plant receptacles.

E96. The geodesic dome habitat of embodiment E95, wherein the green system is configured to attach to a bracket of a geodesic dome, a frame of a geodesic dome habitat, or both.

E97. The geodesic dome habitat of any of embodiment E95 or embodiment E96, wherein the tile plate comprises one or more openings for the one or more plant receptacles and attachment hardware.

E98. The geodesic dome habitat of any one of embodiments E95-E97, wherein at least two of the one or more plant receptacles are different sizes, and the tile plate is configured to receive the different-sized plant receptables.

E99. The geodesic dome habitat of any one of embodiments E95-E98, wherein the one or more plant receptacles are configured to be replaced and removed from the tile plate.

E100. The geodesic dome habitat of any one of embodiments E95-E99, wherein the one or more plant receptacles are configured to accept plant mass comprising one or more of: leaves, stems, and roots.

E101. The geodesic dome habitat of embodiment E100, wherein the plant mass is an edible plant mass grown and maintained for at least two weeks.

E102. The geodesic dome habitat of any one of embodiments 95-101, wherein the one or more plant receptacles comprise openings of one or more sizes to accept plant pots of one or more sizes.

E103. The geodesic dome habitat of embodiment E102, wherein the plant pots are configured to accept plant collars.

E104. The geodesic dome habitat of any one of embodiments E95-E103, wherein at least one of the one or more plant receptacles comprises one or more of: a receptacle lid with rotating latches, one or more bottoms configured to latch onto one or more funnels and a first side of the tile plate to create a watertight seal, and one or more funnels configured to attach to the one or more bottoms of the one or more plant receptables and a second side of the tile plate, wherein the first side of the tile plate is different from the second side.

E105. The geodesic dome habitat of embodiment E104, wherein the receptable lid is configured to:
receive a plant mass through an opening; and
lock onto one or more bottoms of the one or more plant receptables.

E106. The geodesic dome habitat of embodiment E104 or E105, wherein the one or more funnels comprise one or more holes for irrigation drainage, wherein the one or more funnels are made of a single material that protects plant mass from light exposure.

E107. The geodesic dome habitat of any of embodiments E95-E106, wherein the vault enclosure is removable and configured to lock in place onto the tile plate.

E108. The geodesic dome habitat of any one of embodiments E95-E107, wherein the vault enclosure is configured to form a vacuum when locked into place.

E109. The geodesic dome habitat of any one of embodiments E95-E108, wherein the vault enclosure comprises one or more hinged panels configured to attach to other hinged panels to create an enclosed space.

E110. The geodesic dome habitat of embodiment E109, wherein the one or more hinged panels are triangular in shape.

E111. The geodesic dome habitat of embodiment E109 or E110, wherein the one or more hinged panels comprise transparent acrylic panels with 3D printed corners and a flexible trim.

E112. The geodesic dome habitat of any one of embodiments E95-E111, wherein the vault enclosure comprises: one or more springs configured to allow removal of the vault enclosure from the tile plate.

E113. The geodesic dome habitat of embodiment E112, wherein the springs are gas springs.

E114. The geodesic dome habitat of any one of embodiments E95-E113, further comprising: one or more lights and one or more wires, wherein the one or more lights configured to attach to the vault enclosure and provide lighting for plant growth.

E115. The geodesic dome habitat of embodiment E114, wherein the one or more lights are controlled by a timer and are directed toward plant mass.

E116. The geodesic dome habitat of embodiment E114 or E115, wherein the one or more lights operate at a brightness that is conducive to plant growth, pleasant to the human eye, or a combination thereof.

E117. The geodesic dome habitat of any one of embodiments E95-E116, wherein the vault enclosure further comprises:
one or more sensors configured to detect temperature, carbon dioxide, humidity, or a combination thereof.

E118. The geodesic dome habitat of embodiment E117, wherein at least one of the one or more sensors comprises: a carbon dioxide sensor configured to measure carbon dioxide levels, the measured carbon dioxide levels used to adjust fan speed to maintain carbon dioxide levels for plant growth; or a humidity sensor configured to measure humidity levels of the green system, the humidity levels used to adjust fan speed to obtain target humidity levels for plant growth.

E119. The geodesic dome habitat of any one of embodiments E95-E118, wherein the vault enclosure comprises one or more inlets and one or more outlets configured to maintain or adjust humidity using one or more fans, reduce condensation buildup, circulate air inside the vault enclosure, promote plant growth, create a more difficult environment for pests, or a combination thereof.

E120. The geodesic dome habitat of any one of embodiments E95-E119, wherein the vault enclosure comprises one or more inlets and one or more outlets configured to maintain or adjust humidity, reduce condensation buildup, circulate air inside the vault enclosure, promote plant growth, create a more difficult environment for pests, or a combination thereof, wherein the one or more inlets comprise one or more fans, and the one or more outlets comprise one or more gaps between vault enclosure panels.

E121. The geodesic dome habitat of any one of embodiments E95-E120, wherein the one or more irrigation systems are configured to irrigate proximate to roots of plant mass at an irrigation pressure higher than a high-pressure threshold, wherein the irrigation pressure is based on a pressure of a gravity environment, a pressure of a micro gravity environment, or both.

E122. The geodesic dome habitat of any one of embodiments E95-E121, wherein the one or more irrigation systems are configured to feed one or more nutrient mixtures to the one or more plant receptacles.

E123. The geodesic dome habitat of embodiment E122, wherein the one or more nutrient mixtures comprises: water, nitrogen, potassium, salts, or a combination thereof.

E124. The geodesic dome habitat of embodiment E122 or E123, wherein the one or more nutrient mixtures are monitored by a pH meter and an electrical conductivity meter.

E125. The geodesic dome habitat of any one of embodiments E122-E124, wherein the one or more nutrient mixtures comprise: one or more growth mixtures that are diluted separately to reduce nutrient lockout, wherein proportions of the one or more growth mixtures are based on a stage of plant growth.

E126. The geodesic dome habitat of embodiment E125, wherein the one or more growth mixtures comprise: nitrogen, calcium, micronutrients, trace minerals, potassium, phosphorus, magnesium, sulfur, or a combination thereof.

E127. The geodesic dome habitat of embodiment E125, wherein the one or more growth mixtures comprises three parts of a first growth mixture per gallon of water, two parts of a second growth mixture per gallon of water, and one part of a third growth mixture per gallon of water.

E128. The geodesic dome habitat of any one of embodiments E95-E127, wherein the one or more irrigation systems feed the one or more plant receptacles at time intervals in accordance with a timer.

E129. The geodesic dome habitat of any one of embodiments E95-E128, wherein the one or more irrigation systems comprises: one or more aeroponic misters.

E130. The geodesic dome habitat of embodiment E129, wherein the one or more aeroponic misters supply the one or more nutrient mixtures to a root zone of the plant in the form of droplets.

E131. The geodesic dome habitat of embodiment E130, further comprising: a solenoid configured to control release of the one or more nutrient mixtures through the aeroponic misters.

E132. The geodesic dome habitat of any of one embodiments E95-E131, wherein the one or more irrigation systems further comprise: a pump system, comprising: a pump, a pressure switch, an accumulator tank, a safety valve, a filter, and one or more irrigation lines.

E133. The geodesic dome habitat of embodiment E132, wherein the pressure switch controls whether the pump is on or off depending on whether pressure in the one or more irrigation lines is above a lower pressure threshold and below an upper pressure threshold.

E134. The geodesic dome habitat of embodiment E132 or E133, wherein the accumulator tank is pre-pressurized to reduce pump load.

E135. The geodesic dome habitat of any one of embodiments E132-E134, wherein the safety valve actuates when pressure in the one or more irrigation lines exceeds a safe threshold.

E136. The geodesic dome habitat of any one of embodiments E132-E135, wherein the one or more irrigation lines are configured to connect to the filter and to one or more aeroponic misters.

E137. The geodesic dome habitat of any one of embodiments E132-E136, wherein the one or more irrigation lines are configured to draw up one or more nutrient mixtures through the filter and pump it through one or more aeroponic misters.

E138. The geodesic dome habitat of any of embodiments E95-E137, wherein the tile plate is connected to an underfloor enclosure of a geodesic dome.

E139. The geodesic dome habitat of embodiment E138, wherein the underfloor enclosure comprises: a nutrient container configured to house one or more nutrient mixtures.

E140. The geodesic dome habitat of embodiment E139, wherein the nutrient container is configured to feed the one or more nutrient mixtures to a pump container via one or more lines with one or more filters.

E141. The geodesic dome habitat of embodiment E140, wherein the nutrient container is configured to receive excess nutrient mixture supplied by the one or more irrigation systems from a root zone of the one or more plant receptacles.

E142. The geodesic dome habitat of any one of embodiments E138-E141, wherein the underfloor enclosure comprises: a pump container configured to pump one or more nutrient mixtures to the one or more irrigation systems via one or more lines connected to one or more of: a solenoid valve and a pressure gauge.

E143. The geodesic dome habitat of embodiment E142, wherein the pump container comprises: a pump, an accumulation tank, one or more safety valves, and one or more pressure switches.

E144. The geodesic dome habitat of any one of embodiments E95-E143, comprising: a switch box configured to house an electrical system that controls conditions within the vault enclosure.

E145. The geodesic dome habitat of embodiment E144, wherein the electrical system is connected to one or more sensors.

E146. The geodesic dome habitat of embodiment E144 or E145, wherein the switch box comprises one or more of:
one or more cycle timers configured to adjust a solenoid valve for irrigation;
one or more cycle timers configured to adjust a brightness of lights within the enclosure;
one or more potentiometers configured to adjust a speed of fans within the enclosure; and
one or more transformers configured to connect to a pump and one or more pressure switches.

E147. The geodesic dome habitat of embodiment E146, wherein the one or more potentiometers are configured to be manually operated.

E148. The geodesic dome habitat of any one of embodiments E95-E147, wherein the tile plate is configured to be connected to a frame of the geodesic dome, brackets, or both.

E149. The geodesic dome habitat of any one of embodiments E95-E148, wherein the tile plate is configured to be removed from a frame of the geodesic dome, brackets, or both.

E150. The geodesic dome habitat of any one of embodiments E95-E149, wherein the tile plate is configured to be connected to both an outer face and an inner face of the geodesic dome.

E151. The geodesic dome habitat of any one of embodiments E95-E150, wherein the tile plate is configured to connect to a frame, bracket, or both when rotated and bolted into place.

E152. The geodesic dome habitat of any one of embodiments E95-E151, wherein the vault enclosure and the tile plate form a pyramid shaped enclosure.

E153. The geodesic dome habitat of any one of embodiments E95-E152, wherein the green system is configured to operate in one or both of gravity and micro gravity environments.

E154. The geodesic dome habitat of any one of embodiments E95-E153, wherein the green system is configured to operate in any orientation in space to account for one or both of gravity and micro gravity environments.

E155. A geodesic dome habitat comprising:
a frame system for providing structural support for the geodesic dome habitat, the frame system;
a fermentor system for providing an environment for cultivating ferments housed in one or more housings; and
a green system for providing an environment for growing and sustaining plant mass.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

It should be understood from the foregoing that, while particular implementations of the disclosed methods and systems have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A geodesic dome habitat comprising:
a frame system for providing structural support for the geodesic dome habitat, the frame system comprising:
a plurality of struts arranged along edges of the geodesic dome habitat,
a plurality of tension cables arranged planar to a face of the geodesic dome habitat, and
at least one connector arranged along a vertex of the geodesic dome habitat; and
at least one tile configured to attach to the face of the geodesic dome habitat.

2. The geodesic dome habitat of claim 1, wherein the at least one connector comprises:
a plurality of rods, wherein each rod of the plurality of rods is configured to connect to at least one strut from the plurality of struts and comprises a first through-hole, and
a connection plate configured to connect to at least one tension cable from the plurality of tension cables.

3. The geodesic dome habitat of claim 1, wherein the geodesic dome habitat is a truncated icosahedron dome.

4. The geodesic dome habitat of claim 1, further comprising:
a floor system comprising:
a floor positioned at a base of the geodesic dome habitat, wherein a surface of the floor is sloped such that a center of the floor is lower than an edge of the floor adjacent to the frame system;
a catwalk extending from the edge of the floor toward the center of the floor, wherein the catwalk is arranged above the surface of the floor; and
an underfloor enclosure, wherein the underfloor enclosure is configured to include one or more systems compatible with the at least one tile of the geodesic dome habitat.

5. The geodesic dome habitat of claim 4, wherein the underfloor enclosure is configured to connect to one or more functional tiles.

6. The geodesic dome habitat of claim 4, wherein the underfloor enclosure is configured to include:
a nutrient container configured to house one or more nutrient mixtures for a green system;
a pump container configured to pump one or more nutrient mixtures for a green system; or
a switch box configured to house an electrical system for a green system,
or any combination thereof.

7. The geodesic dome habitat of claim 4, wherein the underfloor enclosure is configured to include:
one or more housings configured to house one or more thermal plates and one or more ferments;
a tile plate comprising one or more receptacles, wherein the one or more receptacles are configured to mate with the one or more housings; or
one or more outlets configured to expel air from the one or more housings,
or any combination thereof.

8. The geodesic dome habitat of claim 4, wherein the functional tile comprises:
one or more plant receptacles for plant containment;
a tile plate configured to receive the one or more plant receptacles;
a vault enclosure configured to attach to the tile plate; and
one or more irrigation systems configured to irrigate the one or more plant receptacles.

9. The geodesic dome habitat of claim 4, wherein the functional tile comprises:
one or more housings configured to house one or more thermal plates and one or more ferments;
a mountable frame comprising one or more receptacles, wherein the one or more receptacles are configured to mate with the one or more housings; and
one or more outlets configured to expel air from the one or more housings.

10. The geodesic dome habitat of claim 1, further comprising at least one mountable frame configured to connect to the at least one connector such that the at least one mountable frame is planar to a hexagonal face of the geodesic dome.

11. A fermentor system comprising:
one or more housings configured to house one or more thermal plates and one or more ferments;
a tile plate comprising one or more receptacles, wherein the one or more receptacles are configured to mate with the one or more housings; and
one or more outlets configured to expel air from the one or more housings.

12. The fermentor system of claim 11, wherein the one or more thermal plates are temperature controlled, at least in part, by one or more reservoirs and one or more chiller-heaters.

13. The fermentor system of claim 12, wherein the one or more reservoirs or the one or more chiller-heaters are located in an underfloor enclosure of a geodesic dome.

14. The fermentor system of claim 11, further comprising: one or more inactive housings that do not house one or more thermal plates.

15. The fermentor system of claim 11, wherein the fermentor system is configured to attach to a bracket of a geodesic dome, a frame of a geodesic dome, or both.

16. A green system, comprising:
one or more plant receptacles for plant containment;
a tile plate configured to receive the one or more plant receptacles;
a vault enclosure configured to attach to the tile plate; and
one or more irrigation systems configured to irrigate the one or more plant receptacles.

17. The green system of claim 16, wherein the green system is configured to attach to a bracket of a geodesic dome, a frame of a geodesic dome, or both.

18. The green system of claim 16, wherein the one or more irrigation systems are configured to irrigate proximate to roots of plant mass at an irrigation pressure higher than a high-pressure threshold, wherein the high-pressure threshold is based on a pressure of a gravity environment, a pressure of a micro gravity environment, or both.

19. The green system of claim 16, wherein the one or more irrigation systems comprises: one or more aeroponic misters.

20. The green system of claim 16, wherein the tile plate is connected to an underfloor enclosure of a geodesic dome.
